(19) United States
(12) Patent Application Publication
(10) Pub. No.: US 2024/0058203 A1
(43) Pub. Date: Feb. 22, 2024

(54) SYSTEMS AND APPARATUS FOR APPLYING GAS AND PRESSURE THERAPIES

(71) Applicant: TRI.O MEDICAL DEVICE LTD, Maalot (IL)

(72) Inventor: Kfir WEINSTEIN, Maalot (IL)

(21) Appl. No.: 18/381,824

(22) Filed: Oct. 19, 2023

Related U.S. Application Data
(63) Continuation-in-part of application No. PCT/IB2022/053830, filed on Apr. 25, 2022.
Application No. PCT/IB2022/053830 is a continuation-in-part of application No. 17/239,637, filed on Apr. 25, 2021, now Pat. No. 11,844,918.
Application No. PCT/IB2022/053830 is a continuation-in-part of application No. 17/239,637, filed on Apr. 25, 2021, now Pat. No. 11,844,918.

(30) Foreign Application Priority Data
Sep. 1, 2021 (GB) 2112465.6
Oct. 26, 2022 (GB) 2215876.0

(51) Int. Cl. A61H 9/00

(52) U.S. Cl. CPC A61H 9/0092; A61H 9/0007; A61H 2201/0103; A61H 2201/1238; A61H 2201/165; A61H 2201/50; A61H 2205/06; A61H 2205/10; A61H 2205/12

(57) ABSTRACT

Apparatus, methods, and systems are provided for applying, or use with, a multibaric treatment protocol to a human limb. The apparatus may comprise a bag formed to surround at least a portion of the limb; a connection arrangement mounted to a wall of the bag in a distal portion of the bag, effective to enable therethrough a flow of a gas between the pressure-regulating device and an interior space of the bag; and a gas-permeable strip affixed to or integral with an interior surface of the bag.

### FIELD OF THE INVENTION

The present invention relates to articles of manufacture comprising apparatuses for use in gas and pressure therapies applied to human limbs and torsos.

### BACKGROUND

Pressure-regulating devices have been utilized in a variety of therapies. In many cases, therapies are applied by improvising pressure-retaining volumes above and around a wound or section of a limb or torso. In some cases, internal ‘gas-bridges’ between connection arrangements in the improvised volumes and the wound itself are also improvised, for example by cutting up pieces of an open-cell foam to create gas pathways within the volume. Thus, practices disclosed to date are imprecise, ad hoc, and difficult to maintain in sterile conditions. Further, the improvised pressure-retaining volumes are not appropriate for combination with other gas therapies or with other pressure therapies. Therefore, there is a need for ready-to-use apparatuses that can be used in a variety of therapies employing pressure-regulating devices and/or various gases.

### SUMMARY

PCT/IB2022/053830, filed on Apr. 25, 2022, is incorporated herein by reference in its entirety. U.S. patent application Ser. No. 17/239,637, filed on Apr. 25, 2021, is incorporated herein by reference in its entirety. United Kingdom patent application GB2112465.6, filed on Sep. 1, 2021, is incorporated herein by reference in its entirety.

According to embodiments disclosed herein, a system for administering a multibaric treatment protocol to a limb of a human subject comprises: (a) a first vessel comprising (i) a pliable bag having an opening in a proximal portion thereof and comprising first and second opposing bag sections, (ii) a connection arrangement mounted to the first bag section, and a (iii) lengthwise strip arranged on an interior surface of the second bag section such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip; (b) a second vessel having a proximal opening and comprising multiple fluid-holding compartments such as at least 3 compartments or at least 4 compartments, arranged consecutively along a lengthwise portion of said second vessel; (c) a first gas-transfer section comprising a first opening for gas transfer therethrough, the first section configured to cause a flow of a gas through said first opening; (d) a second gas-transfer section comprising multiple openings for gas transfer therethrough, the second portion configured to cause respective flows of gas through said multiple openings; and (e) electronic circuitry arranged to control said first and second gas-transfer sections and programmed to operate in each one of the following modes in sequence: (i) a first mode in which, when said first vessel envelops a lengthwise part of said limb, said first gas-transfer section causes a quantity of gas to flow through said first opening and into said first vessel, and (ii) a second mode in which, when the second vessel at least partly surrounds said enveloped lengthwise part of said limb, said second gas-transfer section causes a lengthwise circulation of said quantity of gas at least throughout a lengthwise portion of said pliable bag that is surrounded by said multiple fluid-holding compartments, wherein causing the circulation includes regulating, through said multiple corresponding openings, respective gas pressures in the fluid-holding compartments to alternately inflate and deflate said compartments, each inflating being effective to apply a compressive pressure through a wall of said pliable bag to a corresponding portion of said limb, wherein the alternately inflating and deflating includes alternately inflating and deflating consecutive fluid-holding compartments, wherein in said second mode, said lengthwise strip defines a lengthwise, at-most-partly compressible fluid pathway for gas flow between first and second non-contiguous lengthwise portions of said pliable bag that are respectively distal and proximal to a lengthwise portion of said pliable bag that is under compressive pressure applied by one or more corresponding fluid-holding compartments.

In some embodiments, said regulating, through said multiple corresponding openings, respective gas pressures in said fluid-holding compartments to alternately inflate and deflate said compartments can be effective to apply a therapy to a wound or other target area. In such embodiments, said therapy can include evacuation of edema and/or other excretions, e.g., so as to improve blood flow to wounds or other target areas.

In some embodiments, said quantity of gas caused in the first mode to flow through said first opening and into said first vessel can have an ambient-pressure volume of at least 100 cc, or at least 200 cc.

In some embodiments, it can be that (i) said applying of said compressive pressure through a wall of said pliable bag to a corresponding portion of said limb by inflating one or more of said fluid-holding compartments is effective to displace a portion of said quantity of gas within said first vessel, and (ii) said ambient-pressure volume of said quantity of gas is selected so that said displacing does not create an above-ambient pressure within said second vessel.

In some embodiments, the regulating in the second mode of respective gas pressures in the fluid-holding compartments to alternately inflate and deflate said compartments can include repeating a sequence of differential pressure regulation.

In some embodiments, said regulating, through said multiple corresponding openings, respective gas pressures in said fluid-holding compartments to alternately inflate and deflate said compartments can be effective to apply a therapeutic gas to a wound or other target area. In some embodiments, an application of a therapeutic gas can include at least one of ozone, oxygen, and an essential oil. In some embodiments, said quantity of gas can include at least one of ozone, oxygen, and an essential oil.

In some embodiments, in the first mode, the causing of said flow of said quantity of gas can be preceded by evacuating said first vessel through the first opening.

In some embodiments, a volume of said pliable bag can be within a range of 0.3 to 10 liters.

In some embodiments, said lengthwise strip can be formed integrally with said pliable bag. In some embodiments, said lengthwise strip can be affixed to said second bag section.

In some embodiments, in the second mode when the second vessel at least partly surrounds said enveloped lengthwise part of said limb, said lengthwise strip can be aligned longitudinally with said multiple fluid-holding compartments.

In some embodiments, said lengthwise strip can have a length of at least 10 cm. In some embodiments, said lengthwise strip can have a thickness of no more than 3.5 mm (where thickness is the total distance from the interior surface of the bag section upon which said strip is arranged).

In some embodiments, the first gas-transfer section can comprise an ozone generator for delivering an ozone-containing gas to said first vessel. In some embodiments, the first gas-transfer section can comprise a container for storage of a therapeutic gas.

In some embodiments, when one or more bag-sections of said pliable bag are collapsed by inflation of one or more of said multiple fluid-holding compartments, said lengthwise strip can maintain a viable conduit for conveyance of a gas at least for the extent of said first vessel that is surrounded by said fluid-holding compartments of said second vessel.

According to embodiments disclosed herein, a system for administering a multibaric treatment protocol to a limb of a human subject comprises: (a) a first vessel comprising (i) a pliable bag having an opening in a proximal portion thereof and comprising first and second opposing bag sections, and (ii) a connection arrangement mounted to the first bag section; (b) a second vessel having a proximal opening and comprising multiple fluid-holding compartments arranged consecutively along a lengthwise portion of said second vessel; (c) a first gas-transfer section comprising a first opening for gas transfer therethrough, the first section configured to cause a flow of a gas through said first opening; (d) a second gas-transfer section comprising multiple openings for gas transfer therethrough, the second portion configured to cause respective flows of gas through said multiple openings; and (e) electronic circuitry arranged to control said first and second gas-transfer sections and programmed to operate in each one of the following modes in sequence: (i) a first mode in which, when said first vessel envelops a lengthwise part of said limb, said first gas-transfer section causes a quantity of gas to flow through said first opening and into said first vessel, and (ii) a second mode in which, when the second vessel at least partly surrounds said enveloped lengthwise part of said limb, said second gas-transfer section causes a lengthwise circulation of said quantity of gas at least throughout a lengthwise portion of said pliable bag that is surrounded by said multiple fluid-holding compartments, wherein causing the circulation includes regulating, through said multiple corresponding openings, respective gas pressures in the fluid-holding compartments to alternately inflate and deflate said compartments, each inflating being effective to apply a compressive pressure through a wall of said pliable bag to a corresponding portion of said limb, wherein the alternately inflating and deflating includes alternately inflating and deflating consecutive fluid-holding compartments.

According to embodiments disclosed herein, a system for administering a multibaric treatment protocol to a limb of a human subject comprises: (a) a vessel comprising (i) a pliable bag having an opening in a proximal portion thereof and comprising first and second opposing bag sections, (ii) a connection arrangement mounted to the first bag section, and a (iii) lengthwise strip arranged on an interior surface of the second bag section such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip; (b) a gas-transfer apparatus comprising an opening for gas transfer therethrough, the apparatus configured to cause a flow of a gas through said first opening; (c) an elastically-compressible element biased to expand to a design height in at least one dimension; and (d) electronic circuitry arranged to control said gas-transfer apparatus and programmed to perform each of the following steps in sequence: (i) evacuating said vessel, through said first opening of said gas-transfer system, to reduce a pressure in said vessel to a below-ambient pressure and to at least partially compress said elastically-compressible element, and (ii) causing a quantity of gas to flow through said first opening of said gas-transfer system and into said evacuated vessel to increase said pressure in said vessel, the flow of gas traversing said lengthwise strip to expand the at least partially compressed elastically-compressible element.

In some embodiments, the strip can be arranged on an interior surface of the second bag section.

In some embodiments, said elastically-compressible element can comprise an open-celled foam.

In some embodiments, said below-ambient pressure is between 10 and 100 mm Hg below one of ambient pressure atmospheric pressure.

In some embodiments, the flow of said quantity of therapeutic gas to said elastically-compressible element can be at least partly through said lengthwise strip. In some embodiments, the flow of said quantity of gas to said elastically-compressible element can be substantially all through said lengthwise strip.

In some embodiments, a footprint of said lengthwise strip can have an area less than 10 percent of an area of said pliable bag when lain flat without wrinkles or folds. In some embodiments, said lengthwise strip has a length equal to at least 70% of a length (i.e., from distal to proximal ends) of said pliable bag.

In some embodiments, when said pressure in said pliable bag is reduced to said below-ambient or below-atmospheric pressure, said lengthwise strip can retain at least 90% of an uncompressed thickness thereof. In some embodiments, when said pressure in said pliable bag is reduced to said below-ambient or below-atmospheric pressure, said elastically-compressible element can retain less than 80% of an uncompressed thickness thereof.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIGS. 1 and 2 are schematic illustrations of exemplary apparatuses according to embodiments of the present invention.

FIG. 3 is a schematic illustration of an apparatus connected, via a gas connection hose, to a pressure-regulating device, according to embodiments of the present invention.

FIG. 4A is a schematic top view of a strip, according to embodiments of the present invention.

FIGS. 4B, 4C, 4D, 4E, and 4F are schematic transverse cross-sectional views of strips, according to embodiments of the present invention.

FIGS. 5A and 5B are schematic illustrations showing components of an apparatus according to embodiments of the present invention, including a connection arrangement with a gas connection hose connected thereto, two opposing walls of a bag, and a strip affixed, in FIG. 5A, to the wall opposite the connection arrangement and, in FIG. 5B, to the same wall as the connection arrangement.

FIGS. 6, 7, 8 and 9A are schematic illustrations of gas-flow pathways into, through and out of strips, according to embodiments of the present invention.

FIG. 9B is a schematic illustrations of gas-flow pathways into, through and out of a strip and with an externally-applied pressure, according to embodiments of the present invention.

FIGS. 10A and 10B are schematic illustrations of gas-flow pathways into, through and out of a strip in respective uncompressed and partly compressed states, according to embodiments of the present invention.

FIGS. 11A-F show photographs of exemplary gas-permeable strips, and gas-permeable layers of strips, according to embodiments of the present invention.

FIGS. 12A, 12B and 12C are schematic illustrations of an exemplary apparatus comprising an integrally formed strip, according to embodiments of the present invention.

FIG. 13 is a schematic illustration of apparatuses sized for human limbs, in respective donned mode, according to embodiments of the present invention.

FIGS. 14, 15 and 16 are schematic illustrations of human users with exemplary body-sized apparatuses, according to embodiments of the present invention.

FIG. 17 is a schematic illustration of an apparatus sized for a human leg in a donned mode, together with an elastic ribbon shown in the donned mode as a transverse extension to the strip of the apparatus, according to embodiments of the present invention.

FIG. 18 is a schematic illustration of a kit comprising an apparatus and an elastic ribbon for use as a transverse extension, according to embodiments of the present invention.

FIG. 19 is a schematic illustration of a kit comprising an apparatus and a limb-sealing tape, according to embodiments of the present invention.

FIG. 20 is a schematic illustration of a kit comprising the elements of the kit of FIG. 18 and a limb-sealing tape, according to embodiments of the present invention.

FIG. 21 is a block diagram of a kit according to embodiments of the present invention.

FIGS. 22A, 22B and 22C are schematic cross-sectional illustrations of an exemplary apparatus comprising first and second portions of a gas-flow pathway, respectively at different pressure conditions, according to embodiments of the present invention.

FIG. 23 is a schematic illustration of a system for administering a multibaric treatment protocol to a human subject, according to embodiments of the present invention.

FIG. 24 shows first and second vessels at least partly surrounding a human limb, according to embodiments of the present invention.

FIG. 25 shows first and second vessels at least partly surrounding a human limb and connected to a pressure-regulating device, according to embodiments of the present invention.

FIGS. 26A, 26B, 26C, 26D, 26E, and 26F schematically illustrates sequential compression of a multi-compartment second vessel partly surrounding a first vessel which at least partly surrounds a human limb, according to embodiments of the present invention.

FIGS. 27A, 27B, 27C, 27D and 27E show flowcharts of method steps for administering a multibaric treatment protocol to a human subject, according to embodiments of the present invention.

FIGS. 28A, 28B and 28C show flowcharts of method steps for applying a hypobaric therapy to a human limb, according to embodiments of the present invention.

FIGS. 29A and 29B show a flowchart of method steps for administering a multibaric treatment protocol to a human subject, according to embodiments of the present invention.

FIG. 30 shows a flowchart of method steps for applying a hypobaric therapy to a human limb, according to embodiments of the present invention.

### DETAILED DESCRIPTION OF THE ILLUSTRATED EMBODIMENTS

PCT/IB2022/053830, filed on Apr. 25, 2022, is incorporated herein by reference in its entirety. U.S. patent application Ser. No. 17/239,637, filed on Apr. 25, 2021, is incorporated herein by reference in its entirety. United Kingdom patent application GB2112465.6, filed on Sep. 1, 2021, is incorporated herein by reference in its entirety.

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements. Subscripted reference numbers (e.g., 10₁) or letter-modified reference numbers (e.g., 100_{A}) are used to designate multiple separate appearances of elements in a single drawing, e.g. 10₁ is a single appearance (out of a plurality of appearances) of element 10, and 100_{A} is a single appearance (out of a plurality of appearances) of element 100.

Embodiments of the invention include apparatuses for use in pressure-related therapies applied to a human user's body, and in particular (although not exclusively) to one or more of the user's limbs. The apparatus is for use with a pressure-relating device, which can increase, decrease, and/or maintain a gas pressure within a bag component of the apparatus, and/or replace a gas within the bag. The bag is configured to surround a user's limb so that other components of the apparatus are disposed to form a gas-flow pathway to a treatment area, the pathway being viable even when the pressure in the bag is reduced.

Further embodiments of the invention include methods and systems for applying a gas and pressure treatment protocol to one or more limbs of a human body. According to embodiments, the protocol synergistically combines three types of therapy to achieve optimal results: variable compression therapy, i.e., externally applied pressure with variable amplitude and/or placement, for edema removal; negative pressure (vacuum) for evacuation of edema and other excretions so as to improve blood flow to wounds; and application of a therapeutic gas. A ‘therapeutic gas’ as used herein is a gas that including one or more of ozone, oxygen, and an essential oil. Essential oils are substances often applied for improved disinfection and immune system performance.

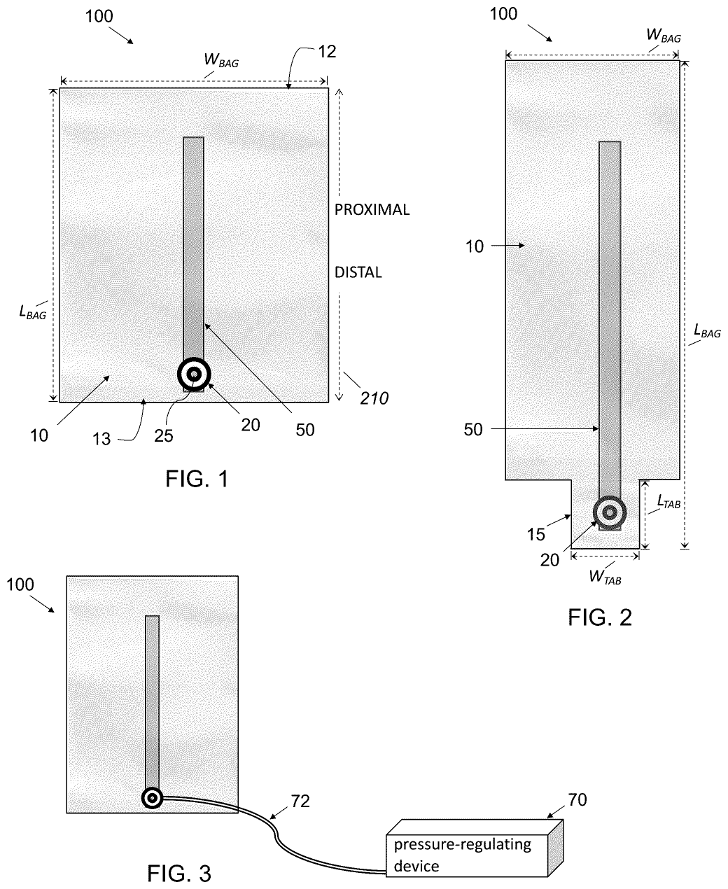

We now refer to the figures and in particular to FIG. 1, which schematically illustrates, in a non-limiting example, an apparatus 100 for use in a therapy. The apparatus includes a pliable bag 10, shown in FIG. 1 in a two-dimensional projection, or in an initial before-use mode and in an unconnected state.

For simplicity, bags are characterized throughout this disclosure as having two opposing walls; however, some bags according to embodiments can be produced to have a single ‘endless’ wall, e.g., a continuous sheet of polymer that can be closed or sealed at one end and open at the other end. Nonetheless, when flattened, such a bag has two opposing walls, or equivalently, two opposing ‘bag-sections’. Bags as disclosed herein can be either seamed or seamless. Bags (and/or apparatuses comprising bags) can be provided in a continuous roll; alternatively or additionally, bags (and/or apparatus comprising bags) can be provided in an initial (pre-use) mode having two sealed ends, wherein a first end is designated for opening to initiate use. In some designs, a bag can be openable simply by separating two opposing walls. In some other designs, a user may have to perform an additional action, such as, for example, tearing off a sealing strip at the top of the bag. All of these variants in the bag design are within the scope of the invention. In addition, for simplicity, all illustrations of bags in the accompanying figures are of rectangular bags, but the embodiments can be implemented with bags of any shape that is suitable for the application, as will be appreciated by those of skill in the art. For example, a bag for an apparatus intended to be used with a patient's hand might be oval (in a two-dimensional projection), or any bag have rounded corners.

Bags according to the embodiments are produced from any suitably pliable material that can maintain a positive and/or negative pressure over a limited period of time, i.e., minutes or hours, but not necessarily days or weeks. Suitable construction materials for bags having low permeability and high pliability include polymers such as various grades of polyethylene, polypropylene and polyvinyl chloride. Low permeability to molecules such as N₂, CO₂, O₂ and O₃ can be a desirable characteristic in order to substantially isolate the interior of the bag, once sealed against a limb in a donned mode, from the surrounding atmosphere for the duration of a therapy session or a portion thereof. A construction material can be selected for compatibility with ozone gas, such as, for example, a polyethylene. Maintaining the pressure is generally a function of permeability of the construction material(s) of the bag, and in some cases thickness of the material. “Maintaining” a pressure, as the term is used herein should be understood to mean maintaining a set or specified pressure, or within 0.1% of the set or specified pressure over the course of a minute, or within 0.5%, or within 1%, or within 2%, or within 3%, or within 4%, or within 5% over the course of a minute. Maintaining can also include making small adjustments, e.g., by a pressure-regulating device connected to the bag, in order to reduce the variation in pressure. “Positive” and “negative” pressures should be understood to mean that a pressure is respectively higher or lower than ambient pressure. For example, if ambient pressure is 760 mm Hg (millimeters of mercury), then 460 mm Hg would be called a negative pressure and 1,060 mm Hg would be called a positive pressure. Thus, a negative-pressure, or hypobaric, therapy is a therapy applied at a pressure below ambient pressure; a negative pressure, i.e., a pressure greater than 0 mm Hg and less than ambient pressure can also be characterized herein as being “a partial vacuum”, “partly evacuated”, or similar.

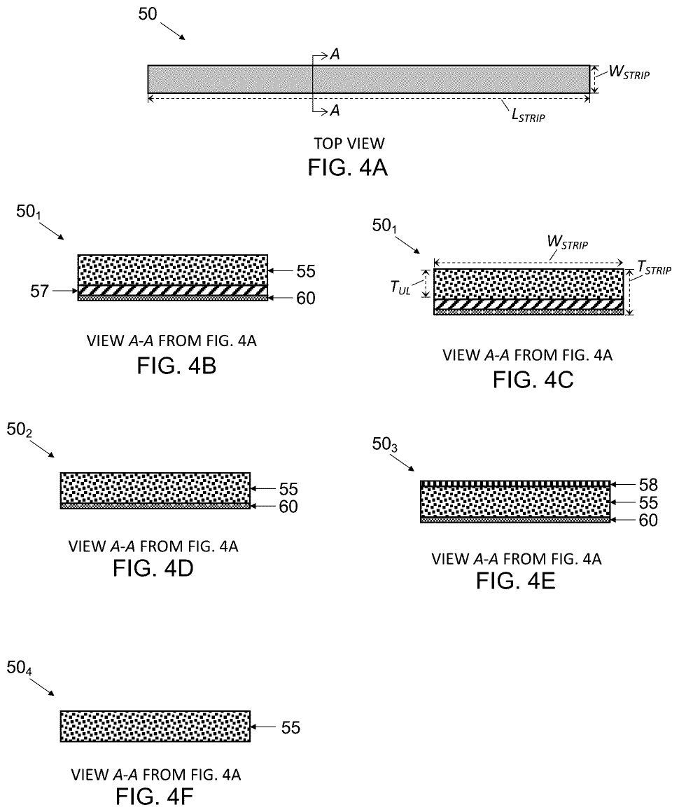

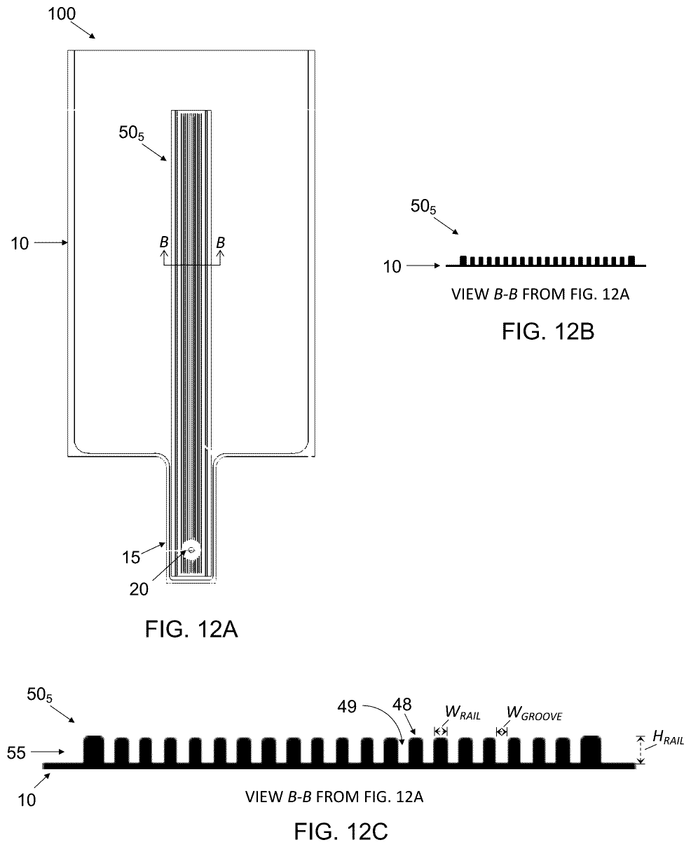

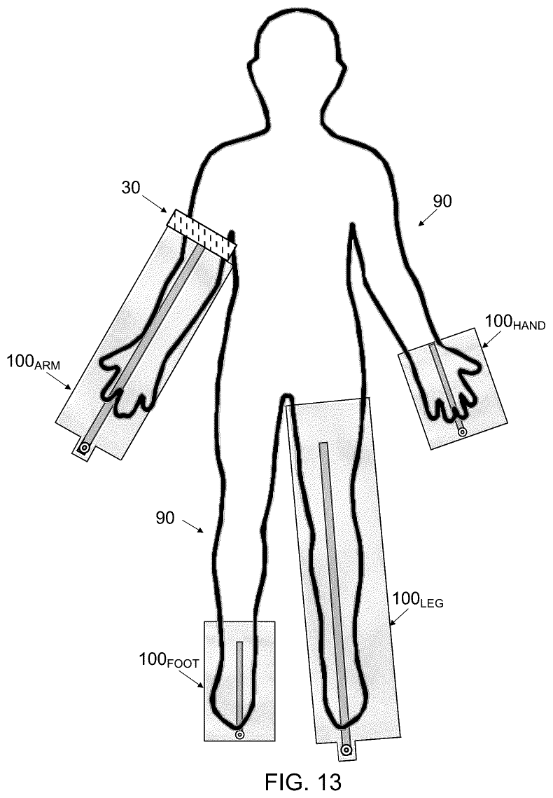

The apparatus 100 of FIG. 1 additionally comprises a strip 50 and a connection arrangement 20. The bag 10 of FIG. 1, like all other bags 10 in the accompanying figures, is shown as at least partly ‘transparent’ so that strip 50 is ‘visible’ within. Although there may be operational advantages to the bag 10 being at least partly transparent, or at least translucent, it is not required in the embodiments disclosed herein. Thus, in some examples, the bag 10 is opaque. The strip 50, in some exemplary embodiments, is a multi-layer strip, i.e., a strip comprising two or more layers, as will be discussed below in connection with FIGS. 4B-E. In some embodiments, the strip 50 is a gas-permeable strip comprising one or more layers, as will be discussed below in connection with FIGS. 4D and 4F. The strip 50 is affixed to an interior surface of the bag 10, i.e., a bag-surface in direct fluid communication with the interior volume of the bag. In embodiments, the affixing includes applying an adhesive so that the strip 50 is bonded, e.g., glued, to the interior surface of the bag 10. In some embodiments, the affixing is by a heat-based process such as, in a non-limiting example, heat welding, such that the strip 50 is heat-welded to the interior surface of the bag 10. In some embodiments such as are illustrated in FIGS. 12A-C, the strip 50 can be integrally formed with the bag 10.

The connection arrangement 20 is for connecting thereto a gas-connection hose introduced to mediate between a pressure-regulating device and the bag. The connection arrangement includes an opening 25 that allows a flow of gas, e.g., in the case of an increase or decrease in pressure, between the pressure-regulating device and the interior of the bag. In other words, pressure within the bag is regulated by connecting the pressure-regulating device to the connection arrangement 20. In some examples, the connection arrangement opening 25 is a simple hole, and in other examples the opening 25 includes one side of a male-female connection arrangement, or any other type of connection arrangement that matches a gas-connection hose suitable for use with the pressure-regulating device. In some embodiments, additional elements can be provided between the bag and the pressure-regulating device, e.g., on the ‘device’ side of the connection arrangement 20—for example, a collection canister for effluent(s), a bio filter, and one or more check valves, as illustrated in FIG. 21.

Respective “distal” and “proximal” directions of are indicated in FIG. 1 by arrow 210. The proximal end 12 of a bag 10 is that portion or end through which a user's limb can be inserted, and the distal end 13 is the opposite end. The connection arrangement 20 is mounted to a wall of the bag 10 in a distal portion, or close to the distal end 13. The strip 50 has a distal end in direct fluid communication with the connection arrangement 20 (including, specifically, the opening 25), and a proximal end disposed in a proximal portion of the bag 10. The proximal portion of the bag makes up as much as 50% of the bag 10, or as much as 40%, or as much as 30%, or as much as 25%, or as much as 20%, or even less. Thus, in some embodiments, the length of the strip 50 (its longer dimension, labeled L_{STRIP} in FIG. 4A) is equal to at least 50% of the length of the bag 10, or at least 60%, or at least 70%, or at least 75%, or at least 80%, or at least 85%, or at least 90%, or at least 95%. The length of the bag 10 is indicated in FIG. 1 as L_{BAG}. The length L_{BAG} can be the largest dimension of the bag 10 as shown in FIG. 1, but this may not be the case in every implementation. Therefore, the length L_{BAG} can be considered to be a distance from the proximal end 12 to the distal end 13 of the bag 10.

In embodiments, it can be desirable to ‘distance’ the connection arrangement 20 so it does not come into contact with the user's limb, e.g., to possibly cause discomfort. FIG. 2 shows a non-limiting example of an apparatus 100 comprising a bag 10 having a distal extension in the form of a tab 15. The tab 15 is open to the interior volume of the rest of the bag 10. In the example of FIG. 2, the connection arrangement 20 is mounted to an interior wall of the bag within the tab section 15, such that there is less opportunity for a user's limb to come into direct contact with the connection arrangement 20. In order for the use of a tab section 15 to be particularly effective in preventing direct contact with a user's limb, it is preferably of a narrower width than the rest of the bag 10: for example, the width of the tab section 15, indicated in FIG. 2 as W_{TAB} is limited to being less than 30% of the width of the bag 10 (W_{BAG}). In some embodiments, W_{TAB} is less than 25% of W_{BAG}, or less than 20%, or less than 15%, or less than 10%. In some embodiments, the length of the tab 15, indicated in FIG. 2 as L_{TAB}, is less than 25% of L_{BAG}, which is the total length of the bag 10, including the tab section 15, as shown in FIG. 2.

FIG. 3 shows an apparatus 100 directly connected to a pressure-regulating device 70 by a gas-connector hose 72. In some embodiments, the connection is not a direct connection. In some embodiments, the hose 72 can include gas-switching capabilities and/or multiple input/output connections. In some embodiments, the hose 72 is part of, or permanently attached to the pressure-regulating device 70, and in other embodiments is a separate element. The pressure-regulating device 70 can be any device suitable for applying and/or maintaining a pressure higher or lower than ambient pressure, e.g., for applying a therapy to a user's limb or torso. Examples of suitable pressure-regulating devices include, and not exhaustively: a negative-pressure therapy unit, an ozone therapy unit, a sequential pressure therapy unit, and a unit combining two or more of the therapies.

In some examples, a pressure-regulating device (70 or 550), is programmed to assume that ambient pressure is 760 mm Hg. In some examples, the pressure-regulating device is programmed to be preset at a given ambient pressure, e.g., at or close to a typical ambient pressure for the elevation of a user's location. In some examples, the pressure-regulating device measures the ambient pressure before or during a treatment session, or during equipment setup or at any other time, and applies it. In some examples, a pressure-regulating device is configured to increase or reduce pressure in a vessel by a preset amount. In some examples, a pressure-regulating device is configured to reach a preset or precalculated pressure in a vessel, either by increasing or reducing pressure. In any of the disclosed embodiments, a pressure-regulating device can combine any of the foregoing features and configurations.

We now refer to FIGS. 4A-F.

FIG. 4A is a top view of a strip 50 according to embodiments. The strip 50 has a length L_{STRIP} and a width W_{STRIP}. In embodiments, the length L_{STRIP} is at least 3 times longer than width W_{STRIP}, or at least 5 times longer, or at least 10 times longer. In some embodiments, a ration of L_{STRIP}:W_{STRIP} is between 3:1 and 5:1, or between 3:1 and 10:1, or between 3:1 and 20:1, or between 3:1 and 30:1, or between 5:1 and 10:1, or between 5:1 and 20:1, or between 5:1 and 30:1, or between 10:1 and 20:1, or between 10:1 and 30:1, or between 20:1 and 30:1.

In embodiments, the length L_{STRIP} is at least 10 cm, or at least 15 cm, or at least 20 cm, or at least 25 cm, or at least 30 cm. In embodiments, the width W_{STRIP} is between 1 cm and 6 cm, or between 2 cm and 5 cm, or between 2.5 cm and 4.5 cm. In some embodiments, the width W_{STRIP} is between 1 cm and 2 cm, or between 1 cm and 3 cm, or between 1 cm and 4 cm, or between 1 cm and 5 cm, or between 2 cm and 3 cm, or between 2 cm and 4 cm, or between 2 cm and 5 cm, or between 2 cm and 6 cm, or between 3 cm and 4 cm, or between 3 cm and 5 cm, or between 3 cm and 6 cm, or between 4 cm and 5 cm, or between 4 cm and 6 cm, or between 5 cm and 6 cm. All ranges cited throughout this specification are inclusive. In embodiments, the area of the strip 50, i.e., length L_{STRIP} multiplied by width W_{STRIP} is smaller than the area of the bag 10, i.e., length L_{BAG} multiplied by width W_{BAG}. In embodiments, the area of the strip is less than 20% of the area of the bag, or less than 15%, or less than 10%, or less than 5%.

FIGS. 4B-F are schematic illustrations of respective transverse cross-sections of various strips 50 according to embodiments, each of the respective illustrations corresponding to view A-A in FIG. 4A. FIG. 4B shows strip 50₁ comprising a bottommost layer 60, an intermediate layer 57 and an upper layer 55 comprising a partially-compressible gas-permeable material. In an example, the bottommost layer 60 is an adhesive layer. In another example, the bottommost layer 60 comprises a fabric that can be affixed to a wall of a bag by heat, for example by heat-welding. In an example, the intermediate layer 57 comprises a tightly woven or nonwoven fabric, and the upper layer 60 comprises one of a loosely woven fabric, a loop fabric, and a felt. As shown in FIG. 4C, the upper layer 60 has a thickness T_{UL}, and the strip 50 has a total thickness of T_{STRIP}. In some embodiments, the strip 50 has a total thickness T_{STRIP} no more than 3.5 mm, or no more than 5 mm, or no more than 7.5 mm, or no more than 10 mm. In some embodiments, the upper layer 55 has a thickness of no more than 3.5 mm, or no more than 5 mm, or no more than 7.5 mm, or no more than 10 mm. In embodiments, it can be desirable for the strip 50 to be rather ‘soft’ so as not to cause undue discomfort to a user should the user's limb, for example, rest on part of the strip 50. In some embodiments, the strip 50 has a Shore A hardness of at most 70, or at most 60, or at most 50, or at most 40. In some embodiments, the gas-permeable upper layer 55 has a Shore A hardness of at most 70, or at most 60, or at most 50, or at most 40.

A strip 50 is characterized by a dimensionless aspect ratio of T_{STRIP}/W_{STRIP}. In embodiments, T_{STRIP}/W_{STRIP} is between 1:1.5 and 1:20, or between 1:5 and 1:15, or between 1:8 and 1:12. In some embodiments, T_{STRIP}/W_{STRIP} is between 1:1.5 and 1:5, or between 1:1.5 and 1:10, or between 1:1.5 and 1:15, or between 1:1.5 and 1:20, or between 1:1.5 and 1:30, or between 1:5 and 1:10, or between 1:5 and 1:12, or between 1:5 and 1:20, or between 1:1.5 and 1:30, or between 1:8 and 1:15, or between 1:8 and 1:20, or between 1:8 and 1:30, or between 1:10 and 1:15, or between 1:10 and 1:20, or between 1:10 and 1:30, or between 1:12 and 1:20, or between 1:12 and 1:30, or between 1:15 and 1:20, or between 1:15 and 1:30, or between 1:20 and 1:30.

An upper layer 55 is characterized by a dimensionless aspect ratio of T_{UL}/W_{STRIP}. In embodiments, T_{UL}/W_{STRIP} is between 1:1.5 and 1:20, or between 1:5 and 1:15, or between 1:8 and 1:12. In some embodiments, T_{UL}/W_{STRIP} is between 1:1.5 and 1:5, or between 1:1.5 and 1:10, or between 1:1.5 and 1:15, or between 1:1.5 and 1:20, or between 1:1.5 and 1:30, or between 1:5 and 1:10, or between 1:5 and 1:12, or between 1:5 and 1:20, or between 1:1.5 and 1:30, or between 1:8 and 1:15, or between 1:8 and 1:20, or between 1:8 and 1:30, or between 1:10 and 1:15, or between 1:10 and 1:20, or between 1:10 and 1:30, or between 1:12 and 1:20, or between 1:12 and 1:30, or between 1:15 and 1:20, or between 1:15 and 1:30, or between 1:20 and 1:30.

The strip 50₂ of FIG. 4D comprises a partly-compressible upper layer 55 and a bottommost layer 60 as previously described. The strip 50₃ of FIG. 4E comprises the partly-compressible upper layer 55 and the bottommost layer 60, and an uppermost layer 58, such as, for example, a coating applied to the upper layer 55. The strip 50₄ of FIG. 4F comprises a partly-compressible, gas-permeable layer 55, which, in embodiments, is affixed to a wall of a bag, e.g., with an adhesive or by heat.

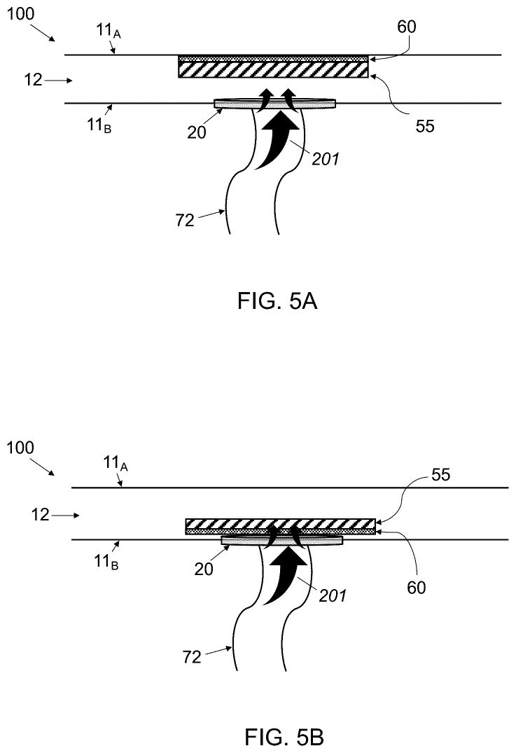

FIGS. 5A and 5B show a detail of an apparatus 100 illustrating the flow of a gas into and out of a bag 10, through a connection arrangement 20. In FIG. 5A, the connecting arrangement 20 is mounted to a wall 11_{B} of a bag 10, and a strip 50 is affixed to a second wall 11_{A}, which is ‘opposite’ the first wall 11_{B}, i.e., separated therefrom by the interior volume 12 of the bag 10. The interior volume 12 may not be an actual volume in an initial state when the apparatus 100 is first produced or first provided, but the apparatus 100 being usable necessarily entails creating an interior volume 12 within the bag 10, e.g., for receiving a limb of a user for a therapy. Thus, in the initial state, the strip 50 and the connecting arrangement 20 of FIG. 5A are on opposite walls 11_{A}, 11_{B}, but there may not be an interior volume separating them. As shown in the example of FIG. 5A, the bottommost layer 60 is the layer affixed to the wall 11_{A} of the bag 10. The term ‘bottommost layer’ is thus to be interpreted as meaning the layer closest to the wall of a bag to which it is affixed, and, accordingly, the term ‘upper layer is to be interpreted as meaning a layer further from that wall to which the strip is affixed, than the bottommost layer. In the example of FIG. 5A, the connecting arrangement 20 is in direct fluid communication with the upper layer 60 of the strip 50. The flow of gas between a pressure-regulating device (not shown in FIGS. 5A-B) and the interior volume 12 of the bag 10 is indicated by arrow 201. The directionality of arrow 201 in FIGS. 5A and 5B is not indicative of a limitation in direction but merely illustrative, and gas can flow in either direction, i.e., both in and out of the bag 10, depending on whether pressure in the bag 10 is being increased or decreased. In the example of FIG. 5B, the connection arrangement 20 is mounted to the same wall 11_{B} to which the strip 50 is affixed. In order to establish fluid communication between the connection arrangement 20 and the gas-permeable upper layer 60, bottommost layer 55 is necessarily at least partly open to a gas flow, for example, if bottommost layer 55 comprises a gas-permeable material and/or a porously or non-continuous material.

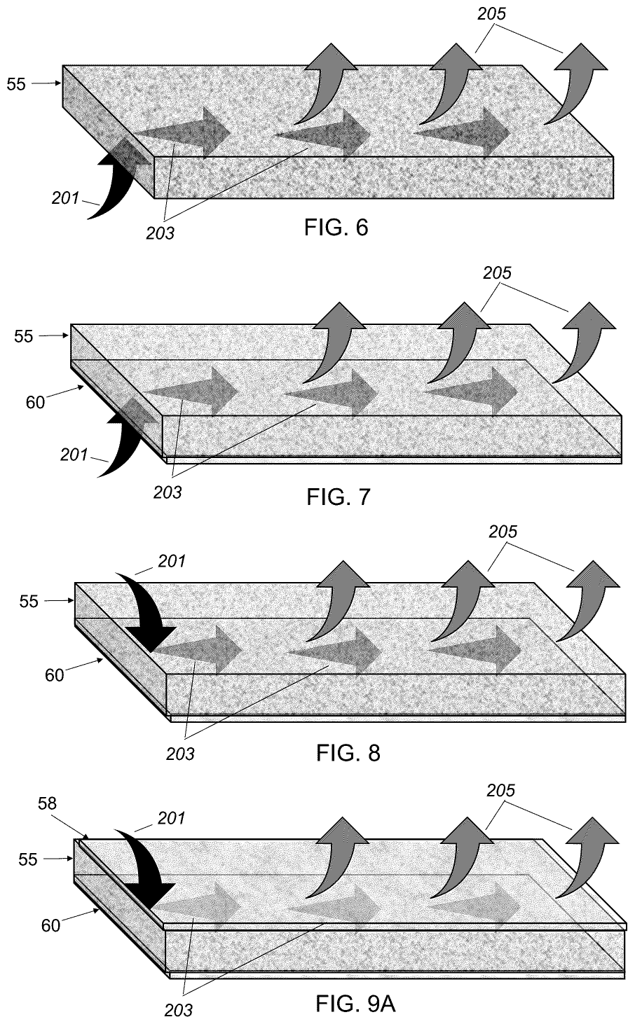

We now refer to FIGS. 6-9A, which are respective schematic illustrations of gas-flow pathways in strips 50. All flow arrows 201, 203 and 205 in FIGS. 6-9 are drawn as if illustrating only an inflow of a gas into the bag, but as was the case with FIGS. 5A and 5B, an apparatus 100 is configured so that gas can flow in either direction, i.e., both in and out of the bag 10, depending on whether pressure in the bag 10 is being increased or decreased. FIG. 6 shows a portion of a strip 50 comprising only a gas-permeable upper layer 55 similar to the example of strip 50₄ shown in FIG. 4F. A gas flow 201 is seen entering the strip from ‘below’ (i.e., from the direction of a connection arrangement 20 mounted to the same wall 11 that the strip 50 is affixed to (as in the example of FIG. 5B); if the gas-permeable layer 55 is affixed to the wall 11 of the bag 10 with an adhesive or with heat, the affixation is such that a gas flow 201 is still possible through a non-continuous application of adhesive (not shown) or non-continuation heat-welding. The gas flow propagates along the length of the strip (arrows 203) and can ‘leave’ the strip 50 through an upper surface, i.e., the surface furthest from the wall 11 of the bag 10 to which it is affixed, as indicated by arrows 205. In a use case, a bag 10 is partly evacuated, such that gas in the interior volume 12 of the bag 10 is removed via the connecting arrangement 20, and the two walls 11 of the bag 10 are brought together by the ‘negative’ pressure. ‘Partially evacuated’ means that a gas pressure in the bag is reduced to 560 mm Hg, or no more than 560 mm Hg, or to 660 mm Hg, or to no more than 660 mm Hg. The strip 50, being at most partly compressible, maintains a gas-flow pathway from the connection arrangement 20 (e.g., where arrow 201 is shown ‘entering’ the strip 50), to any point on the upper surface of the strip, e.g., a point at which a pressure-related therapy is direction. As discussed earlier, the gas-flow pathway has no directionality. The term ‘maintains a gas-flow pathway’ and other similar terms mean remaining open for a gas flow therethrough, wherein the gas flow is adequate for the purposes of the relevant therapy or other purpose. In an illustrative, non-limiting example related to a negative-pressure wound therapy, a bag is partially evacuated to 560 mm Hg absolute gas pressure, all of the air is removed from the bag except for air remaining within the gas-flow pathway, i.e., of a gas-permeable strip or layer or material, and the gas-flow pathway is ‘maintained’, i.e., there is enough gas flow therethrough to allow for the negative pressure to be transmitted from the connecting arrangement to, for example, a wound in fluid communication with the gas-permeable material.

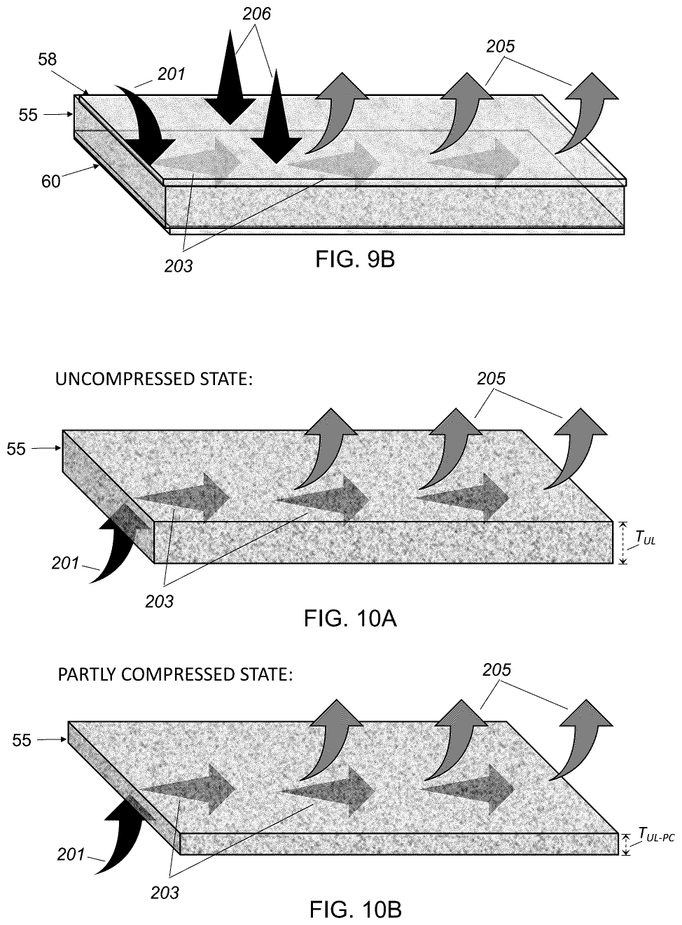

Similarly, FIG. 7 illustrates another strip 50, analogous to the strip 50 of FIG. 5B, wherein the gas-flow pathway passes through (arrow 201) the bottommost layer 60 through, e.g., pores and/or areas of non-continuous application of heat joining or adhesive. In a non-limiting example, the bottommost layer 60 is removed from that area of the strip 50 placed directly over the opening 25 of the connection arrangement 20. FIG. 8 illustrates a gas-flow pathway in another exemplary strip 50, analogous to the strip 50 of FIG. 5A, in which the gas-permeable upper layer 55 is affixed to the wall opposite the wall to which the connection arrangement is mounted, and is thus in direct fluid communication with the connection arrangement 20. The strip 50 of FIG. 9A is analogous to the strip 503 of FIG. 4E, in which an at least partly gas-permeable uppermost layer (or coating) 58 is interposed between the gas-permeable upper layer 60 and the interior 12 of the bag 10.

In all of the examples of FIGS. 6-9A, the apparatus 100 is configured, and component materials are selected, such that a gas-flow pathway can be maintained through the gas-permeable upper layer 55, e.g., the flow-path (in either direction) indicated by arrows 201, 203, 205 within a broad range of pressures relative to pressure-related therapies. An adequate gas-flow pathway is one that is adequate for a flow of gas that is required by the pressure-related therapies. In examples, a pressure-regulating mode of the apparatus 100 can include reaching and/or maintaining a pressure inside the bag 10 within a range of 460 mm Hg to 1060 mm Hg, or within a range of 460 mm Hg (i.e., 300 mm Hg of ‘negative pressure) to 760 mm Hg, or within a range of 560 mm Hg to 760 hg, or within a range of 760 mm Hg to 1060 mm Hg (i.e., 300 mm Hg of positive pressure), or within a range of 760 mm Hg to 960 mm Hg. In embodiments, it can be desirable that the material(s) of the gas-permeable upper layer 55 be selected so that the upper layer 55 (and the strip 50 as a whole) is at most partly compressible, i.e., not completely compressible, since being completely compressible could allow the gas-flow pathway to be closed off at one or more points, or even completely, with application of a ‘negative’ pressure, i.e., evacuation of the bag 10. The skilled artisan will understand that use of the term ‘at most partly compressible’ or ‘at-most-partially compressible’ or other similar terms applies to the partial but not complete compressibility when subjected pressures encountered during the therapies and uses disclosed herein. In embodiments, the concept of being ‘at most partly compressible’ applies to pressures acting upon the strip in a range between 460 mm Hg to 1520 mm Hg, i.e., from 300 mm Hg below atmospheric pressure to two atmospheres.

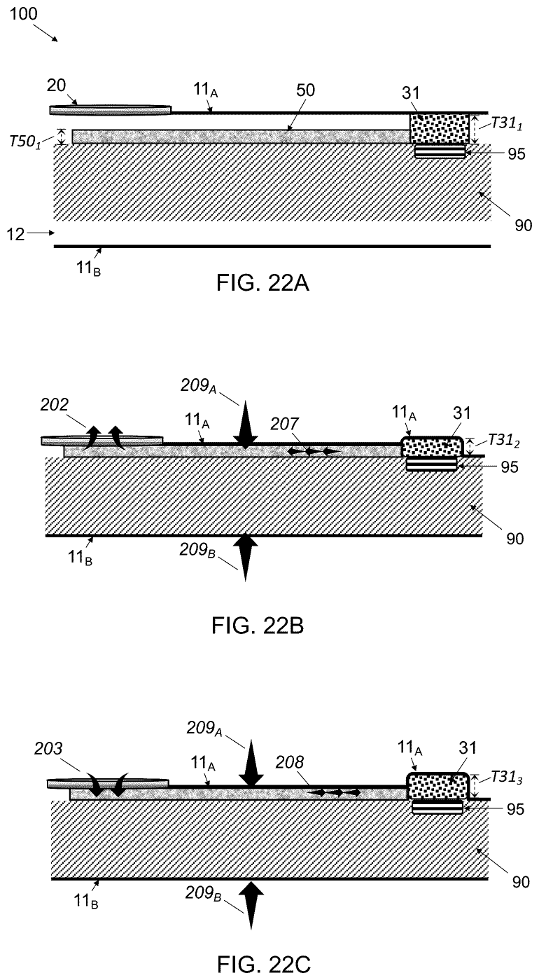

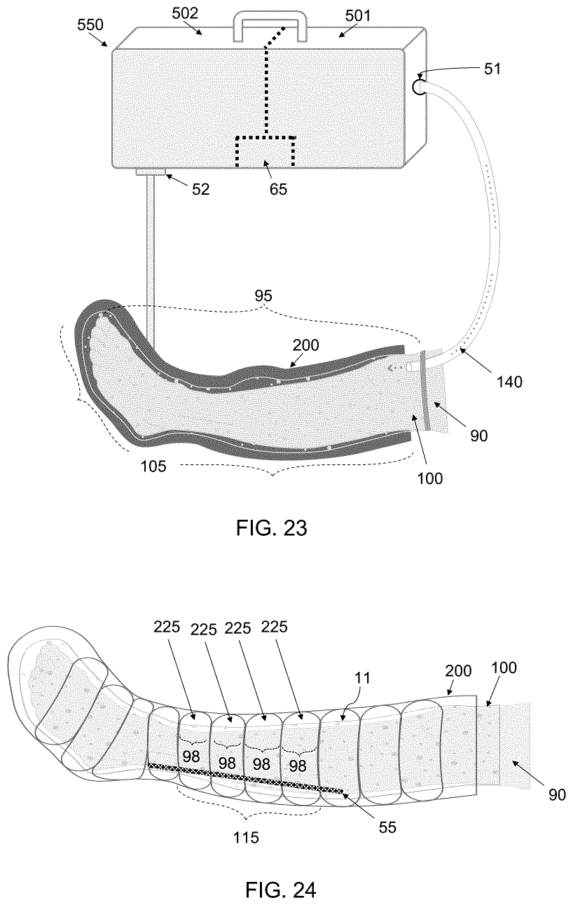

FIG. 9B shows the strip 50 of FIG. 9A, with the addition of an externally-applied pressure (indicated in FIG. 9B by arrows 206, e.g., a mechanical pressure, that is applied from outside the bag 10, e.g., to an outer surface of the bag wall 11_{B} of FIG. 5A. Examples of external mechanical pressures are discussed below with reference to FIGS. 23, 24, 25 and 26A-F. Note: with the exception of the externally-applied pressure illustrated in FIG. 9B, all other pressures disclosed herein are gas pressures. Moreover, any pressure cited in this disclosure or in the claims appended thereto that are at least 460 mm Hg is an ‘absolute’ pressure even if not explicitly described as such, whilst pressures of 100 mm Hg or less are ‘gauge’ pressures, even if not explicitly described as such. The pressure is transmitted through the bag wall 11 (not shown in FIG. 9B) to the uppermost layer 58 of the strip, causing compression of the gas-permeable layer 55. In some examples, the compression of the gas-permeable layer 55 due to the application of the externally-applied pressure 206 is in addition to compression caused by, for example, a negative (less than ambient) pressure, i.e., partial evacuation of the bag 10, in a pressure-regulating mode. Another type of mechanical pressure applied to the gas-permeable layer 55 is the force of two opposing walls of the bag under negative pressure, as discussed below with reference to FIGS. 22A-C.

In the example of FIG. 9B, the apparatus 100 is configured, and component materials are selected, such that a gas-flow pathway can be maintained through the gas-permeable upper layer 55, e.g., the flow-path (in either direction) indicated by arrows 201, 203, 205 within a broad range of externally-applied pressures relative to pressure-related therapies. An adequate gas-flow pathway is one that is adequate for a flow of gas that is required by the pressure-related therapies. In examples, a pressure-regulating mode of the apparatus 100 can include an externally-applied pressure 206 reaching and/or maintaining a pressure transmitted to the gas-permeable layer through bag wall 11 and uppermost layer 58 (if present) in a range from 0 mm Hg to 20 mm Hg, or from 0 mm Hg to 30 mm Hg, or from 0 mm Hg to 40 mm Hg, or from 0 mm Hg to 50 mm Hg, or from 0 mm Hg to 60 mm Hg, or from 0 mm Hg to 70 mm Hg, or from 0 mm Hg to 80 mm Hg, or from 0 mm Hg to 90 mm Hg, or from 0 mm Hg to 100 mm Hg.

A partly-compressible, gas-permeable upper layer 55 is shown in an uncompressed state in FIG. 10A, and in a partly compressed state in FIG. 10B. The thickness of the upper layer 55 is reduced, by the partial compressing, from T_{UL} to T_{UL-PC} by the force of compression, e.g., from partial evacuation of a bag 10 by a pressure-regulating device, e.g., pressure-regulating device 70 of FIG. 3. The bidirectional gas flows indicated by arrows 201, 203 and 205 continue provide a viable gas-flow pathway in the partially compressed state of FIG. 10B.

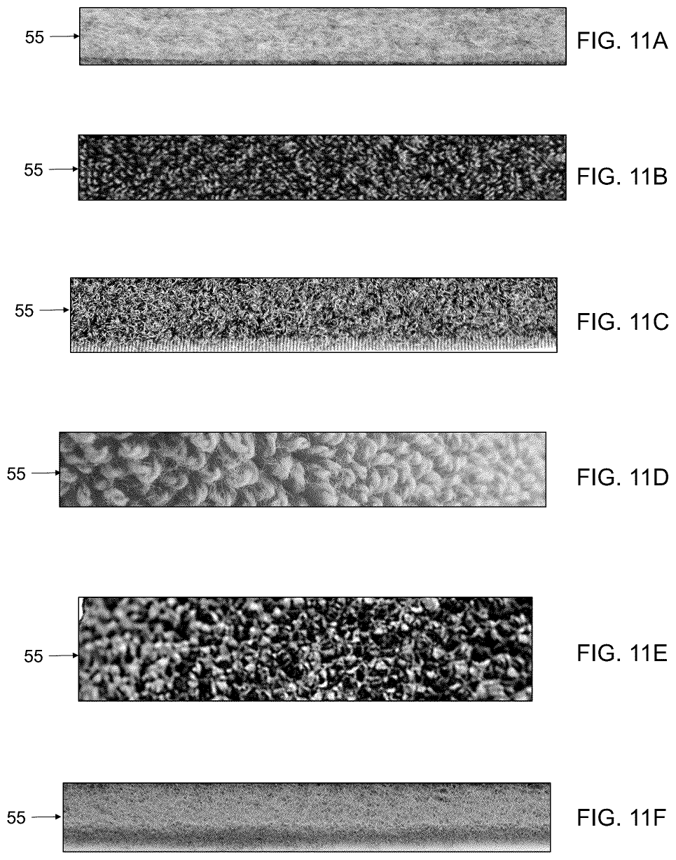

We refer now to FIGS. 11A-F, which show photographs of 5 exemplary partially-compressible, gas-permeable upper layers 55 according to embodiments.

The partially-compressible, gas-permeable upper layer 55 of FIG. 11A comprises a felt fabric.

The partially-compressible, gas-permeable upper layer 55 of FIG. 11B comprises a French terry fabric.

The partially-compressible, gas-permeable upper layer 55 of FIG. 11C comprises a nylon loop fabric—the foreground of the photograph also shows a woven fabric base layer, e.g., intermediate later 57 of FIGS. 4B-C.

The partially-compressible, gas-permeable upper layer 55 of FIG. 11D comprises a cotton terry fabric.

The partially-compressible, gas-permeable upper layer 55 of FIG. 11E comprises a polyurethane foam sheet.

The partially-compressible, gas-permeable upper layer 55 of FIG. 11F comprises a partially compressed mat of nonwoven synthetic fibers, e.g., nylon or cellulose.

The foregoing 6 non-limiting examples of suitable materials for gas-permeable upper layers 55 are all capable of maintaining a viable gas-flow pathway when partially compressed, e.g., as illustrated in FIG. 10B.

We now refer to FIGS. 12A, 12B and 12C, which schematically illustrate an exemplary apparatus 100 according to embodiments which comprises a strip 50₅ that is integrally formed with a wall of the bag 10. In the non-limiting example of FIGS. 12A-C, the strip 50₅ includes a plurality of parallel rails 48 separated by grooves 49. The grooves 48 can be formed from the same material as the wall(s) of the bag 10, but not necessarily. Each of the rails 48 has a height H_{RAIL} and a width W_{RAIL}, while each of the grooves 49 has a width W_{GROOVE}. The ‘height’ of the rails as described here is equivalent to the ‘thickness’ of the strip as discussed elsewhere herein.

In the illustrated example, the outermost rails are wider and higher than the rest of the rails 48. In other examples, all of the rails have the same dimensions and spacing therebetween, and in yet other examples, many or all of the rails have different or even unique dimensions and spacing therebetween. Selection of heights and widths can be based on the requirements for maintaining a lengthwise gas-flow pathway of sufficient capacity and robustness. For example, rail heights are preferably selected so as not to be so short and/or too closely spaced that gas flow could be insufficient when the bag is partly evacuated, the walls of the bag collapse and all gas flow must pass through the grooves. Conversely, rails heights are preferably selected to not be so long that they can be bent over by the force of the walls collapsing when the bag is partly evacuated, e.g., if the material selection and width of the rails allow it. The spacing between adjacent rails, i.e., W_{GROOVE}, is preferably selected so as not to be so widely-spaced that a wall of the bag doesn't easily get folded into a groove when the walls of the bag collapse when the bag is partly evacuated.

In some embodiments, the respective heights H_{RAIL} of the rails are between 1 mm and 3 mm, 1 mm and 4 mm, or between 1 mm and 5 mm, or between 2 mm and 3 mm, or between 2 mm and 4 mm, or between 2 mm and 5 mm.

In some embodiments, the integrally formed strip 505 can include a configuration other than straight rails 48 and grooves 49. In one example (not illustrated), a plurality of protrusions forms a gas pathway that is at most partly compressible when the bag 10 is partly evacuated, e.g., to 100 mm Hg gauge below ambient.

The integrally formed strip 50₅ of FIGS. 12A-C shares many features with the strips 50 of, e.g. FIGS. 1, 2 and 3, including, but not exhaustively: lengths and ratios thereof, widths and ratios thereof, areas and ratios thereof, position within a bag or tab-section extension, and functionality as a gas-flow pathway.

In embodiments, it can be desirable to size an apparatus 100 in accordance with a specific type of adult limb. In the schematic illustration of FIG. 13, four examples of limb-sized apparatuses 100 are shown in respective donned modes for 4 limbs 90 of a human user (clockwise from left): 100_{ARM} provided in a size suitable for easy and convenient use of an adult human arm; 100_{HAND} provided in a size suitable for easy and convenient use of an adult human hand; 100_{LEG} provided in a size suitable for easy and convenient use of an adult human leg; and 100_{FOOT} provided in a size suitable for easy and convenient use of an adult human foot. In embodiments, each limb-specific apparatus can be sized to received at least a majority of the specific limb, or most of the limb, or all of the limb up to a joint, e.g., wrist for a hand-apparatus, shoulder for an arm-apparatus, etc. Any of the apparatuses can be provided without a tab-section extension 15 (as shown in the case of 100_{HAND} and 100_{FOOT}) or with a tab-section extension 15 (as shown in the case of 100_{ARM} and 100_{LEG}). In each of the examples, the connection arrangement 20 is preferably disposed so as to not bother the user's limb to cause discomfort. In embodiments, a limb-sealing element 30, e.g., an adhesive tape, can be provided to provide a seal between the limb and the periphery of the open proximal end of the bag 10.

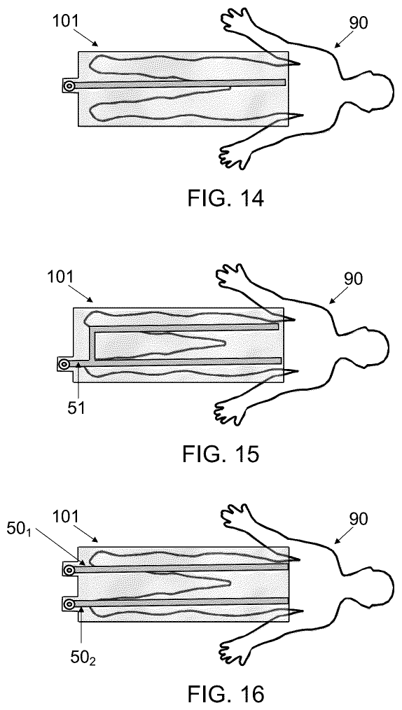

FIGS. 14, 15 and 16 show non-limiting examples of apparatuses 100 intended to for use with a user's torso, or with at least two limbs, e.g., both legs, or with part of a torso including the at least two limbs. FIG. 14 shows an apparatus 100 comprising a single and simple strip 50 and a single connecting arrangement. FIG. 15 shows an alternative configuration for an apparatus 100 including a single, but complex strip 50, where a single connecting arrangement 20 is made to be in fluid communication with two branches of the strip 50. FIG. 16 shows another alternative configuration for a single apparatus 100 including two separate connection arrangements 20 displaced laterally from each other in the distal portion of the bag 10, and two respective strips 50, each in fluid communication with a corresponding connecting arrangement 20. The skilled artisan will understand that the alternative configurations of FIGS. 15 and 16 are easily translated into ordinary apparatuses 100, i.e., apparatuses sized not for a torso but for individual limbs such as the exemplary apparatuses of FIGS. 1-3 and 13.

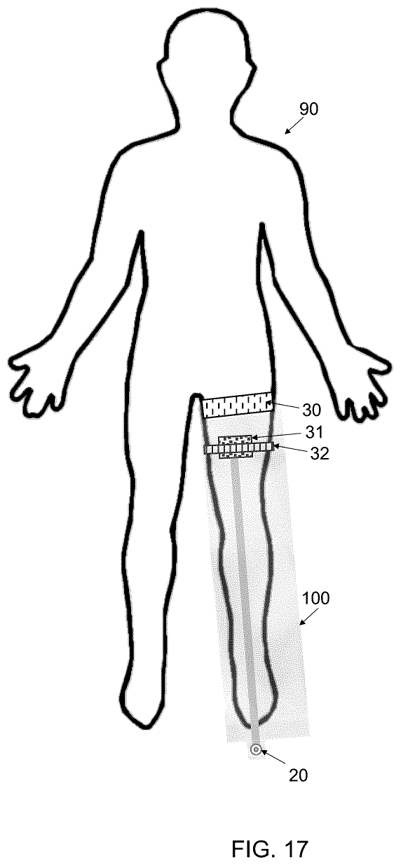

As disclosed hereinabove, a strip 50 is preferably ‘soft’ enough so as to not provide discomfort to a user. Nonetheless, it can happen that a user is more comfortable not having the strip 50 be in direct contact with a sensitive area, e.g., a wound. Additionally or alternatively, it might be inconvenient in some implementations to line up the connecting arrangement 20 with the user's wound so as to keep the strip in a straight line. Thus, it can be desirable to extend the gas-flow pathway provided by the strip 50 transversely around the circumference of the leg. As illustrated in FIG. 17, an elastic ribbon 32 of a gas-pathway material is provided for disposition, in an on-limb configuration, as a transverse extension of the gas-flow pathway (i.e., extending transversely from the strip, to go around the limb). In some embodiments, a sponge 31 or similarly soft element is provided to be interposed between a wound and the strip 50, or between a wound and the elastic ribbon 32.

Any of the features described herein with respect to the various apparatuses and their respective components can be combined to make new combinations not specifically disclosed herein for purposes of conciseness, and such combinations are well within the scope of the present invention.

FIG. 18 shows a kit 300 comprising an apparatus 100—according to any one or more of the embodiments disclosed herein—along with an elastic ribbon 32 and a wound-covering sponge 31.

FIG. 19 shows a kit 310 comprising an apparatus 100—according to any one or more of the embodiments disclosed herein—along with a limb-sealing tape 30.

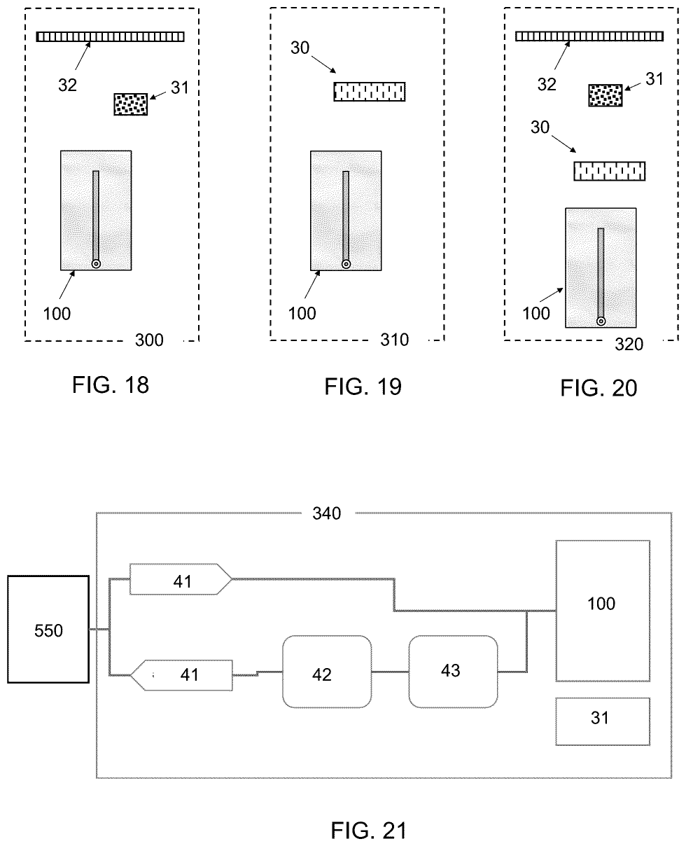

FIG. 20 shows a kit 320 comprising an apparatus 100—according to any one or more of the embodiments disclosed herein—along with an elastic ribbon 32, a wound-covering sponge 31, and a limb-sealing tape 30.

FIG. 21 shows a kit 340 comprising an apparatus 100—according to any one or more of the embodiments disclosed herein—along with an elastically compressible element, e.g., an open-celled foam or sponge 31, a collection canister 43, e.g., for exuded fluids, a bio filter 42, and one or more check valves 41. The kit 340 is schematically shown in communication with a pressure-regulating device 550.

Some embodiments of the invention relate to a system for carrying out treatment protocols. In embodiments, the system includes a gas-transfer apparatus comprising a negative-pressure pump operable to at least 50, 75, 100, 150 or 200 mm Hg below ambient pressure; supply of the therapeutic gases; and/or a positive pressure system including a compressor operable of increasing pressure of a gas by at least 40, 70, 100, 130, or 160 mm Hg. The system may additionally include one or more closed-end vessels, e.g., wearable, one-time-use bags having within gas-flow pathways that remain viable under the negative pressures and/or externally-applied pressure of the treatment protocol; a wound sponge for communicating an underpressure to a target area such as a wound, and, as necessary, additional gas-flow pathway elements for securing an unbroken gas-flow pathway to/from a wound at one end of the pathway and a connection to the gas-transfer apparatus at the other end. The system may additionally include reusable compression sleeves sized for partly surrounding the closed-end vessel(s) enveloping respective limb(s). The compression sleeves are operable to be repeatedly pressurized at up to 60 mm Hg, up to 80 mm Hg or up to 100 mm Hg above ambient.

An exemplary treatment protocol according to embodiments includes a first phase with variable compression therapy in the presence of a therapeutic gas.

Another exemplary treatment protocol includes a second phase including additional gas therapy with underpressure, i.e., pressure below ambient or sub-ambient pressure.

More typically, such an exemplary treatment protocol includes both the first phase with variable compression therapy in the presence of a gas, e.g., a therapeutic gas, and the second phase including additional gas therapy with underpressure.

In embodiments, the treatment begins with removal of edema from a wound area in order to improve blood flow to the damaged tissues, and evacuation of the edema and any other excretions from the wound, in the presence of the therapeutic gas. After the evacuation and initial disinfection, the underpressure (partial vacuum) allows the therapeutic gas to reach the damaged tissues directly.

A first non-limiting example of a treatment protocol includes the following procedures:
a. An elastically compressible element 31, e.g., wound sponge comprising an open-celled foam is placed on a target area, e.g., a wound on a limb;
b. The limb is inserted into a first vessel, e.g., bag 10 equipped with a gas-flow pathway strip 50, and the upper (proximal) opening is sealed;
c. A portion of gas 14 is evacuated from the bag 10 using a pressure-regulating device 550; in some embodiments, as much gas as practically possible is evacuated, the seal is checked during the evacuation;
d. A second vessel, e.g., sequential compression sleeve 200 is donned so as to radially envelop the first vessel 100 (this procedure may be performed earlier, e.g., before partly evacuating the first vessel;
e. A therapeutic gas, e.g., a gas including ozone is produced in a mixture with oxygen, e.g., by introducing an oxygen source to an ozone generator;
f. A therapeutic gas 14 is introduced to the first vessel 100—the gas is not necessarily a therapeutic gas—in amount of gas between 0.3 liters and 10 liters, and/or between 5% and 60% of the maximum volume of the first vessel 100;
g. The sequential compression sleeve 200 applies pressure on the bag 10, e.g., so as to longitudinally circulate the (therapeutic) gas via the strip 50. This procedure may continue for at least 3 minutes and no more than 120 minutes, or at least 5 minutes and no more than 90 minutes, or at least 7 minutes and not more than 75 minutes, or any intermediate range;
h. A portion of the (therapeutic) gas 14 is evacuated from the bag 100 to decrease the pressure in the bag 100 to a first below-ambient pressure, e.g., between 60 and 100 mm Hg (gauge) below ambient. The level of vacuum is sufficient to at least partially collapse the elastically-compressible element 31 as illustrated in FIG. 22B;
i. The second vessel (sequential compression sleeve 200) is removed;
j. A second amount of gas, e.g., a second amount of therapeutic gas, is introduced to the bag 10, to reduce the level of vacuum (to raise the internal pressure of the bag 10) by between 40 and 88 mm Hg (gauge) to a second below-ambient pressure below ambient; this can be done once or intermittently;
k. The vacuum is maintained in the bag 100 for at least 3 minutes, or at least 5 minutes, or at least 7 minutes, or longer;
l. The vacuum can be cycled between the first and second below-ambient pressure ranges.

We now refer to FIGS. 22A, 22B, and 22C.

FIG. 22A shows a partial cross-sectional schematic view of a limb 90, e.g., a leg, in the interior volume 12 of a bag 10 (of an apparatus 100 according to embodiments). A gas-flow pathway includes two portions: a first portion comprising a gas-flow pathway strip 50 and a second portion comprising an elastically compressible element 31 such as a wound sponge 31, e.g., comprising an open-celled foam). The elastically compressible element 31 is in fluid communication with a target area 95 of the limb 90 such as a wound—direct fluid communication in the illustrated example—and the first portion (strip 50) is in fluid communication with the connection arrangement 20. The second portion is preferably thicker than the first portion, but more compressible. For example, at the vacuum levels mentioned above (up to 100 mm Hg gauge below ambient), the second portion retains less than 80% of its original thickness T31₁, or less than 70%, or less than 60%, or less than 50%, while the first portion retains at least 80% of its original thickness T50₁, or at least 90%, or at least 95%.

FIG. 22B shows the partial evacuation of the bag 100, e.g., to a pressure of up to 100 mm Hg gauge below ambient, e.g., 60 to 100 mm Hg gauge, the partial evacuation indicated by arrows 207 and 202. This partial evacuation exemplifies step ‘h’ in the example above. The vacuum collapses the walls 11_{A}, 11_{B} of the bag 10, which exert a force on the interior contents of the bag, as indicated by arrows 209_{A}, 209_{B}. The second portion, i.e., sponge 31, is compressed by these forces 209_{A}, 209_{B}. to a second thickness of T31₂, which is at least 40% less than the original thickness T31₁. The first portion, strip 50, is also compressed by forces 209_{A}, 209_{B}, but to a negligible extent, e.g., less than 5% of original thickness T50₁.

FIG. 22C shows the introduction of gas, e.g., a therapeutic gas, into the bag 100, as indicated by arrows 203 and 208. This introduction of gas exemplifies step ‘j’ in the example above. The pressure in the bag 100 rises to 20 to 88 mm Hg below ambient, and the gas-flow pathway can partially expand. The forces of the walls 11_{A}, 11_{B} on the contents, indicated by arrows 209_{A}, 209_{B}, are accordingly lessened. The second portion 31, in particular, is biased to expand when the vacuum is lessened or removed. This can be seen in FIG. 22C, where the thickness of the second portion 31 increases to a third thickness of T31₃, which is larger than T31₂ but still smaller than the original thickness T31₁ because the bag is still under partial vacuum, albeit reduced. According to embodiments, when ambient pressure is restored, the second portion 31 returns to its original thickness T31₁.

Referring again to FIG. 1, a non-limiting example of a closed-ended vessel for use in a therapy, apparatus 100, is shown. The closed-ended vessel 100 includes a pliable bag 10, shown in FIG. 1 in a two-dimensional projection, or in an initial before-use mode and in an unconnected state. Bags 10 according to the embodiments are produced from any suitably pliable material that can maintain a positive and/or negative pressure over a limited period of time, i.e., minutes or hours, but not necessarily days or weeks.

A construction material for a bag 10 can be selected for compatibility with ozone gas, such as, for example, a polyethylene. Maintaining the pressure is generally a function of permeability of the construction material(s) of the bag, and in some cases thickness of the material. “Maintaining” a pressure, as the term is used herein should be understood to mean maintaining a set or specified pressure, or within 0.1% of the set or specified pressure over the course of a minute, or within 0.5%, or within 1%, or within 2%, or within 3%, or within 4%, or within 5%, or within 10%, or within 20% or within 30% over the course of a minute. Maintaining can also include making small adjustments, e.g., by a pressure-regulating device connected to the bag, in order to reduce the variation in pressure. “Positive” and “negative” pressures should be understood to mean that a pressure is respectively higher or lower than ambient pressure. For example, if ambient pressure is 760 mm Hg (millimeters of mercury), then 460 mm Hg would be called a negative pressure and 1,060 mm Hg would be called a positive pressure. Thus, a negative-pressure therapy is a therapy applied at a pressure below ambient pressure; a negative pressure, i.e., a pressure greater than 0 mm Hg and less than ambient pressure can also be characterized herein as being “a partial vacuum” or similar.

The closed-ended vessel 100 of FIG. 1 additionally comprises a gas-flow strip 50 and a connection arrangement 20. The bag 10 of FIG. 1, is shown as at least partly ‘transparent’ so that strip 50 is ‘visible’ within, but transparency is not required in the embodiments disclosed herein. The strip 50, in some embodiments, is a multi-layer strip, i.e., a strip comprising two or more layers, e.g., a gas-flow pathway layer and one or more additional layers for attachment to an inner wall of the bag. The strip 50 is affixed to an interior surface of the bag 10, i.e., a bag-surface in direct fluid communication with the interior volume of the bag. In embodiments, the affixing includes applying an adhesive so that the strip 50 is bonded, e.g., glued, to the interior surface of the bag 10. In some embodiments, the affixing is by a heat-based process such as, in a non-limiting example, heat welding, such that the strip 50 is heat-welded to the interior surface of the bag 10.

The connection arrangement 20 is for connecting thereto a gas-connection hose introduced to mediate between a pressure-regulating device and the bag. The connection arrangement includes an opening 25 that allows a flow of gas, e.g., in the case of an increase or decrease in pressure, between the pressure-regulating device and the interior of the bag. In other words, pressure within the bag is regulated by connecting the pressure-regulating device to the connection arrangement 20. In some examples, the connection arrangement opening 25 is a simple hole. In other examples the opening 25 includes one side of a male-female connection arrangement, or a valve openable by connecting the correct gas hose to it, or any other type of connection arrangement that matches a gas-connection hose suitable for use with the pressure-regulating device.

Respective “distal” and “proximal” directions of are indicated in FIG. 1 by arrow 210. The proximal end 12 of a bag 10 is that portion or end through which a user's limb can be inserted, and the distal end 13 is the opposite end. The connection arrangement 20 is mounted to a wall of the bag 10 in a distal portion, or close to the distal end 13. The strip 50 has a distal end in direct fluid communication with the connection arrangement 20 (including, specifically, the opening 25), and a proximal end disposed in a proximal portion of the bag 10. The proximal portion of the bag makes up as much as 50% of the bag 10, or as much as 40%, or as much as 30%, or as much as 25%, or as much as 20%, or even less. Thus, in some embodiments, the length of the strip 50 (its longer dimension, labeled L_{STRIP} in FIG. 4A) is equal to at least 50% of the length of the bag 10, or at least 60%, or at least 70%, or at least 75%, or at least 80%, or at least 85%, or at least 90%, or at least 95%. The length of the bag 10 is indicated in FIG. 1 as L_{BAG}. The length L_{BAG} can be the largest dimension of the bag 10 as shown in FIG. 1, but this may not be the case in every implementation. Therefore, the length L_{BAG} can be considered to be a distance from the proximal end 12 to the distal end 13 of the bag 10.

In embodiments, it can be desirable to ‘distance’ the connection arrangement 20 so it does not come into contact with the user's limb, e.g., to possibly cause discomfort. FIG. 2 shows a non-limiting example of an apparatus 100 comprising a bag 10 having a distal extension in the form of a tab 15. The tab 15 is open to the interior volume of the rest of the bag 10. In the example of FIG. 2, the connection arrangement 20 is mounted to an interior wall of the bag within the tab section 15, such that there is less opportunity for a user's limb to come into direct contact with the connection arrangement 20. In order for the use of a tab section 15 to be particularly effective in preventing direct contact with a user's limb, it is preferably of a narrower width than the rest of the bag 10.

FIG. 5A schematically illustrates a cross-sectional detail of a vessel 100 illustrating the flow of a gas into and out of a bag 10, through a connection arrangement 20. The connecting arrangement 20 is mounted to a wall 11_{B} of a bag 10, and a strip 50 is affixed to a second wall 11_{A}, which is ‘opposite’ the first wall 11_{B}, i.e., separated therefrom by the interior volume 12 of the bag 10. The interior volume 12 may not be an actual volume in an initial state when the apparatus 100 is first produced or first provided, but the vessel 100 being usable necessarily entails creating an interior volume 12 within the bag 10, e.g., for receiving a limb of a user for a therapy. Thus, in the initial state, the strip 50 and the connecting arrangement 20 of FIG. 5A are on opposite walls 11_{A}, 11_{B}, but there may not be an interior volume separating them. As shown in the example of FIG. 5A, the connecting arrangement 20 is in direct fluid communication with the upper layer 55 of the strip 50, i.e., the layer displaced furthest from the wall 11 to which the strip 50 is attached. The flow of gas between a pressure-regulating device (not shown in FIG. 5A) and the interior volume 12 of the bag 10 is indicated by arrow 201. The directionality of arrow 201 in FIGS. 5A and 5B is not indicative of a limitation in direction but merely illustrative, and gas can flow in either direction, i.e., both in and out of the bag 10, depending on whether pressure in the bag 10 is being increased or decreased.

We now refer again to FIGS. 6 and 8, which are respective schematic illustrations of gas-flow pathways in strips 50. All flow arrows 201, 203 and 205 in FIGS. 6 and 8 are drawn as if illustrating only an inflow of a gas into a bag 10, but in general a vessel 100 is configured so that gas can flow in either direction, i.e., both in and out of the bag 10, depending on whether pressure in the bag 10 is being increased or decreased.

FIG. 6 shows a portion of a gas-flow pathway comprising a strip 50 which includes a gas-permeable layer 55. A gas flow 201 is seen entering the strip 50, and it propagates along the length of the strip (arrows 203) and can ‘leave’ the strip 50 through any surface as indicated by arrows 205. In a use case, a bag 10 is partly evacuated, such that gas in the interior volume 12 of the bag 10 is removed via the connecting arrangement 20, and the two walls 11 of the bag 10 are brought together by the ‘negative’ pressure. ‘Partially evacuated’ means that a gas pressure in the bag is reduced to 560 mm Hg, or no more than 560 mm Hg, or to 660 mm Hg, or to no more than 660 mm Hg. The strip 50, being at most partly compressible, maintains a gas-flow pathway from the connection arrangement 20 (e.g., where arrow 201 is shown ‘entering’ the strip 50), to any point on the upper surface of the strip, e.g., a point at which a pressure-related therapy is direction. As discussed earlier, the gas-flow pathway has no directionality. The term ‘maintains a gas-flow pathway’ and other similar terms mean remaining open for a gas flow therethrough, wherein the gas flow is adequate for the purposes of the relevant therapy or other purpose. In an illustrative, non-limiting example related to a negative-pressure wound therapy, a bag is partially evacuated to 560 mm Hg absolute gas pressure, all of the air is removed from the bag except for air remaining within the gas-flow pathway, i.e., of a gas-permeable strip or layer or material, and the gas-flow pathway is ‘maintained’, i.e., there is enough gas flow therethrough to allow for the negative pressure to be transmitted from the connecting arrangement to, for example, a wound in fluid communication with the gas-permeable material. As shown in FIG. 8, the strip can also include one or more layers 60, e.g., for attachment to a wall 11 of a bag 10.

In the examples of FIGS. 6 and 8, the vessel 100 is configured, and component materials are selected, such that a gas-flow pathway can be maintained through the gas-permeable layer 55, e.g., the flow-path (in either direction) indicated by arrows 201, 203, 205 within a broad range of pressures relative to pressure-related therapies. An adequate gas-flow pathway is one that is adequate for a flow of gas that is required by the pressure-related therapies. In examples, a pressure-regulating mode of the apparatus 100 can include reaching and/or maintaining a pressure inside the bag 10 within a range of 460 mm Hg to 1060 mm Hg, or within a range of 460 mm Hg (i.e., 300 mm Hg of ‘negative pressure) to 760 mm Hg, or within a range of 560 mm Hg to 760 hg, or within a range of 760 mm Hg to 1060 mm Hg (i.e., 300 mm Hg of positive pressure), or within a range of 760 mm Hg to 960 mm Hg. In embodiments, it can be desirable that the material(s) of the gas-permeable layer 55 be selected so that the layer 55 (and the strip 50 as a whole) is at most partly compressible, i.e., not completely compressible, since being completely compressible could allow the gas-flow pathway to be closed off at one or more points, or even completely, with application of a ‘negative’ pressure, i.e., evacuation of the bag 10.

FIG. 17 illustrates deployment of a vessel 100 on the limb of a human subject 90 according to embodiments. A limb-sealing element 30, e.g., an adhesive tape, is provided for sealing between the limb and the periphery of the open proximal end of the bag 10. A gas-flow-pathway ribbon 32, e.g., an at-least partly elastic ribbon of a gas-pathway material is provided for disposition as a transverse extension of the gas-flow pathway (i.e., extending transversely from the strip, to go around the limb). A sponge 31 or similarly soft element interposed between a wound and the elastic ribbon 32, or, alternatively, between the wound and the strip 50.

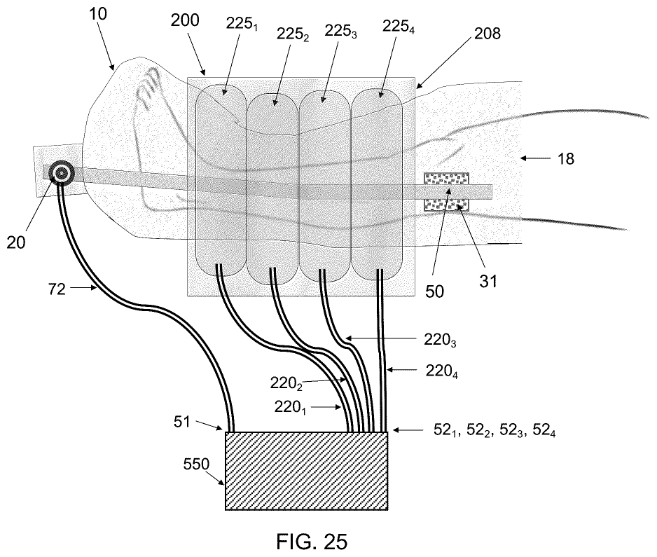

We now refer to FIGS. 23 and 24. FIG. 23 shows a non-limiting example of a system for administering a multibaric treatment protocol to a human subject, according to some embodiments. The system comprises a gas-transfer apparatus 550 comprising first and second openings 51, 52 for gas transfer therethrough. FIG. 24 illustrates the arrangement of first and second vessels 100, 200 on the limb of the subject 90. The arrangement of hoses and tubes, and their respective connecting arrangements and locations on the gas-transfer apparatus 550 and on the first vessel 100 are shown in FIG. 23 for purposes of illustration, and in other examples the respective and arrangements and locations can be different. In other illustrative examples (not shown), connections 20 between the first vessel 100 and the gas-transfer apparatus 550 are made solely in a distal portion of the vessel 100, either at the distal end of the bag 10 or in a distal extension 15.

A first gas-transfer section 501 comprises a first opening 51 for gas transfer therethrough, and is configured to (i) regulate a pressure in a first vessel 100 placed in fluid communication therewith throughout a range from 200 mm Hg below an ambient pressure to 160 mm Hg above the ambient pressure, and (ii) cause a flow through the first opening 51 of a gas such as therapeutic gas 140. The first vessel, in embodiments, comprises a closed-ended bag 10, e.g., one of the bags 10 of FIG. 1 or 2.

A second gas-transfer section 502 comprises second openings 52 for gas transfer therethrough, and is configured to regulate a pressure in a second vessel 200 placed in fluid communication therewith throughout an above-ambient range up to 100 mm Hg above the ambient pressure. A suitable second vessel 200 is a compression sleeve having multiple gas pockets or compartments.

The system further comprises electronic circuitry 65 programmed to operate in each one of the following modes, in sequence or in parallel. For the present disclosure, the term ‘electronic circuitry’ is used broadly to describe any combination of hardware, software and/or firmware. Electronic circuitry may include any executable code module (i.e., stored on a computer-readable medium) and/or firmware and/or hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used including but not limited to reduced instruction set computer (RISC) architecture and/or complex instruction set computer (CISC) architecture. Electronic circuitry may be located in a single location or distributed among a plurality of locations where various circuitry elements may be in wired or wireless electronic communication with each other.

In embodiments, the pressure-regulating device 550 can be equipped with any or all of the following components, and not exhaustively: a power inlet with switch fuses and EMI filter, an ozone generator using high voltage corona discharge, a solid-state relay for operating the ozone generator, a DC power supply, solenoid valves, a pressure pump, a vacuum pump, DC actuators for operating pumps and valves, controller modules, a chemical ozone destructor, and internal silicone-based gas hoses.

In a first mode of the system, the first gas-transfer section 501 causes a gas such as therapeutic gas 140 to flow through the first opening 51 and into the first vessel 100, responsively to an input affirming that the first vessel 100 is in fluid communication with the first gas-transfer section 501 and is disposed to envelop at least a lengthwise part 95 of a limb of the subject 90. In an example, the input is a user input received by the gas-transfer apparatus 550 from a user, i.e., a human user. In another example, the input is received by the gas-transfer apparatus 550 from a sensor (not shown), such as an imaging sensor or an electromechanical sensor, e.g., a pressure switch. In yet another example, the input is received by a human user from a visual check of the connection between the first vessel 100 and the first gas-transfer section 501.

In a second mode of the system, the second gas-transfer section 502 regulates respective above-ambient gas pressures in fluid-holding compartments 225 of the second vessel 200 so as to cause the fluid-holding compartments 225 to apply respective compressive pressures through a wall 11 of the first vessel 100, to corresponding portions 98 of the limb 90. The regulating is carried out through the second openings 52 and while at least a portion of the gas 140 resides within the first vessel 100. The regulating causes a circulation (“induced circulation”, “indirect circulation”) of the gas 140 throughout the part 115 of the first vessel 100 that is surrounded by the second vessel 200, to the extent that the part 115 is surrounded by the fluid-holding compartments 225. The regulating is responsive to an input affirming that the second vessel 200 is in fluid communication with the second gas-transfer section 502 and is disposed to surround at least a lengthwise part 105 of the first vessel 100. In an example, the input is a user input received by the gas-transfer apparatus 550 from a user, i.e., a human user. In another example, the input is received by the gas-transfer apparatus 550 from a sensor (not shown), such as an imaging sensor or an electromechanical sensor, e.g., a pressure switch. In yet another example, the input is received by a human user from a visual check of the connection between the second vessel 200 and the second gas-transfer section 502.

In a second non-limiting example of a treatment protocol, a system comprising electronic circuitry 65 and a pressure-regulating device 550 has two main modes of operation which run consecutively and/or in parallel: (1) lymphatic massage and ozone disinfection, and (2) pulsing vacuum plus ozone. To be clear: ‘ozone,’ or more properly an ozone-containing gas, is a non-limiting example of a therapeutic gas which can be applied according to the instant example.

According to the example, the operation sequence includes the following six procedures:
a. Carrying out a live test of the apparatus 100 comprising the first vessel 10. The device 550 operates a vacuum pump until reaching a negative pressure of about 100 mm Hg gauge below ambient in the first vessel 10. Pressure is checked after a 10-second wait. The device 550 allows a pressure bleed of 15 mm Hg negative pressure; above this value, the test fails.
b. Ozone fill: The first vessel is partly filled with a predetermined amount of ozone.
c. Lymphatic massage: The pressure pump and valves are activated to create a peristaltic massage of the leg for a preset amount of time with the second vessel 200 surrounding the first vessel 100 on the limb 90.
d. Ozone extraction: The vacuum pump is activated to empty the first vessel 100 of ozone, reaching a negative pressure of about 100 mm Hg gauge below ambient. The extracted ozone is destroyed, i.e., returned to oxygen, by an ozone destructor unit.
e. Vacuum treatment: The vacuum pump is again activated to reach a negative pressure of about 100 mm Hg below ambient in the first vessel 100, and holds this negative pressure for a predetermined time. If the negative pressure bleeds out, the vacuum pump is reactivated to achieve the desired negative pressure. Ozone is again introduced to the first vessel 100 to a negative pressure of about 20 mm Hg below ambient, and holds for a predetermined time. The cycle of evacuating and re-introducing ozone is repeated until reaching a predetermined treatment time.
f. Ozone extraction: The vacuum pump is activated to empty the first vessel 100 of ozone to reach a negative pressure of about 100 mm Hg below ambient. Again, the extracted ozone is destroyed, i.e., returned to oxygen, by an ozone destructor unit.

FIG. 25 shows another non-limiting example of a system for administering a multibaric treatment protocol to a human subject, according to some embodiments. An apparatus 100 is illustrated ‘in situ’ with a first vessel (bag) 10 component surrounding a limb 90 of a human subject. The apparatus 100 includes a connection arrangement 20 for connecting to a first opening 51 of a pressure-regulating device 550 via gas hose 72. A gas-flow pathway comprises a first portion that includes a gas-flow pathway strip 50 and a second portion comprising an elastically compressible element 31 in communication with a target area 95 (not shown) of the limb 90. A second vessel 200 comprises four fluid compartments 225₁, 225₂, 225₃ and 225₄ connected to second openings 52 of the pressure-regulating device 550 via respective gas hoses 220₁, 220₂, 220₃ and 220₄.

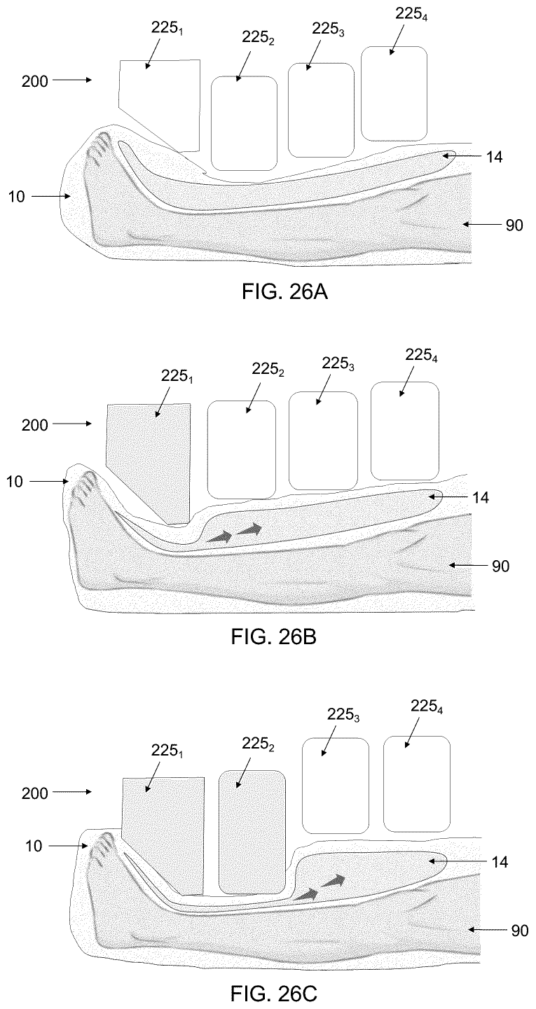

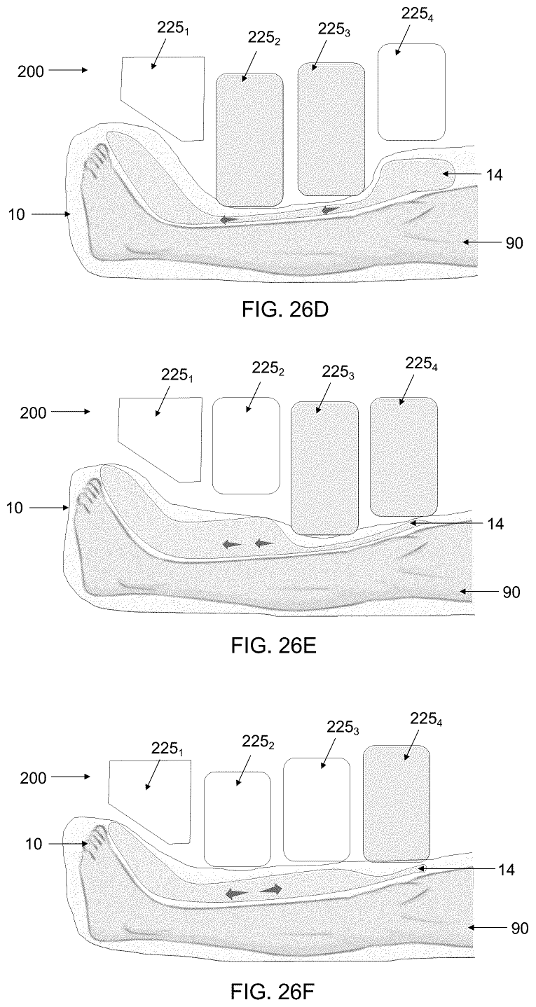

FIGS. 26A, 26B, 26C, 26D, 26E and 26F illustrate a sequence illustrating an exemplary operating mode of a system such as the system illustrated in FIG. 25. The exemplary operating mode include a ‘peristaltic’ massage’ of the limb, i.e., a sequential compression protocol that uses inflation and deflation of the four fluid compartments 225₁, 225₂, 225₃ and 225₄ to peristaltically circulate gas contained in the first vessel 10 and in fluid communication with the limb 90 of a subject (and optionally with a target area 95 of the limb).

A limb 90 is at least partly inserted in a first vessel 10 which has disposed therewithin a quantity of a gas 14. In some embodiments, the first vessel 10 is equipped with a gas-flow pathway (e.g., including a gas-flow pathway strip 50 and an elastically compressible element 31). In such embodiments, some, most or substantially all of the gas 14 can be contained within the volume of the gas-flow pathway, at least when the first vessel 10 is partly evacuated, as may be is the case in the example of FIGS. 26A-F. A second vessel 200 comprising four fluid compartments 225₁, 225₂, 225₃ and 225₄ surrounds the first vessel 10 such that inflation of any one or more of the fluid compartments 225₁, 225₂, 225₃ and 225₄ applies a force to first vessel, the force being passed through by the wall of the first vessel 10 to the limb and/or to the components (e.g., portions 50, 31 of the gas-flow pathway) that are provided with the first vessel 10.

In FIG. 26A, none of the fluid compartments 225₁, 225₂, 225₃ and 225₄ is inflated, and the available gas 14 is distributed in the first vessel 10, e.g., in the gas-flow pathway (not shown) without any influence of the second vessel 200. In FIG. 26B, a first fluid compartment 225₁ is inflated, causing some of the gas 14 to circulate proximally, indicated by the small arrows. In FIG. 26C, the first compartment 225₁ remains inflated, and the second compartment 225₂ is inflated, causing more of the gas 14 to circulate proximally. In FIG. 26D, the first compartment 225₁ is deflated, while the second compartment 225₂ remains inflated, and the third compartment 225₃ is inflated, causing some of the gas 14 to circulate distally. In FIG. 26E, the second compartment 225₂ is also deflated, while the third compartment 225₃ remains inflated, and the fourth compartment 225₄ is inflated, causing more of the gas 14 to circulate distally. In FIG. 26F, the third compartment 225₃ is also deflated, while the fourth compartment 225₄ remains inflated, causing the gas 14 to flow toward the initial condition of FIG. 26A. The skilled artisan will understand that the next step in the sequence is to deflate the fourth compartment 225₄ and return to the condition of FIG. 26A, and repeat the cycle as programmed. In some embodiments, the pressure due to the inflation can vary from compartment to compartment and from cycle to cycle.

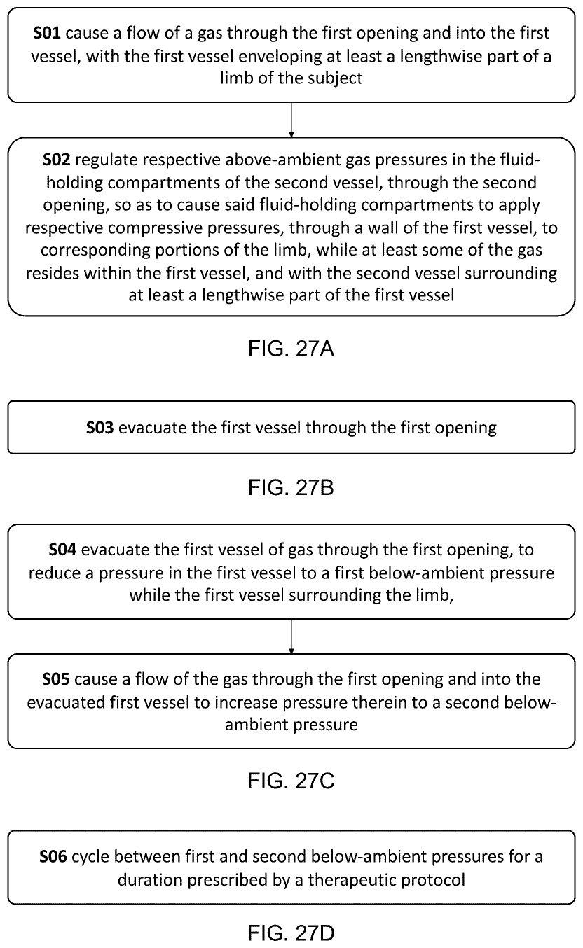

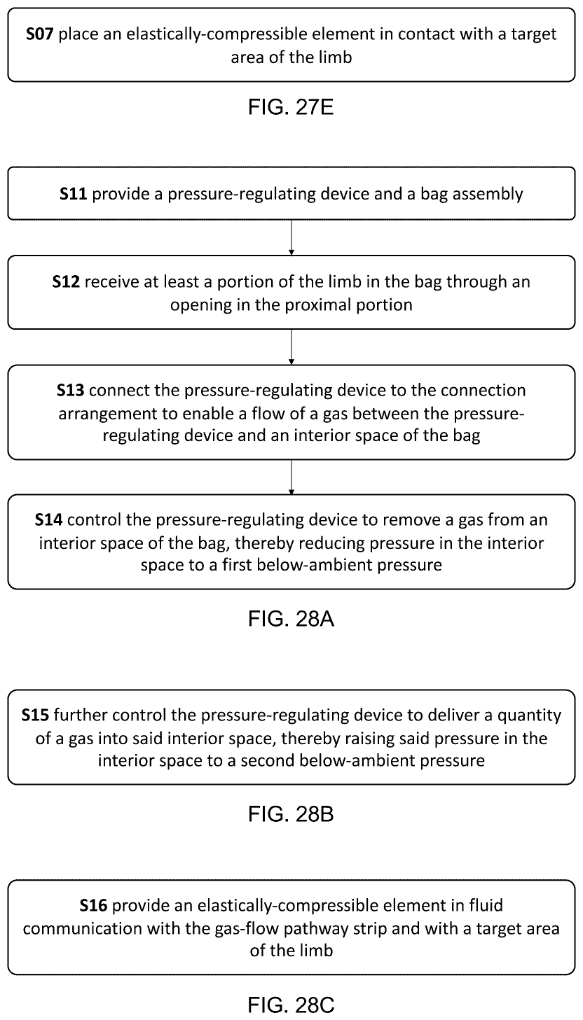

We now refer to FIGS. 27A, 27B, 27C, 27D and 27E.

A method is disclosed, according to embodiments, for administering a multibaric treatment protocol to a limb of a human subject 90 using a gas-transfer system 550 according to any of the embodiments disclosed herein. An exemplary gas-transfer system 550 comprises first and second openings 51, 52 for gas transfer therethrough, the first opening 51 being in fluid communication with a first vessel 10 and the second openings 52 being in fluid communication with a second vessel 200. The second vessel 200 comprises multiple fluid-holding compartments 225 openable to the gas-transfer system 550. In some embodiments, either or both of the first and second vessels 10, 200 is/are flexible. As shown in the flowchart of FIG. 27A, the method comprises at least Steps S01 and S02:

Step S01: with the first vessel 10 enveloping at least a lengthwise part 95 of a limb 90 of the subject, causing a flow of a gas 140 through the first opening and into the first vessel. In some embodiments, the gas includes a therapeutic gas, and in some such embodiments, the therapeutic gas comprises at least one of ozone, oxygen, and an essential oil.

Step S02: while at least a portion of the therapeutic gas 140 resides within the first vessel 10, and with the second vessel 200 surrounding at least a lengthwise part 105 of the first vessel 10, regulating, through the second opening 52, respective above-ambient gas pressures in the fluid-holding compartments 225 of the second vessel 200 so as to cause the fluid-holding compartments 225 to apply respective compressive pressures, through a wall 11 of the first vessel 10, to corresponding portions 98 of the limb 90. In some embodiments, the regulating of the respective above-ambient gas pressures in the fluid-holding compartments 225 includes repeating a sequence of differential pressure regulation for a duration prescribed by a therapeutic protocol. In some embodiments, the regulating of respective above-ambient gas pressures in the fluid-holding compartments 225 includes regulating respective pressures of between 20 and 100 mm Hg above ambient; in other words, the pressure in an inflated fluid-holding compartment 225 can be anywhere in the range 20 to 100 mm Hg gauge above ambient in accordance with a user or clinical selection of a desired pressure.

According to the method, the regulating of the respective above-ambient gas pressures causes a circulation of the gas such as therapeutic gas 140 throughout the at least a part 115 of the first vessel 10 that is surrounded by the second vessel 200 to the extent that the ‘at least a part 115’ is surrounded by the fluid-holding compartments 225. In some embodiments, the regulating of the respective above-ambient gas pressures in the fluid-holding compartments 225 includes repeating a sequence of differential pressure regulation.

Without wishing to be bound by theory, the inventor believes that such circulation results in a higher effective concentration of the therapeutic agent in the therapeutic gas in the vicinity of the wound. In addition, the inventor believes that such circulation improves the mass transfer rate by increasing the driving force concentration difference [mol/m³] in the vicinity of the wound, and by increasing the mass transfer coefficient.

In some embodiments, the circulation of the therapeutic gas 140 is at least partly through a flow pathway 55 in the first vessel 10, e.g., through a gas-flow pathway of a gas-flow-pathway strip 50 or through a tubing arrangement (not shown). In some embodiments, the gas-flow pathway strip is laterally open along its length to an interior space of the first vessel, such that a fluid disposed within the first vessel can flow freely into and out of the gas-flow pathway strip.

In some embodiments, as shown in the flowchart of FIG. 27B, the method additionally comprises, before Step S01:

Step S03: evacuating the first vessel 10, e.g., through the first opening 51.

In some embodiments, as illustrated in the flowchart of FIG. 27C, the method further comprises, after Step S02:

Step S04: with the first vessel 10 surrounding at least part 95 of the limb 90, evacuating the first vessel 10 of gas such as therapeutic gas 140 through the first opening 51, to reduce a pressure in the first vessel 10 to a first below-ambient pressure. In some embodiments, the first below-ambient pressure is between 10 and 50 mm Hg below ambient. In some embodiments, the pressure is maintained at the first below-ambient pressure for at least 3 minutes, at least 5 minutes, at least 10 minutes, or within a range of 3 to 90 minutes, 5 to 75 minutes, 10 to 60 minutes, or 15 to 60 minutes.

Step S05: causing a flow of a therapeutic gas 140 (the same gas as in Step S01, or different therefrom) through the first opening 51 and into the evacuated first vessel 10 to increase the pressure in the first vessel 10 to a second below-ambient pressure. In some embodiments, the second below-ambient pressure is between 60 and 100 mm Hg below ambient.

In some embodiments, a difference between the first below-ambient pressure and the second below-ambient pressure is between 40 and 88 mm Hg gauge.

In some embodiments, as illustrated in the flowchart of FIG. 27D, the method further comprises, after Step S05:

Step S06: cycling between the first and second below-ambient pressures for a duration prescribed by a therapeutic protocol. In some embodiments, the first and second below-ambient pressures can be different from cycle to cycle. In some embodiments, the first and second below-ambient pressures are substantially the same from cycle to cycle.

In some embodiments, as illustrated in the flowchart of FIG. 27E, the method further comprises, before Step S01:

Step S07: placing an elastically-compressible element in contact with a target area of the limb. The elastically-compressible element 31 can comprise a ‘wound sponge’ or any open-celled foam. In some embodiments, evacuating the first vessel of gas (e.g., in Step S03 or S04) is effective to at least partially compress the elastically-compressible element 31. In some embodiments, causing the flow of the gas through the first opening (e.g., in Step S01 or Step S05) is effective to expand the at least partially compressed elastically-compressible element. If Step S07 is carried, out then the introduction of the therapeutic gas 140 in Step S05 causes the therapeutic gas to be delivered to the area near the wound, as the foam acts like a spring that is partially released from a compressed state

A method is disclosed, according to embodiments, for applying a hypobaric therapy to a human limb 90. As shown in the flowchart of FIG. 27A, the method comprises at least Steps S11, S12, S13 and S14:

Step S11: providing a pressure-regulating device 550 and a bag assembly, the bag assembly comprising a bag 10 comprising a connection arrangement 20 mounted to a wall 11 of the bag 10 in a distal portion thereof, and a gas-flow pathway strip 50 disposed lengthwise within the bag 50 between the connection arrangement 20 and a proximal portion of the bag. According to the method, the strip is 50 laterally open along its length to an interior 12 space of the bag 10, such that when the bag 10 is provided in a non-evacuated state, a fluid 14 disposed within the bag 10 can flow freely into and out of the gas-flow pathway strip. In embodiments, the strip 50 is sufficiently uncompressible to maintain a gas-flow pathway therethrough when walls 11 of the bag 10 collapse under partial evacuation of the bag 10. This gas-flow pathway, which includes the strip 50 and, optionally, an elastically-compressible element 31 in fluid communication with both the strip 50 and a target area 95 of the limb 90, e.g., a wound, is thus maintained from the connection arrangement 20 of the bag to the area of the interest (e.g., the target area 95). The strip can be formed according to any of the embodiments and examples disclosed herein.

Step S12: receiving at least a portion of the limb 90 in the bag 10 through an opening in the proximal portion.

Step S13 connecting the pressure-regulating device 550 to the connection arrangement 20 to enable a flow of a gas 140 between the pressure-regulating device 550 and an interior space 12 of the bag 10. In some embodiments, delivery of the gas 14 (e.g., a therapeutic gas) into the interior space 12 is at least partly through the gas-flow pathway strip 50. In some embodiments, delivery of the gas 14 (e.g., the therapeutic gas) into the interior space 12 is substantially all through the gas-flow pathway strip 50. In embodiments, the strip 50 is formed integrally with the bag 10 and in other embodiments, which are interchangeable with the integrally-formed strip 505 and operable with all apparatuses, systems and method disclosed herein, the strip 50 is formed separately and then affixed to a wall 11 of the bag 10.

Step S14: controlling the pressure-regulating device 550 to remove a gas 14 from an interior space 12 of the bag 10, thereby to reducing pressure in the interior space 12 to a first below-ambient pressure.

In some embodiments, as illustrated in the flowchart of FIG. 28B, the method additionally comprises:

Step S15: further controlling the pressure-regulating device 550 to deliver a quantity of a gas 140 into the interior space 12, thereby raising the pressure in the interior space 12 to a second below-ambient pressure. In some embodiments, a gas-flow pathway is maintained in the gas-flow pathway strip 50 at both the first and second below-ambient pressures.

In some embodiments, the first below-ambient pressure is between 10 and 50 mm Hg below ambient. In some embodiments, second below-ambient pressure is between 60 and 100 mm Hg below ambient.

In some embodiments, as illustrated in the flowchart of FIG. 28C, the method additionally comprises, before Step S11:

Step S16: providing an elastically-compressible element 31 in fluid communication with the gas-flow pathway strip 50 and with a target area 95 of the limb 90. In some embodiments, the elastically-compressible element 31 is at least partly compressed at the first below-ambient pressure and biased to expand when the pressure is raised to the second below-ambient pressure. In some embodiments, the elastically-compressible element 31 comprises an open-celled foam.

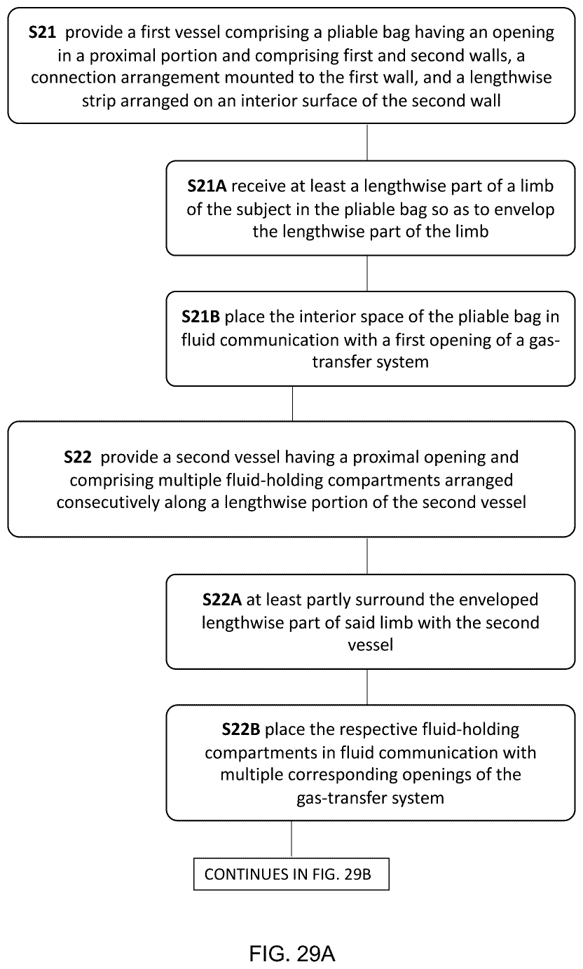

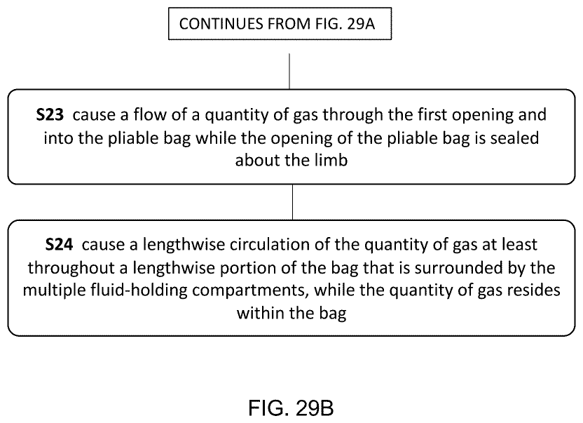

We now refer to FIGS. 29A and 29B. A method is disclosed, according to embodiments, for administering a multibaric treatment protocol to a human subject 90 using a gas-transfer system. An exemplary gas-transfer system is gas-transfer system 550 of FIG. 25, which comprises first opening 51 and multiple openings 52 for gas transfer therethrough, the first opening 51 being in fluid communication with a first vessel 10 and the second openings 52 being in fluid communication with fluid-holding compartment 225 of a second vessel 200. In some embodiments, either or both of the first and second vessels 10, 200 is/are flexible. In some embodiments, first vessel 10 is pliable but not expandable by above-ambient pressures encountered in the therapies disclosed herein. As shown in the flowchart of FIGS. 29A and 29B, the method comprises at least Steps S21, S22, S23 and S24. Step S21 includes sub-steps S21A and 21B. Step S22 includes sub-steps S22A and S22B. The method comprises:

Step S21 includes providing a first vessel 100 comprising a pliable bag 10 having an opening 18 (shown in FIG. 25) in a proximal portion thereof and comprising first and second opposing bag sections 11_{A}, 11_{B}, (ii) a connection arrangement 20 mounted to the first bag section 11_{B}, and a (iii) lengthwise strip 50 arranged on an interior surface of the second bag section 11_{A} such that (A) a distal portion of said lengthwise strip 50 is disposed in a distal portion of said pliable bag 10 and in fluid communication with said connection arrangement 20 and (B) a proximal end of the lengthwise strip is disposed in a proximal portion of said pliable bag 10, said lengthwise strip 50 comprising an at-most-partially compressible layer 55 open to an interior space 12 of said pliable bag 10 along the length of said lengthwise strip 50. A suitable first vessel 100 is a first vessel 100 shown in any one of FIGS. 1-3, 12A, 13-17, or 22A-C. The lengthwise strip 50 can be formed integrally with said pliable bag 10 e.g., as shown in FIGS. 12B-C, or can be affixed to said second bag section 11_{A} as shown in FIG. 5A. In embodiments, the footprint of said lengthwise strip 50 has an area less than 10 percent of an area of said pliable bag 10 when lain flat without wrinkles or folds.

Step S21 includes two sub-steps S21A and S21B:
Step S21A includes receiving, through said opening 18, at least a lengthwise part of a limb of the subject 90 in said pliable bag 10 so as to envelop said lengthwise part of said limb, the receiving being such that said distal portion of said lengthwise strip 50 remains in fluid communication with said connection arrangement 20.
Step S21B includes placing said interior space 12 of said pliable bag 10 in fluid communication with a first opening 51 of the gas-transfer system 550 through said connection arrangement 20 as shown, for example in FIG. 25.

Step S22 includes providing a second vessel 200 having a proximal opening 208 (shown in FIG. 25) and comprising multiple fluid-holding compartments 225, e.g., at least 3, or at least 4, arranged consecutively along a lengthwise portion of said second vessel 200. In embodiments, the lengthwise strip 50 is aligned longitudinally with said multiple fluid-holding compartments 225.

Step S22 includes two sub-steps S22A and S22B:
Step S22A includes at least partly surrounding, by said second vessel 200, said enveloped (by first vessel 100) lengthwise part of said limb.
Step S22B includes placing the respective fluid-holding compartments 225 in fluid communication with multiple corresponding openings 52 of the gas-transfer system 550, as illustrated, for example, in FIG. 25.

Step S23 includes causing a flow of a quantity of gas 14 (shown e.g., in FIG. 26A) through the first opening 51 and into the bag 10 subsequent to said providing of said first vessel 100 in Step S21 and while said opening 18 of said pliable bag 10 is sealed about said limb, e.g., as shown in FIG. 17. In some embodiments, said quantity of gas 14 has an ambient-pressure volume of at least 100 cc or at least 200 cc. The bag itself can have a total volume of volume within a range of 0.3 to 10 liters. In some embodiments, said quantity of gas 14 includes at least one of ozone, oxygen, and an essential oils e.g., to act as a therapeutic gas for treating a wound or other target area of the limb. In some embodiments, Step S23 is preceded by evacuating the bag 10. Pre-evacuating the bag 10 can be desirable if the quantity of gas 14 caused to flow in Step S23 is different than the gas already in the bag 10 before undertaking Step S23.

Step S24 is carried out subsequent to providing of the second vessel 200 in Step S22, while said quantity of gas 14 resides within the bag, and includes causing a lengthwise circulation of said quantity of gas 14 at least throughout a lengthwise portion of the bag 10 that is surrounded by said multiple fluid-holding compartments 225. Causing the circulation includes regulating, through said multiple corresponding openings 52, respective gas pressures in the fluid-holding compartments 225 to alternately inflate and deflate said compartments 225 as shown in FIGS. 26A-F, each inflating being effective to apply a compressive pressure through a wall 11 of the bag 10 to a corresponding portion of said limb. In some embodiments, the alternately inflating and deflating includes repeating a sequence of differential pressure regulation. The alternately inflating and deflating includes alternately inflating and deflating consecutive fluid-holding compartments 225, as shown in FIGS. 26A-F. The lengthwise strip 50 (not shown in FIGS. 26A-F) defines a lengthwise, at-most-partly compressible fluid pathway for gas flow between first and second non-contiguous lengthwise portions of the bag that are respectively distal and proximal to a lengthwise portion of the bag 10 that is under compressive pressure applied by one or more corresponding fluid-holding compartments 225, e.g., as illustrated in FIG. 26D. When one or more bag-sections 11 of the bag 10 are collapsed by inflation of one or more of the multiple fluid-holding compartments 225, the lengthwise strip 50 maintains a viable conduit for conveyance of a gas at least for the extent of the bag 10 that is surrounded by the fluid-holding compartments 225 of the second vessel 200.

As shown, e.g., in FIGS. 26B-F, applying of compressive pressure through a wall 11 of the bag 10 to a corresponding portion of the limb by inflating one or more of said fluid-holding compartments 225 is effective to displace a portion of said quantity of gas 14 within the bag 10, and in embodiments, the said ambient-pressure volume of said quantity of gas 14 is selected so that the displacing effect does not create an above-ambient pressure within the bag 10.

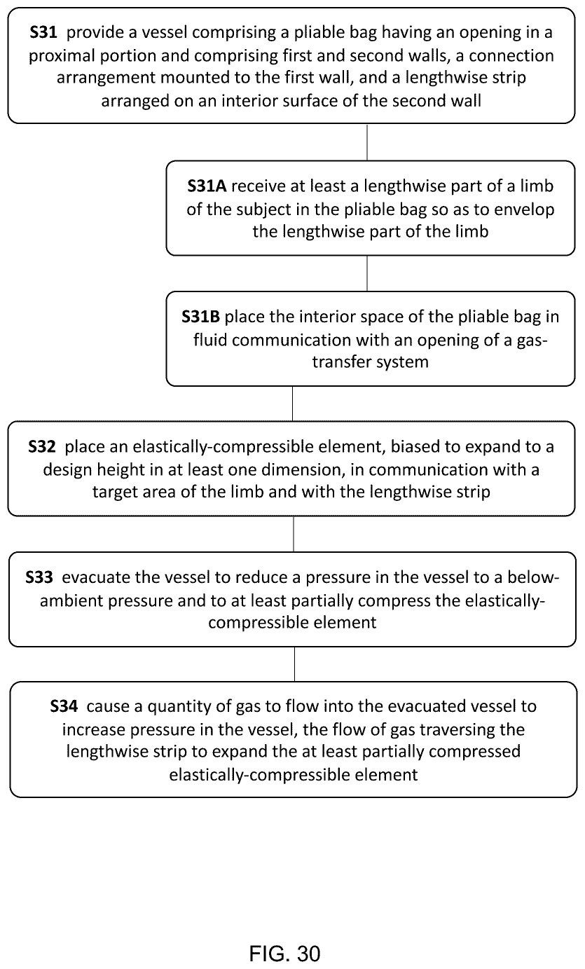

We now refer to FIG. 30. A method is disclosed, according to embodiments, for administering a multibaric treatment protocol to a human subject 90 using a gas-transfer system. As shown in the flowchart of FIG. 30, the method comprises at least Steps S31, S32, S33 and S34. Step S31 includes sub-steps S31A and S31B. The method comprises:

Step S31 includes providing a vessel 100 comprising a pliable bag 10 having an opening 18 (e.g., as shown in FIG. 25) in a proximal portion thereof and comprising first and second opposing bag sections 11_{A}, 11_{B}, (ii) a connection arrangement 20 mounted to the first bag section 11_{B}, and a (iii) lengthwise strip 50 arranged on an interior surface of the second bag section 11_{A} such that (A) a distal portion of said lengthwise strip 50 is disposed in a distal portion of said pliable bag 10 and in fluid communication with said connection arrangement 20 and (B) a proximal end of the lengthwise strip is disposed in a proximal portion of said pliable bag 10, said lengthwise strip 50 comprising an at-most-partially compressible layer 55 open to an interior space 12 of said pliable bag 10 along the length of said lengthwise strip 50. A suitable vessel 100 is a vessel 100 shown in any one of FIGS. 1-3, 12A, 13-17, or 22A-C. The lengthwise strip 50 can be formed integrally with said pliable bag 10 e.g., as shown in FIGS. 12B-C, or can be affixed to said second bag section 11_{A} as shown in FIG. 5A. In embodiments, the footprint of said lengthwise strip 50 has an area less than 10 percent of an area of said pliable bag 10 when lain flat without wrinkles or folds. In embodiments, the lengthwise strip 50 has a length equal to at least 70% of a length (from distal to proximal ends) of said pliable bag 10.

Step S31 includes two sub-steps S31A and S31B:
Step S31A includes receiving, through said opening 18, at least a lengthwise part of a limb of the subject 90 in said pliable bag 10 so as to envelop said lengthwise part of said limb, the receiving being such that said distal portion of said lengthwise strip 50 remains in fluid communication with said connection arrangement 20.
Step S31B includes placing said interior space 12 of said pliable bag 10 in fluid communication with an opening 51 of the gas-transfer system 550 through said connection arrangement 20 as shown, for example in FIG. 25.

Step S32 includes placing an elastically-compressible element 30, biased to expand to a design height in at least one dimension, (i) in contact and/or in fluid communication with a target area of the limb and (ii) in contact and/or in fluid communication with said lengthwise strip 50, so as to form an at-most-partly compressible fluid pathway in communication with both the elastically-compressible element 30 and the connection arrangement 20.

Step S33 is carried out subsequent to providing the vessel 100 in Step S31, and includes evacuating the bag 10, through said first opening 51 of said gas-transfer system 550, to reduce a pressure in the bag 10 to a below-ambient (e.g., below-atmospheric) pressure and to at least partially compress said elastically-compressible element 30. In some embodiments, below-ambient/below-atmospheric pressure is between 10 and 100 mm Hg below ambient or atmospheric pressure. In some embodiments, the elastically-compressible element 30 comprises an open-celled foam. In some embodiments, when the bag is evacuated, the lengthwise strip 50 retains at least 90% of its uncompressed thickness. In some embodiments, when the bag 10 is evacuated, the elastically-compressible element 30 retains less than 80% of its uncompressed thickness.

Step S34 is carried out after Step S33 and includes causing a quantity of gas to flow through said first opening 51 of said gas-transfer system 550 and into the evacuated bag 10 to increase said pressure in the bag 10, the flow of gas traversing said lengthwise strip 50 to expand the at least partially compressed elastically-compressible element 30. In embodiments, the flow of said quantity of therapeutic gas to the elastically-compressible element 30 is at least partly through the lengthwise strip 50, and in some embodiments is substantially all through the lengthwise strip 50.

In some embodiments, Steps S33 and S34 are carried out repeatedly (i.e., Step S33, then Step S34, then repeat) for the length of a therapeutic treatment session so as to cycle pressure and/or gas.

### Additional Discussion of the Embodiments

Embodiments of the present invention relate to apparatuses for use with a pressure-regulating device, in applying a therapy to a human limb. According to embodiments, an apparatus for use, with a pressure-regulating device, in applying a therapy to a human limb, comprises: (a) a pliable bag formed to receive, in a donned mode, at least a portion of the limb, through an opening in a proximal portion of the bag; (b) a multilayer strip comprising a bottommost layer affixed to an interior surface of the bag, wherein a distal end of the multilayer strip is disposed in a distal portion of the bag, and wherein a proximal end of the multilayer strip is disposed in the proximal portion of the bag; and (c) a connection arrangement mounted to a wall of the bag in the distal portion thereof, the connection arrangement being effective, in a pressure-regulating mode, to enable therethrough a flow of a gas between the pressure-regulating device and an interior space of the bag, the multilayer strip further comprising an upper layer comprising a partially compressible material defining a gas-flow pathway disposed lengthwise within the bag, between the connection arrangement and the proximal portion of the bag. In some embodiments, the lengthwise gas-flow pathway can be maintained when a gas pressure in the bag is at most 660 mm Hg. In some embodiments, the lengthwise gas-flow pathway can be maintained when a gas pressure inside the bag is 560 mm Hg.

In some embodiments, the lengthwise gas-flow pathway can be maintained when a mechanical pressure of 20 mm Hg gauge is applied externally to the bag and transmitted through a wall of the bag to an uppermost layer of the multilayer strip. In some embodiments, the lengthwise gas-flow pathway can be maintained when a mechanical pressure of 60 mm Hg gauge is applied externally to the bag and transmitted through a wall of the bag to an uppermost layer of the multilayer strip.

In some embodiments, the multilayer strip can have a Shore A hardness of at most 70, or at most 60, or at most 50, or at most 40. In some embodiments, the upper layer of the strip can have a Shore A hardness of at most 70, or at most 60, or at most 50, or at most 40. In some embodiments, it can be that the distal end of the multilayer strip is in fluid communication with the connection arrangement such that the partially compressible material forms a gas-flow pathway from the connection arrangement to the proximal end of the multilayer strip. In some embodiments, the multilayer strip can have a length-to-width ratio of at least 3:1, or of at least 5:1, or at least 10:1. In some embodiments, the multilayer strip can have a length of at least 10 cm, or at least 15 cm, or at least 20 cm, or at least 25 cm, or at least 30 cm. In some embodiments, the multilayer strip can have a thickness of no more than 3.5 mm, or no more than 5 mm, or no more than 7.5 mm, or no more than 10 mm. In some embodiments, the upper layer can have a thickness of no more than 3.5 mm, or no more than 5 mm, or no more than 7.5 mm, or no more than 10 mm.

In some embodiments, the bag can be sized to receive a hand or a foot. In some embodiments, the bag can be sized to receive, lengthwise, at least a majority of an adult human arm. In some embodiments, the bag can be sized to receive, lengthwise, at least a majority of an adult human leg. In some embodiments, the multilayer strip can have a length equal to at least 70% of a length of the bag. In some embodiments, it can be that (i) the distal portion of the bag includes a distally-disposed tab section open to the interior space of the bag, the distal tab section having a width less than 25% of a maximum width of the distal portion of the bag, and/or (ii) the connection arrangement is mounted at least partly within the distally-disposed tab section.

In some embodiments, the therapy can include a negative-pressure wound therapy. In some embodiments, the pressure-regulating mode can include an interior of the bag being under a vacuum. In some embodiments, the pressure-regulating mode can include a pressure inside the bag within a range of 460 mm Hg to 1060 mm Hg, or within a range of 460 mm Hg to 760 mm Hg, or within a range of 560 mm Hg to 760 hg, or within a range of 760 mm Hg to 1060 mm Hg, or within a range of 760 mm Hg to 960 mm Hg. In some embodiments, the multilayer strip can have a thickness:width dimensionless aspect ratio of between 1:1.5 and 1:20, or between 1:5 and 1:15, or between 1:8 and 1:12.

In some embodiments, the bottommost layer can include an adhesive. In some embodiments, the multilayer strip can be attached to a first wall of the bag and the connection arrangement is mounted to a second wall of the bag. In some embodiments, the multilayer strip can be attached to the same wall that the connection arrangement is mounted to, and/or the bottommost layer of the multilayer strip can be in mechanical contact with the connection arrangement, and/or the upper layer can be in fluid communication with the connection arrangement through the bottommost layer. In some embodiments, the bag can be interiorly pre-sterilized. In some embodiments, the bag can comprise an ozone-resistant material. In some embodiments, the multilayer strip can be effective to maintain fluid communication along a lengthwise path when a portion of the path is subjected to an externally-applied positive pressure of 100 mm Hg.

According to embodiments of the invention, a kit can comprise (i) the apparatus according to any of the embodiments disclosed hereinabove, and/or (ii) an elastic ribbon of a gas-pathway material for disposition, in an on-limb configuration, as a transverse extension of the gas-flow pathway around the limb. In some embodiments, the kit can additionally comprise a sponge for mediating between the partially compressible material and a wound. In some embodiments, the kit can additionally (or alternatively) comprise a limb-sealing tape.

According to embodiments of the invention, an apparatus for use, with a pressure-regulating device, in applying a therapy to a human limb comprises: (a) a pliable bag formed to surround, in a donned mode, at least a portion of the limb; (b) a connection arrangement mounted to a wall of the bag in a distal portion of the bag, the connection arrangement being effective to enable therethrough a flow of a gas between the pressure-regulating device and an interior space of the bag in a pressure-regulating mode; and (c) a gas-permeable strip affixed to an interior surface of the bag and having a length equal to at least 70% of a length of the bag, a distal end of the gas-permeable strip being in communication with the connection arrangement in the distal portion of the bag, and a proximal end of the gas-permeable strip being disposed in a proximal portion of the bag, the gas-permeable strip comprising a partially compressible, gas-permeable material forming a lengthwise gas-flow pathway. In some embodiments, the partially compressible, gas-permeable material can form a lengthwise gas-flow pathway when the bag is at least partly evacuated. In some embodiments, the gas-permeable strip can have a Shore A hardness of at most 70, or at most 60, or at most 50, or at most 40.

In some embodiments, the partially compressible, gas-permeable material can form a gas-flow pathway from the connection arrangement to the proximal end of the gas-permeable strip. In some embodiments, the gas-permeable strip can have a length-to-width ratio of at least 3:1, or of at least 5:1, or at least 10:1. In some embodiments, the gas-permeable strip can have a length of at least 10 cm, or at least 15 cm, or at least 20 cm, or at least 25 cm, or at least 30 cm. In some embodiments, the gas-permeable strip has a thickness of no more than 3.5 mm, or no more than 5 mm, or no more than 7.5 mm, or no more than 10 mm. In some embodiments, the bag can be sized to receive a hand or a foot. In some embodiments, the bag can be sized to receive, lengthwise, at least a majority of an adult human arm. In some embodiments, the bag can be sized to receive, lengthwise, at least a majority of an adult human leg.

In some embodiments, it can be that (i) the distal portion of the bag includes a distally-disposed tab section open to the interior space of the bag, the distal tab section having a width less than 25% of a maximum width of the distal portion of the bag, and/or (ii) the connection arrangement is mounted at least partly within the distally-disposed tab section. In some embodiments, the therapy can include a negative-pressure wound therapy. In some embodiments, the pressure-regulating mode can include an interior of the bag being under a vacuum. In some embodiments, the pressure-regulating mode can include a pressure inside the bag within a range of 460 mm Hg to 1060 mm Hg, or within a range of 460 mm Hg to 760 mm Hg, or within a range of 560 mm Hg to 760 hg, or within a range of 760 mm Hg to 1060 mm Hg, or within a range of 760 mm Hg to 960 mm Hg.

In some embodiments, the gas-permeable strip can have a thickness:width dimensionless aspect ratio of between 1:1.5 and 1:20, or between 1:5 and 1:15, or between 1:8 and 1:12. In some embodiments, the gas-permeable strip can be attached to a first wall of the bag and the connection arrangement is mounted to a second wall of the bag. In some embodiments, the gas-permeable strip can be attached to the same wall that the connection arrangement is mounted to. In some embodiments, the bag can be interiorly pre-sterilized. In some embodiments, the bag can comprise an ozone-resistant material. In some embodiments, the gas-permeable strip can be effective to maintain fluid communication along a lengthwise path when a portion of the path is subjected to an externally-applied positive pressure of 100 mm Hg.

According to embodiments of the invention, a kit can comprise (i) the apparatus according to any of the embodiments disclosed hereinabove, and/or (ii) an elastic ribbon of a gas-pathway material for disposition, in an on-limb configuration, as a transverse extension of the gas-flow pathway around the limb. In some embodiments, the kit can additionally comprise a sponge for mediating between the partially compressible material and a wound. In some embodiments, the kit can additionally (or alternatively) comprise a limb-sealing tape.

According to embodiments of the invention, an apparatus for use, with a pressure-regulating device, in applying a therapy to a human limb, comprises: (a) a pliable bag formed to surround, in a donned mode, at least a portion of the limb; (b) a connection arrangement mounted to a wall of the bag in a distal portion of the bag, the connection arrangement being effective to enable therethrough a flow of a gas between the pressure-regulating device and an interior space of the bag in a pressure-regulating mode; and (c) a gas-permeable strip affixed to an interior surface of the bag, a distal end of the gas-permeable strip being in communication with the connection arrangement in the distal portion of the bag, and a proximal end of the gas-permeable strip being disposed in a proximal portion of the bag, the gas-permeable strip comprising a partially compressible, gas-permeable material forming a lengthwise gas-flow pathway, wherein the gas-permeable strip has a thickness:width dimensionless aspect ratio of between 1:5 and 1:15.

In some embodiments, the lengthwise gas-flow pathway can be maintained when a gas pressure in the bag is at most 660 mm Hg. In some embodiments, the lengthwise gas-flow pathway can be maintained when a gas pressure inside the bag is 560 mm Hg.

In some embodiments, the lengthwise gas-flow pathway can be maintained when a mechanical pressure of 20 mm Hg gauge is applied externally to the bag and transmitted through a wall of the bag to an uppermost layer of the multilayer strip. In some embodiments, the lengthwise gas-flow pathway can be maintained when a mechanical pressure of 60 mm Hg gauge is applied externally to the bag and transmitted through a wall of the bag to an uppermost layer of the multilayer strip. In some embodiments, the gas-permeable strip can have a Shore A hardness of at most 70, or at most 60, or at most 50, or at most 40. In some embodiments, the partially compressible, gas-permeable material can form a gas-flow pathway from the connection arrangement to the proximal end of the gas-permeable strip. In some embodiments, the gas-permeable strip can have a length-to-width ratio of at least 3:1, or of at least 5:1, or at least 10:1. In some embodiments, the gas-permeable strip can have a length of at least 10 cm, or at least 15 cm, or at least 20 cm, or at least 25 cm, or at least 30 cm. In some embodiments, the gas-permeable strip can have a thickness of no more than 3.5 mm, or no more than 5 mm, or no more than 7.5 mm, or no more than 10 mm.

In some embodiments, the bag can be sized to receive a hand or a foot. In some embodiments, the bag can be sized to receive, lengthwise, at least a majority of an adult human arm. In some embodiments, the bag can be sized to receive, lengthwise, at least a majority of an adult human leg. In some embodiments, it can be that (i) the distal portion of the bag includes a distally-disposed tab section open to the interior space of the bag, the distal tab section having a width less than 25% of a maximum width of the distal portion of the bag, and/or (ii) the connection arrangement is mounted at least partly within the distally-disposed tab section. In some embodiments, the therapy can include a negative-pressure wound therapy. In some embodiments, the pressure-regulating mode can include an interior of the bag being under a vacuum. In some embodiments, the pressure-regulating mode can include a pressure inside the bag within a range of 460 mm Hg to 1060 mm Hg, or within a range of 460 mm Hg to 760 mm Hg, or within a range of 560 mm Hg to 760 hg, or within a range of 760 mm Hg to 1060 mm Hg, or within a range of 760 mm Hg to 960 mm Hg.

In some embodiments, the gas-permeable strip can have a length equal to at least 70% of a length of the bag. In some embodiments, the gas-permeable strip can be attached to a first wall of the bag and the connection arrangement is mounted to a second wall of the bag. In some embodiments, the gas-permeable strip can be attached to the same wall that the connection arrangement is mounted to. In some embodiments, the bag can be interiorly pre-sterilized. In some embodiments, the bag can comprise an ozone-resistant material. In some embodiments, the gas-permeable strip can be effective to maintain fluid communication along a lengthwise path when a portion of the path is subjected to an externally-applied positive pressure of 100 mm Hg.

According to embodiments of the invention, a kit can comprise (i) the apparatus according to any of the embodiments disclosed hereinabove, and/or (ii) an elastic ribbon of a gas-pathway material for disposition, in an on-limb configuration, as a transverse extension of the gas-flow pathway around the limb. In some embodiments, the kit can additionally comprise a sponge for mediating between the partially compressible material and a wound. In some embodiments, the kit can additionally (or alternatively) comprise a limb-sealing tape.

Embodiments of the present invention relate to apparatuses for use with a pressure-regulating device, in applying a therapy to a human limb. According to embodiments, there is provided an apparatus for use, with a pressure-regulating device, in applying a therapy to a human limb, comprises: (a) a bag formed to receive, in a donned mode, at least a portion of the limb, through an opening in a proximal portion of the bag; (b) a multilayer strip comprising a bottommost layer affixed to an interior surface of the bag, wherein a distal end of the multilayer strip is disposed in a distal portion of the bag, and wherein a proximal end of the multilayer strip is disposed in the proximal portion of the bag; and (c) a connection arrangement mounted to a wall of the bag in the distal portion thereof, the connection arrangement being effective, in a pressure-regulating mode, to enable therethrough a flow of a gas between the pressure-regulating device and an interior space of the bag, the multilayer strip further comprising an upper layer comprising a partially compressible material defining a gas-flow pathway disposed lengthwise within the bag, between the connection arrangement and the proximal portion of the bag.

In some embodiments, the lengthwise gas-flow pathway can be maintained when a gas pressure in the bag is at most 660 mm Hg. In some embodiments, the lengthwise gas-flow pathway can be maintained when a gas pressure inside the bag is 560 mm Hg.

In some embodiments, the multilayer strip can have a thickness:width dimensionless aspect ratio of between 1:2.5 and 1:20.

In some embodiments, the lengthwise gas-flow pathway can be maintained when a mechanical pressure of 20 mm Hg gauge is applied externally to the bag and transmitted through a wall of the bag to an uppermost layer of the multilayer strip. In some embodiments, the lengthwise gas-flow pathway can be maintained when a mechanical pressure of 60 mm Hg gauge is applied externally to the bag and transmitted through a wall of the bag to an uppermost layer of the multilayer strip.

In some embodiments, the multilayer strip can have a Shore A hardness of at most 70, or at most 60, or at most 50, or at most 40.

In some embodiments, it can be that the distal end of the multilayer strip is in fluid communication with the connection arrangement such that the partially compressible material forms a gas-flow pathway from the connection arrangement to the proximal end of the multilayer strip.

In some embodiments, the multilayer strip can have a length-to-width ratio of at least 3:1, or of at least 5:1, or at least 10:1. In some embodiments, the multilayer strip can have a length of at least 10 cm, or at least 15 cm, or at least 20 cm, or at least 25 cm, or at least 30 cm. In some embodiments, the multilayer strip can have a thickness of no more than 3.5 mm, or no more than 5 mm, or no more than 7.5 mm, or no more than 10 mm. In some embodiments, the upper layer can have a thickness of no more than 3.5 mm, or no more than 5 mm, or no more than 7.5 mm, or no more than 10 mm.

In some embodiments, the bag can be sized to receive a hand or a foot. In some embodiments, the bag can be sized to receive, lengthwise, at least a majority of an adult human arm. In some embodiments, the bag can be sized to receive, lengthwise, at least a majority of an adult human leg.

In some embodiments, the multilayer strip can have a length equal to at least 20% of a length of the bag.

In some embodiments, the multilayer strip can have a length equal to at least 30% of a length of the bag.

In some embodiments, the multilayer strip can have a length equal to at least 40% of a length of the bag.

In some embodiments, the multilayer strip can have a length equal to at least 50% of a length of the bag.

In some embodiments, the multilayer strip can have a length equal to at least 60% of a length of the bag.

In some embodiments, the multilayer strip can have a length equal to at least 70% of a length of the bag.

In some embodiments, it can be that (i) the distal portion of the bag includes a distally-disposed tab section open to the interior space of the bag, the distal tab section having a width less than 25% of a maximum width of the distal portion of the bag, and/or (ii) the connection arrangement is mounted at least partly within the distally-disposed tab section.

In some embodiments, the therapy can include a negative-pressure wound therapy. In some embodiments, the pressure-regulating mode can include an interior of the bag being under a vacuum. In some embodiments, the pressure-regulating mode can include an absolute pressure inside the bag within a range of 460 mm Hg to 1060 mm Hg, or within a range of 560 mm Hg to 960 mm Hg, or within a range of 460 mm Hg to 760 mm Hg, or within a range of 560 mm Hg to 760 hg, or within a range of 760 mm Hg to 1060 mm Hg, or within a range of 760 mm Hg to 960 mm Hg, or within a range of 760 mm Hg to 850 mm Hg.

In some embodiments, the pressure-regulating mode can include a pressure applied externally to the bag and transmitted through a wall of the bag to an uppermost layer of the multilayer strip, the externally-applied pressure being over a range of 0 mm Hg to 30 mm Hg. In some embodiments, the pressure-regulating mode can includes a pressure applied externally to the bag and transmitted through a wall of the bag to an uppermost layer of the multilayer strip, the externally-applied pressure being over a range of 0 mm Hg to 80 mm Hg.

In some embodiments, the multilayer strip can have a thickness:width dimensionless aspect ratio of between 1:1.5 and 1:20, or between 1:2.5 and 1:15, or between 1:5 and 1:15, or between 1:8 and 1:12.

In some embodiments, the bottommost layer can include an adhesive. In some embodiments, the multilayer strip can be attached to a first wall of the bag and the connection arrangement is mounted to a second wall of the bag.

In some embodiments, the multilayer strip can be effective to maintain fluid communication along a lengthwise path when a portion of the path is subjected to an externally-applied positive pressure at 100 mm Hg.

According to embodiments, an apparatus for use, with a pressure-regulating device, in applying a therapy to a human limb comprises: (a) a bag formed to surround, in a donned mode, at least a portion of the limb; (b) a connection arrangement mounted to a wall of the bag in a distal portion of the bag, the connection arrangement being effective to enable therethrough a flow of a gas between the pressure-regulating device and an interior space of the bag in a pressure-regulating mode; and (c) a gas-permeable strip affixed to an interior surface of the bag and having a length equal to at least 70% of a length of the bag, a distal end of the gas-permeable strip being in communication with the connection arrangement in the distal portion of the bag, and a proximal end of the gas-permeable strip being disposed in a proximal portion of the bag, the gas-permeable strip comprising a partially compressible, gas-permeable material forming a lengthwise gas-flow pathway.

According to embodiments of the invention, a kit can comprise (i) the apparatus according to any of the embodiments disclosed hereinabove, and/or (ii) an elastic ribbon of a gas-pathway material for disposition, in an on-limb configuration, as a transverse extension of the gas-flow pathway around the limb. In some embodiments, the kit can additionally comprise a sponge for mediating between the partially compressible material and a wound. In some embodiments, the kit can additionally (or alternatively) comprise a limb-sealing tape.

According to embodiments of the invention, an apparatus for use, with a pressure-regulating device, in applying a therapy to a human limb, comprises: (a) a bag formed to surround, in a donned mode, at least a portion of the limb; (b) a connection arrangement mounted to a wall of the bag in a distal portion of the bag, the connection arrangement being effective to enable therethrough a flow of a gas between the pressure-regulating device and an interior space of the bag in a pressure-regulating mode; and (c) a gas-permeable strip affixed to an interior surface of the bag, a distal end of the gas-permeable strip being in communication with the connection arrangement in the distal portion of the bag, and a proximal end of the gas-permeable strip being disposed in a proximal portion of the bag, the gas-permeable strip comprising a partially compressible, gas-permeable material forming a lengthwise gas-flow pathway, wherein the gas-permeable strip has a thickness:width dimensionless aspect ratio of between 1:5 and 1:15.

In some embodiments, the strip or multi-layer strip forms a lengthwise gas-flow pathway at least in the pressure-regulating mode.

In some embodiments, the strip or multilayer strip can have a length equal to at least 40% of a length of the bag, a thickness:width dimensionless aspect ratio of between 1:1.5 and 1:20, and a length-to-width ratio of at least 3:1.

In some embodiments, the strip or multilayer strip can have a length equal to at least 50% of a length of the bag, a thickness:width dimensionless aspect ratio of between 1:2.5 and 1:20, and a length-to-width ratio of at least 5:1.

In some embodiments, the strip or multilayer strip can have a length equal to at least 40% of a length of the bag, a thickness:width dimensionless aspect ratio of between 1:2.5 and 1:20, and a length-to-width ratio of at least 3:1, and the strip or multilayer strip comprises a partially compressible, gas-permeable material that forms a lengthwise gas-flow pathway (at least) in a pressure-regulating mode over an absolute pressure range within the bag of 560 mm Hg to 960 mm Hg.

In some embodiments, the strip or multilayer strip can have a length equal to at least 60% of a length of the bag, a thickness:width dimensionless aspect ratio of between 1:2.5 and 1:20, and a length-to-width ratio of at least 3:1, and the strip or multilayer strip comprises a partially compressible, gas-permeable material that forms a lengthwise gas-flow pathway (at least) in a pressure-regulating mode over an absolute pressure range within the bag of 560 mm Hg to 960 mm Hg, and the strip or multilayer strip comprises a partially compressible, gas-permeable material that forms a lengthwise gas-flow pathway (at least) in a pressure-regulating mode that includes an externally applied pressure over a gauge pressure range of 0 mm Hg to 30 mm Hg.

A method is disclosed, according to embodiments, for administering a multibaric treatment protocol to a human subject using a gas-transfer system comprising first and second openings for gas transfer therethrough. The first opening is in fluid communication with a first vessel and the second opening is in fluid communication with a second vessel, the second vessel comprising multiple fluid-holding compartments openable at least to each other. The method comprises: (a) with the first vessel enveloping at least a lengthwise part of a limb of the subject, causing a flow of a therapeutic gas through the first opening and into the first vessel, and (b) while at least a portion of the therapeutic gas resides within the first vessel, and with the second vessel surrounding at least a lengthwise part of the first vessel, regulating, through the second opening, respective above-ambient gas pressures in the fluid-holding compartments of the second vessel so as to cause the fluid-holding compartments to apply respective compressive pressures, through a wall of the first vessel, to corresponding portions of the limb.

In another aspect, a method is disclosed for administering a multibaric treatment protocol to a human subject using a gas-transfer system comprising first and second openings for gas transfer therethrough. The first opening may be in fluid communication with a first vessel and the second opening may be in fluid communication with a second vessel, the second vessel comprising at least one fluid-holding compartment. The method comprises: (a) causing a flow of a therapeutic gas through the first opening and into the first vessel, and (b) while at least a portion of the therapeutic gas resides within the first vessel, and with the second vessel surrounding at least a lengthwise part of the first vessel, regulating, through the second opening, at least one above-ambient gas pressure in the at least one fluid-holding compartment of the second vessel so as to cause the at least one fluid-holding compartment to apply compressive pressure, through a wall of the first vessel, to corresponding portions of the limb.

According to the method, the regulating respective above-ambient gas pressures may cause a circulation of the therapeutic gas throughout at least a part of the first vessel that is surrounded by the second vessel to the extent that the at least a part is surrounded by the fluid-holding compartments.

In some embodiments, the first vessel can be, and typically is, flexible.

In some embodiments, the second vessel can be, and typically is, flexible.

In some embodiments, the method can additionally comprise, before the causing of a flow of a therapeutic gas: evacuating the first vessel through the first opening.

In some embodiments, the regulating respective above-ambient gas pressures in the fluid-holding compartments can include repeating a sequence of differential pressure regulation for a duration prescribed by a therapeutic protocol.

In some embodiments, the method can further comprise, after the regulating respective above-ambient gas pressures in the fluid-holding compartments: (i) with the first vessel surrounding at least part of the limb, evacuating the first vessel of the therapeutic gas, through the first opening, to reduce a pressure in the first vessel to a first below-ambient pressure; and (ii) causing a flow of the therapeutic gas through the first opening and into the evacuated first vessel to increase the pressure in the first vessel to a second below-ambient pressure.

In some embodiments, the method can additionally include: cycling between the first and second below-ambient pressures for a duration prescribed by a therapeutic protocol.

In some embodiments, the regulating respective above-ambient gas pressures in the fluid-holding compartments can include regulating respective pressures of between 20 and 100 mm Hg above ambient.

In some embodiments, the first below-ambient pressure can be between 10 and 50 mm Hg below ambient. In some embodiments, the second below-ambient pressure can be between 60 and 100 mm Hg below ambient. In some embodiments, a difference between the first below-ambient pressure and the second below-ambient pressure can be between 40 and 88 mm Hg gauge.

In some embodiments, the circulation of the therapeutic gas can be at least partly through a flow pathway in the first vessel.

In other aspects there is provided a system for administering a multibaric treatment protocol or method according to any of the embodiments disclosed herein.

According to embodiments, a system for administering a multibaric treatment protocol to a human subject comprises: (a) a first gas-transfer section comprising a first opening for gas transfer therethrough, the first section configured to (i) regulate a pressure in a first vessel placed in fluid communication therewith throughout a range from 200 mm Hg below an ambient pressure to 160 mm Hg above the ambient pressure, and (ii) cause a flow through the first opening of a therapeutic gas; (b) a second gas-transfer section comprising a second opening for gas transfer therethrough, the second portion configured to regulate a pressure in a second vessel placed in fluid communication therewith throughout an above-ambient range up to 100 mm Hg above the ambient pressure; and (c) electronic circuitry programmed to operate in each one of the following modes in sequence: (i) a first mode in which, responsively to an input affirming that the first vessel is in fluid communication with the first gas-transfer section and is disposed to envelop at least a lengthwise part of a limb of the subject, the first gas-transfer section causes a therapeutic gas to flow through the first opening and into the first vessel, and (ii) a second mode in which, responsively to an input affirming that the second vessel is in fluid communication with the second gas-transfer section and is disposed to surround at least a lengthwise part of the first vessel, the second gas-transfer section regulates, through the second opening and while at least a portion of the therapeutic gas resides within the first vessel, respective above-ambient gas pressures in fluid-holding compartments of the second vessel so as to cause the fluid-holding compartments to apply respective compressive pressures, through a wall of the first vessel, to corresponding portions of the limb, wherein the regulating causes a circulation of the therapeutic gas throughout the at least part of the first vessel that is surrounded by the second vessel to the extent that the at least part is surrounded by the fluid-holding compartments.

According to embodiments, a system for administering a multibaric treatment protocol to a human subject comprises: (a) a first gas-transfer section comprising a first opening for gas transfer therethrough, the first section configured to (i) regulate at least one of (A) a pressure in a first vessel placed in fluid communication therewith within a range from 50 mm Hg below an ambient pressure to ambient pressure; and (B) a pressure in a first vessel placed in fluid communication therewith within a range of ambient pressure to at least 50 mm Hg above the ambient pressure; and (ii) cause a flow through the first opening of a therapeutic gas; (b) a second gas-transfer section comprising a second opening for gas transfer therethrough, the second portion configured to regulate a pressure in a second vessel placed in fluid communication therewith; and (c) electronic circuitry programmed to operate in at least one of the following modes in sequence: (i) a first mode in which, responsively to an input affirming that the first vessel is in fluid communication with the first gas-transfer section and is disposed to envelop at least a lengthwise part of a limb of the subject, the first gas-transfer section causes a therapeutic gas to flow through the first opening and into the first vessel, and (ii) a second mode in which, responsively to an input affirming that the second vessel is in fluid communication with the second gas-transfer section and is disposed to surround at least a lengthwise part of the first vessel, the second gas-transfer section regulates, through the second opening and while at least a portion of the therapeutic gas resides within the first vessel, respective above-ambient gas pressures in fluid-holding compartments of the second vessel so as to cause the fluid-holding compartments to apply respective compressive pressures, through a wall of the first vessel, to corresponding portions of the limb, wherein the regulating causes a circulation of the therapeutic gas throughout the at least part of the first vessel that is surrounded by the second vessel to the extent that the at least part is surrounded by the fluid-holding compartments.

### Additional Embodiments

Various methods and apparatus, as well as additional systems, are disclosed herein.

Additional Embodiments (or “Clauses”) 1 to 111 are provided hereinbelow.

Embodiment 1. A method for administering a multibaric treatment protocol to a human subject using a gas-transfer system comprising first and second openings for gas transfer therethrough, the first opening in fluid communication with a first vessel and the second opening in fluid communication with a second vessel, the second vessel comprising multiple fluid-holding compartments, the method comprising:
a. with the first vessel enveloping at least a lengthwise part of a limb of the subject, causing a flow of a gas through the first opening and into the first vessel, and
b. while at least a portion of the gas resides within the first vessel, and with the second vessel surrounding at least a lengthwise part of the first vessel, regulating, through the second opening, respective above-ambient gas pressures in the fluid-holding compartments of the second vessel so as to cause the fluid-holding compartments to apply respective compressive pressures, through a wall of the first vessel, to corresponding portions of the limb.
Embodiment 1A. The method of Embodiment 1, wherein the second vessel and the fluid-holding compartments are sealed from the atmosphere.
Embodiment 1B. The method of either one of Embodiments 1 or 1A, wherein at least one of: (1) the second vessel and (2) the fluid-holding compartments are sealed from the first vessel.
   Embodiment 2. The method of Embodiment 1, wherein said gas includes a therapeutic gas.
   Embodiment 3. The method of any preceding Embodiment, wherein said gas includes at least one of ozone, oxygen, and an essential oil.
   Embodiment 4. The method of any preceding Embodiment, wherein said regulating respective above-ambient gas pressures causes a circulation of said gas throughout at least a part of the first vessel that is surrounded by the second vessel to the extent that said at least a part is surrounded by said fluid-holding compartments.
   Embodiment 5. The method of any preceding Embodiment, wherein said regulating respective above-ambient gas pressures in the fluid-holding compartments includes repeating a sequence of differential pressure regulation.
   Embodiment 6. The method of either one of Embodiments 4 or 5, wherein said circulation of said gas is at least partly through a gas-flow pathway strip disposed within said first vessel, said gas-flow pathway strip being laterally open along its length to an interior space of said first vessel, such that a fluid disposed within said first vessel can flow freely into and out of said gas-flow pathway strip.
   Embodiment 6A. The method of Embodiment 6, wherein the gas-flow pathway strip is disposed lengthwise, i.e., longitudinally, within said first vessel.
   Embodiment 6B. The method of either one of Embodiments 6 or 6A, wherein the gas-flow pathway strip comprises an at-most partly compressible material, and when the first vessel is at least partially evacuated, the gas-flow pathway strip allows flow of a gas along its entire length.
   Embodiment 6C. The method of Embodiment 6B, wherein when the first vessel is at least partially evacuated under negative pressure (vacuum), one or more walls of the first vessel is/are collapsed so as to apply a lateral force on the gas-flow pathway strip, making the strip a laterally-closed, longitudinally-open gas-flow pathway.
   Embodiment 6D. The method of any one of Embodiments 6 to 6C, wherein when one or more walls of the first vessel are collapsed by expansion of one or more the fluid-holding compartments of the second vessel, the gas-flow pathway strip maintains a viable conduit for conveyance of a gas at least for the extent of the first vessel that is surrounded by the fluid-holding compartments of the second vessel.
   Embodiment 6E. The method of any one of Embodiments 6 to 6D, wherein the strip is aligned longitudinally with the fluid-holding compartments.
   Embodiment 7. The method of any preceding Embodiment, additionally comprising, before said causing of a flow of a gas: evacuating the first vessel through the first opening.
   Embodiment 8. The method of any preceding Embodiment, further comprising, after said regulating respective above-ambient gas pressures in said fluid-holding compartments:
i. with the first vessel surrounding at least part of said limb, evacuating the first vessel of said gas, through the first opening, to reduce a pressure in said first vessel to a first below-ambient pressure; and
ii. causing a flow of said gas through said first opening and into said evacuated first vessel to increase said pressure in said first vessel to a second below-ambient pressure.
   Embodiment 9. The method of Embodiment 8, additionally including: cycling between said first and second below-ambient pressures for a duration prescribed by a therapeutic protocol.
   Embodiment 10. The method of any preceding Embodiment, wherein said regulating respective above-ambient gas pressures in the fluid-holding compartments includes regulating respective pressures at values within a range of 20 and 100 mm Hg above ambient pressure.
   Embodiment 11. The method of any preceding Embodiment, wherein said first below-ambient pressure has a value within a range of 10 and 50 mm Hg below ambient pressure.
   Embodiment 12. The method of any preceding Embodiment, wherein said second below-ambient pressure has a value within a range of 60 and 100 mm Hg below ambient pressure.
   Embodiment 13. The method of any preceding Embodiment, wherein a difference between said first below-ambient pressure and said second below-ambient pressure is between 40 and 88 mm Hg.
   Embodiment 14. The method of Embodiment 13, wherein a gas-flow pathway is maintained in said gas-flow pathway strip at both the first and second below-ambient pressures.
   Embodiment 15. The method of any one of Embodiments 6 to 14, wherein said gas-flow pathway strip is formed integrally with said first vessel.
   Embodiment 16. The method of any one of Embodiments 6 to 14, wherein said gas-flow pathway is affixed to an interior surface of said first vessel.
   Embodiment 17. The method of any preceding Embodiment, additionally comprising: placing an elastically-compressible element in contact with a target area of the limb.
   Embodiment 17A. The method of Embodiment 17, wherein said elastically-compressible element is also in contact with the gas-flow pathway strip to form a gas flow pathway connecting the elastically-compressible element and the connection arrangement via the gas-flow pathway strip.
   Embodiment 17B. The method of Embodiment 17A, wherein said contact with the gas-flow pathway strip is a direct contact.
   Embodiment 18. The method of any one of Embodiments 17 to 17B, wherein said elastically-compressible element is at least partly compressed when said first vessel is evacuated via the first opening to reduce the pressure within said first vessel to said first below-ambient pressure.
   Embodiment 18A. The method of Embodiment 18, wherein said first vessel is sufficiently evacuated via the first opening so as to draw the first vessel tightly over the limb.
   Embodiment 19. The method of Embodiment 18 or Embodiment 18A, wherein said causing the flow of said gas through said first opening is effective to expand the at least partially compressed elastically-compressible element.
   Embodiment 20. The method of any one of Embodiments 17 to 19, wherein said elastically-compressible element comprises an open-celled foam.
   Embodiment 21. The method of any preceding Embodiment, wherein a volume of said at least a portion of said gas is within a range of 0.3 to 10 liters.
   Embodiment 21A. The method of Embodiment 21, wherein said volume is at least 0.5 liters.
   Embodiment 21B. The method of Embodiment 21, wherein said volume is at least 1 liter.
   Embodiment 21C. The method of Embodiment 21, wherein said volume is at least 1.5 liters.
   Embodiment 21D. The method of any one of Embodiments 21 to 210, wherein said volume is at most 8 liters.
   Embodiment 21E. The method of Embodiment 21 D, wherein said volume is at most 6 liters.
   Embodiment 21F. The method of Embodiment 21 D, wherein said volume is at most 5 liters.
   Embodiment 21G. The method of Embodiment 21 D, wherein said volume is at most 4 liters.
   Embodiment 22. The method of any preceding Embodiment, wherein said regulating of respective above-ambient gas pressures includes regulating respective above-ambient gas pressures to cause sequential compression of said gas in said first vessel.
   Embodiment 23. The method of any preceding Embodiment, wherein the first vessel is flexible.
   Embodiment 24. The method of any preceding Embodiment, wherein the second vessel is flexible.
   Embodiment 25. A system for administering a multibaric treatment protocol to a human subject, the system comprising:
a. a first gas-transfer section comprising a first opening for gas transfer therethrough, the first section configured to (i) regulate a pressure in a first vessel placed in fluid communication therewith, and (ii) cause a flow of a gas through said first opening;
b. a second gas-transfer section comprising a second opening for gas transfer therethrough, the second portion configured to regulate a pressure in a second vessel placed in fluid communication therewith; and
c. electronic circuitry programmed to operate in each one of the following modes in sequence:
   i. a first mode in which said first gas-transfer section causes a gas to flow through said first opening and into said first vessel, and
   ii. a second mode in which said second gas-transfer section regulates, through the second opening and while at least a portion of said gas resides within the first vessel, respective gas pressures in fluid-holding compartments of said second vessel so as to cause said fluid-holding compartments to apply respective compressive pressures, through a wall of the first vessel, to corresponding portions of said limb.
      Embodiment 26. The system of Embodiment 25, wherein in said first mode, the causing of the gas to flow by said first gas-transfer section is in response to an input affirming that said first vessel is in fluid communication with said first gas-transfer section and is disposed to envelop at least a lengthwise part of a limb of the subject.
      Embodiment 27. The system of either one of Embodiments 25 or 26, wherein in said second mode, the regulating of respective gas pressures by said second gas-transfer section is in response to an input affirming that said second vessel is in fluid communication with said second gas-transfer section and is disposed to surround at least a lengthwise part of said first vessel.
      Embodiment 28. The system of any one of Embodiments 25 to 27, wherein said regulating causes a circulation of said gas throughout said at least part of the first vessel that is surrounded by the second vessel to the extent that said at least part is surrounded by said fluid-holding compartments.
      Embodiment 28A. The system of Embodiment 28, wherein the circulation is at least partly caused by a sequence of inflations and/or deflations of said fluid-holding compartments.
      Embodiment 29. The system of any one of Embodiments 25 to 28A, wherein said regulating respective gas pressures in said fluid-holding compartments includes repeating a sequence of differential pressure regulation.
      Embodiment 30. The system of either one of Embodiments 28 or 29, wherein said circulation of said gas is at least partly (e.g., at least 30%, at least 50%, at least 70%, at least 90%, or at least 95%) through a gas-flow pathway strip disposed lengthwise within said first vessel, said gas-flow pathway strip being laterally open along its length to an interior space of said first vessel, such that a fluid disposed within said first vessel can flow freely into and out of said gas-flow pathway strip.
      Embodiment 31. The system of any one of Embodiments 25 to 30, wherein said gas includes a therapeutic gas.
      Embodiment 32. The system of any one of Embodiments 25 to 31, wherein said gas includes ozone, oxygen, and an essential oil.
      Embodiment 33. The system of any one of Embodiments 25 to 32, wherein said gas includes at least one of oxygen and an essential oil.
      Embodiment 34. The system any one of Embodiments 25 to 33, wherein said first gas-transfer section is configured to regulate said pressure in said first vessel throughout a range from 200 mm Hg below an ambient or atmospheric pressure to 160 mm Hg above an ambient or atmospheric pressure.
      Embodiment 35. The system of one of Embodiments 25 to 34, wherein said second gas-transfer section is configured to regulate said pressure in said second vessel throughout a range of 0 to 100 mm Hg above an ambient or atmospheric pressure.
      Embodiment 36. The system of any one of Embodiments 30 to 35, wherein said gas-flow pathway strip is formed integrally with said first vessel.
      Embodiment 37. The system of any one of Embodiments 30 to 35, wherein said gas-flow pathway is affixed, and optionally, directly affixed, to an interior surface of said first vessel.
      Embodiment 37A. The system of any one of Embodiments 25 to 37, wherein the first gas-transfer section comprises an ozone generator for delivering an ozone-containing gas to the first vessel.
      Embodiment 37B. The system of any one of Embodiments 25 to 37A, wherein the first gas-transfer section comprises a container for storage of, or containing, a therapeutic gas, for delivering said therapeutic gas to the first vessel.
      Embodiment 37C. The system of any one of Embodiments 25 to 37B, wherein said first gas-transfer section is configured to regulate said pressure in said first vessel throughout a range of 50 mm Hg below an ambient or atmospheric pressure to an ambient or atmospheric pressure.
      Embodiment 37D. The system of any one of Embodiments 25 to 37C, wherein said second gas-transfer section is configured to regulate said pressure in said second vessel throughout a range of 0 to 40 mm Hg above an ambient or atmospheric pressure.
      Embodiment 37E. The system of any one of Embodiments 25 to 37D, the first vessel and the gas-flow pathway strip adapted whereby, when the first vessel is subjected to a particular negative pressure within a range of 660 to 710 mm Hg (absolute), at least one wall of the first vessel collapses so as to apply a lateral force on the gas-flow pathway strip, making the strip a laterally-closed, longitudinally-open gas-flow pathway.
      Embodiment 37F. The system of any one of Embodiments 25 to 37E, wherein, said electronic circuitry is further programmed, in a third mode, to withdraw said gas that resides within the first vessel, to reduce a pressure in the first vessel to a first below-ambient pressure or sub-atmospheric pressure.
      Embodiment 37G. The system of Embodiment 37F, wherein said electronic circuitry is further programmed, in a fourth mode following said third mode, to introduce into the first vessel, a volume of a or said therapeutic gas, while maintaining said pressure in the first vessel below the ambient or atmospheric pressure.
      Embodiment 38. A method for applying a hypobaric therapy to a human limb, the method comprising:
a. providing a pressure-regulating device and a bag assembly, the bag assembly comprising:
   i. a bag comprising a connection arrangement mounted to a wall of the bag in a distal portion thereof, and
   ii. a gas-flow pathway strip disposed within the bag between said connection arrangement and a proximal portion of the bag, said strip being laterally open along its length to an interior space of the bag, such that when the bag is provided in a non-evacuated state, a fluid disposed within the bag can flow freely into and out of said gas-flow pathway strip;
b. receiving, in the bag, at least a portion of the limb, through an opening in said proximal portion of the bag;
c. connecting the pressure-regulating device to the connection arrangement so as to enable therethrough, in a pressure-regulating mode, a flow of a gas between the pressure-regulating device and an interior space of the bag; and
d. controlling the pressure-regulating device to remove a portion of said gas from an interior space of the bag, to reduce a pressure in said interior space to a first below-ambient pressure.
   Embodiment 38A. The method of Embodiment 38, wherein the gas-flow pathway strip is disposed lengthwise between said connection arrangement and said proximal portion of the bag.
   Embodiment 38B. The method of either of Embodiments 38 or 38A, wherein the gas-flow pathway strip comprises an at-most partly compressible material, and the strip is configured to maintain a viable gas-flow pathway when said first below-ambient pressure causes one or more bags of the wall to collapse and apply a compressing force on the gas-flow pathway strip.
   Embodiment 39. The method of any one of Embodiments 38 to 38B, additionally comprising: further controlling the pressure-regulating device to deliver a quantity of a therapeutic gas into said interior space, thereby raising said pressure in said interior space to a second below-ambient pressure.
   Embodiment 40. The method of either one of Embodiments 38 or 39, wherein a gas-flow pathway is maintained in said gas-flow pathway strip at both the first and second below-ambient pressures.
   Embodiment 41. The method of any one of Embodiments 38 to 40, additionally comprising: providing an elastically-compressible element in fluid communication with, or fluidly contacting, the gas-flow pathway strip and with a target area of the limb.
   Embodiment 42. The method of Embodiment 41, wherein said elastically-compressible element is at least partly compressed at said first below-ambient pressure in said interior space and biased to expand when said pressure is raised to said second below-ambient pressure.
   Embodiment 43. The method of either one of Embodiments 41 or 42, wherein said elastically-compressible element comprises an open-celled foam.
   Embodiment 44. The method of any one of Embodiments 39 to 43, wherein the delivery of said quantity of said therapeutic gas into said interior space is at least partly through said gas-flow pathway strip.
   Embodiment 45. The method of any one of Embodiments 39 to 44, wherein the delivery of said quantity of said therapeutic gas to said elastically-compressible element is substantially all through said gas-flow pathway strip.
   Embodiment 46. The method of any one of Embodiments 38 to 45, wherein said gas-flow pathway strip is formed integrally with said first vessel.
   Embodiment 47. The method of any one of Embodiments 38 to 45, wherein said gas-flow pathway is affixed to an interior surface of said first vessel.
   Embodiment 48. The method of any one of Embodiments 38 to 47, wherein said first below-ambient pressure has a value within a range of 10 and 50 mm Hg below ambient pressure.
   Embodiment 49. The method any one of Embodiments 39 to 48, wherein said second below-ambient pressure has a value within a range of 60 and 100 mm Hg below ambient pressure.
   Embodiment 50. Apparatus for use, with a pressure-regulating device, in applying a therapy to a human limb, the apparatus comprising:
a. a bag formed to receive, in a donned mode, at least a portion of the limb, through an opening in a proximal portion of the bag;
b. a multilayer strip comprising a bottommost layer affixed to an interior surface of the bag, wherein a distal end of said multilayer strip is disposed in a distal portion of the bag, and wherein a proximal end of said multilayer strip is disposed in said proximal portion of the bag; and
c. a connection arrangement mounted to a wall of the bag in said distal portion thereof, the connection arrangement being effective, in a pressure-regulating mode, to enable therethrough a flow of a gas between the pressure-regulating device and an interior space of the bag,
said multilayer strip further comprising an upper layer comprising a partially compressible material defining a gas-flow pathway disposed lengthwise within the bag, between said connection arrangement and said proximal portion of the bag.
   Embodiment 51. The apparatus of Embodiment 50, wherein said multilayer strip is laterally open along its length to the interior space of the bag from the distal portion of the bag to the proximal portion of the bag, such that when the bag is in a non-evacuated state, a fluid disposed within the bag can flow freely into and out of the partially compressible material of said upper layer.
   Embodiment 52. The apparatus of either one of Embodiments 50 or 51, wherein said lengthwise gas-flow pathway is maintained when a gas pressure in the bag is at most 660 mm Hg (absolute).
   Embodiment 53. The apparatus of any one of Embodiments 50 to 52, wherein said multilayer strip has a dimensionless thickness-to-width aspect ratio of between 1:2.5 and 1:20.
   Embodiment 54. The apparatus of any one of Embodiments 50 to 53, wherein said lengthwise gas-flow pathway is maintained when a gas pressure inside the bag is 560 mm Hg (absolute).
   Embodiment 55. The apparatus of any one of Embodiments 50 to 54, wherein said lengthwise gas-flow pathway is maintained when a mechanical pressure of 20 mm Hg gauge is applied externally to the bag (e.g., by a partly inflatable sleeve surrounding the bag) and transmitted through a wall of the bag to an uppermost layer of the multilayer strip.
   Embodiment 56. The apparatus of any one of Embodiments 50 to 55, wherein (i) said lengthwise gas-flow pathway is maintained when a mechanical pressure of 60 mm Hg gauge is applied externally to the bag by a partly inflatable sleeve surrounding the bag and transmitted through a wall of the bag to an uppermost layer of the multilayer strip.
   Embodiment 57. The apparatus of any one of Embodiments 50 to 56, wherein said multilayer strip has a Shore A hardness of at most 70.
   Embodiment 58. The apparatus of any one of Embodiments 50 to 57, wherein said distal end of said multilayer strip is in fluid communication with said connection arrangement such that said partially compressible material forms said gas-flow pathway from said connection arrangement to said proximal end of said multilayer strip.
   Embodiment 59. The apparatus of any one of Embodiments 50 to 58, wherein said multilayer strip has a length-to-width ratio of at least 3:1.
   Embodiment 60. The apparatus of any one of Embodiments 50 to 59, wherein said multilayer strip has a length of at least 10 cm.
   Embodiment 61. The apparatus of any one of Embodiments 50 to 60, wherein said multilayer strip has a thickness of no more than 5 mm.
   Embodiment 62. The apparatus of any one of Embodiments 50 to 61, wherein said upper layer has a thickness of no more than 3.5 mm.
   Embodiment 63. The apparatus of any one of Embodiments 50 to 62, wherein the limb is one of a hand and a foot.
   Embodiment 64. The apparatus of any one of Embodiments 50 to 63, wherein said multilayer strip has a length equal to at least 70% of a length of the bag.
   Embodiment 65. The apparatus of any one of Embodiments 50 to 64, wherein a footprint of said multilayer strip has an area less than 10 percent of an area of the bag when lain flat without wrinkles or folds.
   Embodiment 66. The apparatus of any one of Embodiments 50 to 65, wherein (i) said distal portion of the bag includes a distally-disposed tab section open to said interior space of the bag, said distal tab section having a width less than 25% of a maximum width of said distal portion of the bag, and (ii) said connection arrangement is mounted at least partly within said distally-disposed tab section.
   Embodiment 67. The apparatus of Embodiment 66, wherein said connection arrangement is mounted entirely within said distally-disposed tab section.
   Embodiment 68. The apparatus of any one of Embodiments 50 to 67, wherein the bottommost layer includes an adhesive.
   Embodiment 69. The apparatus of any one of Embodiments 50 to 68 wherein said multilayer strip is attached to a first wall of the bag and the connection arrangement is mounted to a second wall of the bag.
   Embodiment 70. The apparatus of any one of Embodiments 50 to 69, wherein said multilayer strip is effective to maintain fluid communication along a lengthwise path when a portion of said path is subjected to an externally-applied positive pressure of 100 mm Hg gauge, said externally-applied positive pressure being applied by a partly inflatable sleeve surrounding the bag.
   Embodiment 71. Apparatus for use, with a pressure-regulating device, in applying a therapy to a target area of a human limb, the apparatus comprising:
(a) a bag comprising:
   (i) two opposing bag-sections; and
   (ii) a connection arrangement mounted to a first bag-section in a distal portion of the bag;
(b) a strip extending lengthwise along a bag-section from said distal portion of the bag to a proximal portion thereof and in fluid communication with the connection arrangement; said strip having a first uncompressed thickness; and
(c) a porous, compressible article, dimensioned to fit within said bag, and having a second uncompressed thickness;
said porous, compressible article and a proximal end of said strip adapted, when juxtaposed, to form a gas-flow pathway configuration;
and wherein, when disposed in said configuration and subjected to a force exerted thereupon by the two bag-sections when the bag is subjected to a negative pressure, said porous, compressible article is proportionally more compressed than said strip.
   Embodiment 72. The apparatus of Embodiment 71, wherein said second uncompressed thickness is greater than said first uncompressed thickness.
   Embodiment 73. The apparatus of either one of Embodiments 71 or 72, wherein said second uncompressed thickness is at least twice said first uncompressed thickness.
   Embodiment 74. The apparatus of any of Embodiments 71 to 73, wherein when subjected to said force when said negative pressure in the bag is 100 mm Hg (660 mm Hg absolute), said strip retains at least 90% of said first uncompressed thickness.
   Embodiment 75. The apparatus of any of Embodiments 71 to 73, wherein when subjected to said force when said negative pressure in the bag is 100 mm Hg (660 mm Hg absolute), said strip retains at least 95% of said first uncompressed thickness.
   Embodiment 76. The apparatus of any of Embodiments 71 to 75, wherein when subjected to said force when said negative pressure in the bag is 100 mm Hg (660 mm Hg absolute), said porous, compressible article retains less than 80% of said second uncompressed thickness.
   Embodiment 77. The apparatus of any of Embodiments 71 to 75, wherein when subjected to said force when said negative pressure in the bag is 100 mm Hg (660 mm Hg absolute), said porous, compressible article retains less than 50% of said second uncompressed thickness.
   Embodiment 78. The apparatus of any one of Embodiments 71 to 77, wherein said strip is formed integrally with the bag.
   Embodiment 79. The apparatus of any one of Embodiments 71 to 78, wherein said strip is affixed to an interior surface of the bag.
   Embodiment 80. The apparatus of any one of Embodiments 71 to 79, wherein said porous, compressible article is biased to expand proportionally more than said strip when the pressure in the bag is increased.
   Embodiment 81. The apparatus of any one of Embodiments 71 to 80, wherein said strip is laterally open along its length to an interior space of the bag, such that when the bag is in a non-evacuated state, a gas disposed within the bag flows freely into and out of said strip.
   Embodiment 82. The apparatus of any one of Embodiments 71 to 81, wherein said strip is one of: integrally formed with the bag, and affixed to an interior surface of the bag.
   Embodiment 83. The apparatus of any one of Embodiments 71 to 82, wherein the apparatus is provided as a kit comprising first and second elements, said first element comprising the bag having said first portion affixed thereto or integrally formed therewith, said second element comprising said second portion.
   Embodiment 84. The apparatus of any one of Embodiments 71 to 83, wherein said porous, compressible article includes an elastically-compressible material.
   Embodiment 85. The apparatus of Embodiment 84, wherein said elastically-compressible material comprises an open-celled foam.
   Embodiment 86. Apparatus for use, with a pressure-regulating device, in applying a therapy to a human limb, the apparatus comprising:
a. a bag formed to receive, in a donned mode, at least a portion of the limb, through an opening in a proximal portion of the bag;
b. a connection arrangement mounted to a wall of the bag in a distal portion thereof, the connection arrangement being effective, when connected to the pressure-regulating device, to enable therethrough a flow of a gas between the pressure-regulating device and an interior space of the bag; and
c. a strip formed on an interior surface of the bag, said strip defining a lengthwise gas-flow pathway within the bag, in between said connection arrangement and a proximal portion of the bag.
   Embodiment 87. The apparatus of Embodiment 86, wherein said strip is integrally formed with the bag.
   Embodiment 88. The apparatus of Embodiment 86 or Embodiment 87, wherein said lengthwise gas-flow pathway extends to said connection arrangement.
   Embodiment 89. The apparatus of any one of Embodiments 86 to 88, wherein the strip comprises a plurality of parallel raised rails and a plurality of grooves disposed between adjacent rails.
   Embodiment 90. The apparatus of Embodiment 89, wherein for at least some of the plurality of grooves, respective widths of one or more grooves are less than or equal to respective heights of corresponding adjacent rails.
   Embodiment 91. The apparatus of any one of Embodiments 86 to 88, wherein the strip comprises a plurality of raised protrusions.
   Embodiment 92. The apparatus of Embodiment 91, wherein for at least some of the plurality of raised protrusions, a spacing between neighboring raised protrusions is less than respective heights of said neighboring protrusions.
   Embodiment 93. The apparatus of any one of Embodiments 86 to 92, wherein said strip is laterally open along its length to the interior space of the bag from the distal portion of the bag to the proximal portion of the bag, such that when the bag is in a non-evacuated state, a fluid disposed within the bag can flow freely into and out of said strip.
   Embodiment 94. The apparatus of any one of Embodiments 86 to 93, wherein said lengthwise gas-flow pathway is maintained when a gas pressure in the bag is at most 660 mm Hg (absolute).
   Embodiment 95. The apparatus of any one of Embodiments 86 to 94, wherein said strip has a dimensionless thickness-to-width aspect ratio of between 1:2.5 and 1:20.
   Embodiment 96. The apparatus of any one of Embodiments 86 to 95, wherein said lengthwise gas-flow pathway is maintained when a gas pressure inside the bag is 560 mm Hg (absolute).
   Embodiment 97. The apparatus of any one of Embodiments 86 to 96, wherein said lengthwise gas-flow pathway is maintained when a mechanical pressure of 20 mm Hg gauge is applied externally to the bag by a partly inflatable sleeve surrounding the bag and transmitted through a wall of the bag to the top of the strip.
   Embodiment 98. The of any one of Embodiments 86 to 97, wherein (i) said lengthwise gas-flow pathway is maintained when a mechanical pressure of 60 mm Hg gauge is applied externally to the bag by a partly inflatable sleeve surrounding the bag and transmitted through a wall of the bag to the top of the strip.
   Embodiment 99. The apparatus of any one of Embodiments 86 to 98, wherein said strip has a Shore A hardness of at most 70.
   Embodiment 100. The apparatus of any one of Embodiments 86 to 94, wherein said strip has a length-to-width ratio of at least 3:1.
   Embodiment 101. The apparatus of any one of Embodiments 86 to 100, wherein said strip has a length of at least 10 cm.
   Embodiment 102. The apparatus of any one of Embodiments 86 to 101, wherein a thickness of said strip is at most 7 mm.
   Embodiment 102A. The apparatus of Embodiment 105, wherein said thickness of said strip is at most 5 mm.
   Embodiment 1028. The apparatus of Embodiment 105, wherein said thickness of said strip is at most 4 mm.
   Embodiment 102C. The apparatus of Embodiment 105, wherein said thickness of said strip is at most 3 mm.
   Embodiment 103. The apparatus of any one of Embodiments 86 to 102, wherein said strip has a length equal to at least 70% of a length of the bag.
   Embodiment 104. The apparatus of any one of Embodiments 86 to 103, wherein a footprint of said strip has an area less than 10 percent of an area of the bag when lain flat without wrinkles or folds.
   Embodiment 105. The apparatus of any one of Embodiments 86 to 104, wherein (i) said distal portion of the bag includes a distally-disposed tab section open to said interior space of the bag, said distal tab section having a width less than 25% of a maximum width of said distal portion of the bag, and (ii) said connection arrangement is mounted at least partly within said distally-disposed tab section.
   Embodiment 106. The apparatus of Embodiment 105, wherein said connection arrangement is mounted entirely within said distally-disposed tab section.
   Embodiment 107. The apparatus of any one of Embodiments 86 to 106, wherein said strip and the bag are formed from the same material.
   Embodiment 108. The apparatus of any one of Embodiments 86 to 107, wherein said strip is formed on a first wall of the bag and the connection arrangement is mounted to a second wall of the bag.
   Embodiment 109. The apparatus of any one of Embodiments 86 to 108, wherein said strip is effective to maintain fluid communication along a lengthwise path when a portion of said path is subjected to an externally-applied positive pressure of 100 mm Hg gauge, said externally-applied positive pressure being applied by a partly inflatable sleeve surrounding the bag.
   Embodiment 110. The apparatus of any one of Embodiments 86 to 109, wherein a or said thickness of said strip is at least 1.0 mm.
   Embodiment 111. The apparatus of Embodiment 110, wherein said thickness of said strip is at least 2.0 mm.

As used herein in the specification and in the claims section that follows, the term “atmospheric pressure” refers to 760 mm Hg (absolute).

### Inventive Concepts

Various methods and apparatus, as well as additional systems, are disclosed herein as numbered inventive concepts.

Inventive concepts (or “Clauses”) 1 to 55 are provided hereinbelow.

Inventive concept 1: A method for administering a multibaric treatment protocol to a human subject using a gas-transfer system, the method comprising:
a. providing a first vessel comprising (i) a pliable bag having an opening in a proximal portion thereof and comprising first and second opposing bag sections, (ii) a connection arrangement mounted to the first bag section, and a (iii) lengthwise strip arranged on an interior surface of the second bag section such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip, wherein said providing includes:
   i. receiving, through said opening, at least a lengthwise part of a limb of the subject in said pliable bag so as to envelop said lengthwise part of said limb, the receiving being such that said distal portion of said lengthwise strip remains in fluid communication with said connection arrangement, and
   ii. placing said interior space of said pliable bag in fluid communication with a first opening of the gas-transfer system through said connection arrangement;
b. providing a second vessel having a proximal opening and comprising multiple fluid-holding compartments arranged consecutively along a lengthwise portion of said second vessel, wherein said providing includes:
   i. at least partly surrounding, by said second vessel, said enveloped lengthwise part of said limb, and
   ii. placing the respective fluid-holding compartments in fluid communication with multiple corresponding openings of the gas-transfer system;
c. subsequent to said providing of said first vessel and while said opening of said pliable bag is sealed about said limb, causing a flow of a quantity of gas through the first opening and into the bag;
d. subsequent to said providing of said second vessel, and while said quantity of gas resides within the bag, causing a lengthwise circulation of said quantity of gas at least throughout a lengthwise portion of the bag that is surrounded by said multiple fluid-holding compartments, the causing of the circulation including regulating, through said multiple corresponding openings, respective gas pressures in the fluid-holding compartments to alternately inflate and deflate said compartments, each inflating being effective to apply a compressive pressure through a wall of the bag to a corresponding portion of said limb, wherein:
   i. the alternately inflating and deflating includes alternately inflating and deflating consecutive fluid-holding compartments, and
   ii. said lengthwise strip defines a lengthwise, at-most-partly compressible fluid pathway for gas flow between first and second non-contiguous lengthwise portions of the bag that are respectively distal and proximal to a lengthwise portion of the bag that is under compressive pressure applied by one or more corresponding fluid-holding compartments.

Inventive concept 2: The method of Inventive Concept 1, wherein said quantity of gas caused in the first mode to flow through said first opening and into said first vessel has an ambient-pressure volume of at least 100 cc.

Inventive concept 3: The method of either one of Inventive Concepts 1 or 2, wherein (i) said applying of said compressive pressure through a wall of said pliable bag to a corresponding portion of said limb by inflating one or more of said fluid-holding compartments is effective to displace a portion of said quantity of gas within said first vessel, and (ii) said ambient-pressure volume of said quantity of gas is selected so that said displacing does not create an above-ambient pressure within said second vessel.

Inventive concept 4: The method of any one of Inventive Concepts 1 to 3, wherein (i) the regulating in the second mode of respective gas pressures in the fluid-holding compartments to alternately inflate and deflate said compartments includes repeating a sequence of differential pressure regulation

Inventive concept 5: The method of any one of Inventive Concepts 1 to 4, wherein said quantity of gas includes at least one of ozone, oxygen, and an essential oil.

Inventive concept 6: The method of any one of Inventive Concepts 1 to 5, wherein in the first mode, the causing of said flow of said quantity of gas is preceded by evacuating said first vessel through the first opening.

Inventive concept 7: The method of any one of Inventive Concepts 1 to 6, wherein a volume of said quantity of gas is within a range of 0.3 to 10 liters.

Inventive concept 8: The method of any one of Inventive Concepts 1 to 7, wherein said lengthwise strip is formed integrally with said pliable bag.

Inventive concept 9: The method of any one of Inventive Concepts 1 to 7, wherein said lengthwise strip is affixed to said second bag section.

Inventive concept 10: The method of any one of Inventive Concepts 1 to 9, wherein in the second mode when the second vessel at least partly surrounds said enveloped lengthwise part of said limb, said lengthwise strip is aligned longitudinally with said multiple fluid-holding compartments.

Inventive concept 11: The method of any one of Inventive Concepts 1 to 10, wherein said lengthwise strip has a length of at least 10 cm.

Inventive concept 12: The method of any one of Inventive Concepts 1 to 11, wherein said lengthwise strip has a thickness of no more than 3.5 mm.

Inventive concept 13: The method of any one of Inventive Concepts 1 to 12, wherein the first gas-transfer section comprises an ozone generator for delivering an ozone-containing gas to said first vessel.

Inventive concept 14: The method of any one of Inventive Concepts 1 to 13, wherein the first gas-transfer section comprises a container for storage of a therapeutic gas.

Inventive concept 15: The method of any one of Inventive Concepts 1 to 14, wherein when one or more bag-sections of said pliable bag are collapsed by inflation of one or more of said multiple fluid-holding compartments, said lengthwise strip maintains a viable conduit for conveyance of a gas at least for the extent of said first vessel that is surrounded by said fluid-holding compartments of said second vessel.

Inventive concept 16: A method for administering a treatment protocol to a human subject using a gas-transfer system, the method comprising:
a. providing a vessel comprising (i) a pliable bag having an opening in a proximal portion thereof and comprising first and second opposing bag sections, (ii) a connection arrangement mounted to the first bag section, and a (iii) lengthwise strip arranged on an interior surface of the second bag section such that a distal end of the s lengthwise trip is disposed in a distal portion of said pliable bag and a proximal end of the lengthwise strip is disposed in a proximal portion of said pliable bag, the lengthwise strip comprising an at-most-partially compressible layer open to an interior space of said pliable bag along the length of said lengthwise strip, wherein said providing includes:
   i. receiving, through said opening, at least a lengthwise part of a limb of the subject in said pliable bag so as to envelop said lengthwise part of said limb, and
   ii. placing said interior space of said pliable bag in fluid communication with an opening of the gas-transfer system through said connection arrangement;
b. placing an elastically-compressible element, biased to expand to a design height in at least one dimension, (i) in contact and/or in fluid communication with a target area of the limb and (ii) in contact and/or in fluid communication with said lengthwise strip, so as to form an at-most-partly compressible fluid pathway in communication with both the elastically-compressible element and the connection arrangement.
c. subsequent to said providing of said vessel, evacuating said vessel, through said first opening of said gas-transfer system, to reduce a pressure in said vessel to a below-ambient pressure and to at least partially compress said elastically-compressible element; and
d. causing a quantity of gas to flow through said first opening of said gas-transfer system and into said evacuated vessel to increase said pressure in said vessel, the flow of gas traversing said lengthwise strip to expand the at least partially compressed elastically-compressible element.

Inventive concept 17: The system of Inventive Concept 16, wherein said elastically-compressible element comprises an open-celled foam.

Inventive concept 18: The system of any either one of Inventive Concepts 16 or 17, wherein said below-ambient pressure is between 10 and 100 mm Hg below ambient pressure.

Inventive concept 19: The system of any one of Inventive Concepts 16 to 18, wherein the flow of said quantity of therapeutic gas to said elastically-compressible element is at least partly through said lengthwise strip.

Inventive concept 20: The system of any one of Inventive Concepts 16 to 19, wherein the flow of said quantity of gas to said elastically-compressible element is substantially all through said lengthwise strip.

Inventive concept 21: The system of any one of Inventive Concepts 16 to 20, wherein a footprint of said lengthwise strip has an area less than 10 percent of an area of said pliable bag when lain flat without wrinkles or folds.

Inventive concept 22: The system of any one of Inventive Concepts 16 to 21, wherein said lengthwise strip has a length equal to at least 70% of a length of said pliable bag.

Inventive concept 23: The system of any of Inventive Concepts 16 to 22, wherein when said pressure in said pliable bag is reduced to said below-ambient pressure, said lengthwise strip retains at least 90% of an uncompressed thickness thereof.

Inventive concept 24: The system of any of Inventive Concepts 16 to 23, wherein when said pressure in said pliable bag is reduced to said below-ambient pressure, said elastically-compressible element retains less than 80% of an uncompressed thickness thereof.

Inventive concept 25: A method for administering a multibaric treatment protocol to a human subject using a gas-transfer system, the method comprising:
a. providing a first vessel comprising (i) a pliable bag having an opening in a proximal portion thereof and comprising first and second opposing bag sections, and (ii) a connection arrangement mounted to the first bag section, wherein said providing includes:
   i. receiving, through said opening, at least a lengthwise part of a limb of the subject in said pliable bag so as to envelop said lengthwise part of said limb, and
   ii. placing said interior space of said pliable bag in fluid communication with a first opening of the gas-transfer system through said connection arrangement;
b. providing a second vessel having a proximal opening and comprising multiple fluid-holding compartments arranged consecutively along a lengthwise portion of said second vessel, wherein said providing includes:
   i. at least partly surrounding, by said second vessel, said enveloped lengthwise part of said limb, and
   ii. placing the respective fluid-holding compartments in fluid communication with multiple corresponding openings of the gas-transfer system;
c. subsequent to said providing of said first vessel and while said opening of said pliable bag is sealed about said limb, causing a flow of a quantity of gas through the first opening and into the bag;
d. subsequent to said providing of said second vessel, and while said quantity of gas resides within the bag, causing a lengthwise circulation of said quantity of gas at least throughout a lengthwise portion of the bag that is surrounded by said multiple fluid-holding compartments, the causing of the circulation including regulating, through said multiple corresponding openings, respective gas pressures in the fluid-holding compartments to alternately inflate and deflate said compartments, each inflating being effective to apply a compressive pressure through a wall of the bag to a corresponding portion of said limb.

Inventive concept 26: The method of Inventive Concept 25, wherein said quantity of gas caused in the first mode to flow through said first opening and into said first vessel has an ambient-pressure volume of at least 100 cc.

Inventive concept 27: The method of either one of Inventive Concepts 25 or 26, wherein (i) said applying of said compressive pressure through a wall of said pliable bag to a corresponding portion of said limb by inflating one or more of said fluid-holding compartments is effective to displace a portion of said quantity of gas within said first vessel, and (ii) said ambient-pressure volume of said quantity of gas is selected so that said displacing does not create an above-ambient pressure within said second vessel.

Inventive concept 28: The method of any one of Inventive Concepts 25 to 27, wherein (i) the regulating in the second mode of respective gas pressures in the fluid-holding compartments to alternately inflate and deflate said compartments includes repeating a sequence of differential pressure regulation

Inventive concept 29: The method of any one of Inventive Concepts 25 to 28, wherein said quantity of gas includes at least one of ozone, oxygen, and an essential oil.

Inventive concept 30: The method of any one of Inventive Concepts 25 to 29, wherein in the first mode, the causing of said flow of said quantity of gas is preceded by evacuating said first vessel through the first opening.

Inventive concept 31: The method of any one of Inventive Concepts 25 to 30, wherein a volume of said quantity of gas is within a range of 0.3 to 10 liters.

Inventive concept 32: The method of any one of Inventive Concepts 25 to 31, wherein said lengthwise strip is formed integrally with said pliable bag.

Inventive concept 33: The method of any one of Inventive Concepts 25 to 31, wherein said lengthwise strip is affixed to said second bag section.

Inventive concept 34: The method of any one of Inventive Concepts 25 to 33, wherein in the second mode when the second vessel at least partly surrounds said enveloped lengthwise part of said limb, said lengthwise strip is aligned longitudinally with said multiple fluid-holding compartments.

Inventive concept 35: The method of any one of Inventive Concepts 25 to 34, wherein said lengthwise strip has a length of at least 10 cm.

Inventive concept 36: The method of any one of Inventive Concepts 25 to 35, wherein said lengthwise strip has a thickness of no more than 3.5 mm.

Inventive concept 37: The method of any one of Inventive Concepts 25 to 36, wherein the first gas-transfer section comprises an ozone generator for delivering an ozone-containing gas to said first vessel.

Inventive concept 38: The method of any one of Inventive Concepts 25 to 37, wherein the first gas-transfer section comprises a container for storage of a therapeutic gas.

Inventive concept 39: The method of any one of Inventive Concepts 25 to 38, wherein when one or more bag-sections of said pliable bag are collapsed by inflation of one or more of said multiple fluid-holding compartments, said lengthwise strip maintains a viable conduit for conveyance of a gas at least for the extent of said first vessel that is surrounded by said fluid-holding compartments of said second vessel.

Inventive concept 40: A system for administering a multibaric treatment protocol to a limb of a human subject, the system comprising:
a. a first gas-transfer section comprising a first opening for gas transfer therethrough, the first section configured to cause a flow of a gas through said first opening;
b. a second gas-transfer section comprising multiple openings for gas transfer therethrough, the second portion configured to cause respective flows of gas through said multiple openings; and
c. electronic circuitry programmed to operate in each one of the following modes in sequence:
   i. a first mode operable when said first vessel envelops a least a lengthwise portion of said limb, in which said first gas-transfer section causes a gas to flow through said first opening and into said first vessel, and
   ii. a second mode operable when said fluid-holding compartments of said second vessel surround at least a lengthwise portion of said enveloped first vessel and while at least a portion of said gas resides within said first vessel, in which said second gas-transfer section regulates, through said multiple openings, respective gas pressures in said fluid-holding compartments so as to cause said fluid-holding compartments to apply respective compressive pressures, through a wall of said first vessel, to corresponding portions of said limb.

Inventive concept 41: The system of Inventive Concept 40, wherein said quantity of gas caused in the first mode to flow through said first opening and into said first vessel has an ambient-pressure volume of at least 100 cc.

Inventive concept 42: The system of either one of Inventive Concepts 40 or 41, wherein (i) said applying of said compressive pressure through a wall of said pliable bag to a corresponding portion of said limb by inflating one or more of said fluid-holding compartments is effective to displace a portion of said quantity of gas within said first vessel, and (ii) said ambient-pressure volume of said quantity of gas is selected so that said displacing does not create an above-ambient pressure within said second vessel.

Inventive concept 43: The system of any one of Inventive Concepts 40 to 42, wherein (i) the regulating in the second mode of respective gas pressures in the fluid-holding compartments to alternately inflate and deflate said compartments includes repeating a sequence of differential pressure regulation.

Inventive concept 44: The system of any one of Inventive Concepts 40 to 43, wherein said quantity of gas includes at least one of ozone, oxygen, and an essential oil.

Inventive concept 45: The system of any one of Inventive Concepts 40 to 44, wherein in the first mode, the causing of said flow of said quantity of gas is preceded by evacuating said first vessel through the first opening.

Inventive concept 46: The system of any one of Inventive Concepts 40 to 45, wherein a volume of said quantity of gas is within a range of 0.3 to 10 liters.

Inventive concept 47: The system of any one of Inventive Concepts 40 to 46, wherein said lengthwise strip is formed integrally with said pliable bag.

Inventive concept 48: The system of any one of Inventive Concepts 40 to 46, wherein said lengthwise strip is affixed to said second bag section.

Inventive concept 49: The system of any one of Inventive Concepts 40 to 48, wherein in the second mode when the second vessel at least partly surrounds said enveloped lengthwise part of said limb, said lengthwise strip is aligned longitudinally with said multiple fluid-holding compartments.

Inventive concept 50: The system of any one of Inventive Concepts 40 to 49, wherein said lengthwise strip has a length of at least 10 cm.

Inventive concept 51: The system of any one of Inventive Concepts 40 to 50, wherein said lengthwise strip has a thickness of no more than 3.5 mm.

Inventive concept 52: The system of any one of Inventive Concepts 40 to 51, wherein the first gas-transfer section comprises an ozone generator for delivering an ozone-containing gas to said first vessel.

Inventive concept 53: The system of any one of Inventive Concepts 40 to 52, wherein the first gas-transfer section comprises a container for storage of a therapeutic gas.

Inventive concept 54: The system of any one of Inventive Concepts 40 to 53, wherein when one or more bag-sections of said pliable bag are collapsed by inflation of one or more of said multiple fluid-holding compartments, said lengthwise strip maintains a viable conduit for conveyance of a gas at least for the extent of said first vessel that is surrounded by said fluid-holding compartments of said second vessel.

Inventive concept 55: Apparatus for use, with a pressure-regulating apparatus, in applying a therapy to a human limb, the apparatus comprising:
a. a pliable bag having an opening in a proximal portion thereof and comprising first and second opposing bag sections;
b. a connection arrangement mounted to the first bag section, and
c. a lengthwise strip arranged on an interior surface of the second bag section such that (i) a distal portion of said lengthwise strip is disposed in a distal portion of said pliable bag and in fluid communication with said connection arrangement and (ii) a proximal end of the lengthwise strip is disposed in a proximal portion of said pliable bag, said lengthwise strip comprising an at-most-partially compressible layer open to an interior space of said pliable bag along the length of said lengthwise strip, wherein:
   said pliable bag is configured to receive, in a donned mode, at least a portion of said limb, through said opening, and
   said at-most-partially compressible layer of said lengthwise strip enables fluid flow therethrough when an evacuation of said interior space of said pliable bag causes said at-most-partially compressible layer to be pressed against either the limb or an interior surface of the first bag section, said evacuation being by a negative pressure of up to 100 mm Hg below an ambient pressure being applied to said interior space by the pressure-regulating apparatus through said connection arrangement.

Inventive concept 56: Apparatus for use with a pressure-regulating apparatus in applying a therapy, the apparatus comprising:
a. a pliable bag having an opening in a proximal portion thereof and comprising first and second opposing bag sections;
b. a connection arrangement mounted to the first bag section, and
c. a lengthwise strip arranged on an interior surface of the second bag section such that (i) a distal portion of said lengthwise strip is disposed in a distal portion of said pliable bag and in fluid communication with said connection arrangement and (ii) a proximal end of the lengthwise strip is disposed in a proximal portion of said pliable bag, said lengthwise strip comprising an at-most-partially compressible layer open to an interior space of said pliable bag along the length of said lengthwise strip,
wherein said at-most-partially compressible layer of said lengthwise strip enables fluid flow therethrough when an evacuation of said interior space of said pliable bag causes said at-most-partially compressible layer to be partially compressed, said evacuation being by a negative pressure of up to 100 mm Hg below an atmospheric pressure, being applied to said interior space by the pressure-regulating apparatus through said connection arrangement.

Inventive concept 57: A system for administering a multibaric treatment protocol to a limb of a human subject, the system comprising:
a. a first vessel comprising (i) a pliable bag having an opening in a proximal portion thereof and comprising first and second opposing bag sections, (ii) a connection arrangement mounted to the first bag section, and a (iii) lengthwise strip arranged on an interior surface of said pliable bag such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip;
b. a second vessel having a proximal opening and comprising multiple fluid-holding compartments arranged consecutively along a lengthwise portion of said second vessel;
c. a first gas-transfer section comprising a first opening for gas transfer therethrough, the first section configured to cause a flow of a gas through said first opening;
d. a second gas-transfer section comprising multiple openings for gas transfer therethrough, the second portion configured to cause respective flows of gas through said multiple openings; and
e. electronic circuitry arranged to control said first and second gas-transfer sections and programmed to operate in each one of the following modes in sequence:
   i. a first mode in which, when said first vessel envelops a lengthwise part of said limb, said first gas-transfer section causes a quantity of gas to flow through said first opening and into said first vessel, and
   ii. a second mode in which, when the second vessel at least partly surrounds said enveloped lengthwise part of said limb, said second gas-transfer section causes a lengthwise circulation of said quantity of gas at least throughout a lengthwise portion of said pliable bag that is surrounded by said multiple fluid-holding compartments, wherein causing the circulation includes regulating, through said multiple corresponding openings, respective gas pressures in the fluid-holding compartments to alternately inflate and deflate said compartments, each inflating being effective to apply a compressive pressure through a wall of said pliable bag to a corresponding portion of said limb, wherein the alternately inflating and deflating includes alternately inflating and deflating consecutive fluid-holding compartments,
wherein in said second mode, said lengthwise strip defines a lengthwise, at-most-partly compressible fluid pathway for gas flow between first and second non-contiguous lengthwise portions of said pliable bag that are respectively distal and proximal to a lengthwise portion of said pliable bag that is under compressive pressure applied by one or more corresponding fluid-holding compartments.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A system for administering a multibaric treatment protocol to a limb of a human subject, the system comprising:
a. a first vessel comprising (i) a pliable bag having an opening in a proximal portion thereof and comprising first and second opposing bag sections, (ii) a connection arrangement mounted to the first bag section, and a (iii) lengthwise strip arranged on an interior surface of the second bag section such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip;
b. a second vessel having a proximal opening and comprising multiple fluid-holding compartments arranged consecutively along a lengthwise portion of said second vessel;
c. a first gas-transfer section comprising a first opening for gas transfer therethrough, the first section configured to cause a flow of a gas through said first opening;
d. a second gas-transfer section comprising multiple openings for gas transfer therethrough, the second portion configured to cause respective flows of gas through said multiple openings; and
e. electronic circuitry arranged to control said first and second gas-transfer sections and programmed to operate in each one of the following modes in sequence:
i. a first mode in which, when said first vessel envelops a lengthwise part of said limb, said first gas-transfer section causes a quantity of gas to flow through said first opening and into said first vessel, and
ii. a second mode in which, when the second vessel at least partly surrounds said enveloped lengthwise part of said limb, said second gas-transfer section causes a lengthwise circulation of said quantity of gas at least throughout a lengthwise portion of said pliable bag that is surrounded by said multiple fluid-holding compartments, wherein causing the circulation includes regulating, through said multiple corresponding openings, respective gas pressures in the fluid-holding compartments to alternately inflate and deflate said compartments, each inflating being effective to apply a compressive pressure through a wall of said pliable bag to a corresponding portion of said limb, wherein the alternately inflating and deflating includes alternately inflating and deflating consecutive fluid-holding compartments,
wherein in said second mode, said lengthwise strip defines a lengthwise, at-most-partly compressible fluid pathway for gas flow between first and second non-contiguous lengthwise portions of said pliable bag that are respectively distal and proximal to a lengthwise portion of said pliable bag that is under compressive pressure applied by one or more corresponding fluid-holding compartments.

2. The system of claim 1, wherein said quantity of gas caused in the first mode to flow through said first opening and into said first vessel has an ambient-pressure volume of at least 100 cc.

3. The system of claim 2, wherein (i) said applying of said compressive pressure through a wall of said pliable bag to a corresponding portion of said limb by inflating one or more of said fluid-holding compartments is effective to displace a portion of said quantity of gas within said first vessel, and (ii) said ambient-pressure volume of said quantity of gas is selected so that said displacing does not create an above-ambient pressure within said first vessel.

4. The system of any one of claims 1 to 3, wherein the regulating in the second mode of respective gas pressures in the fluid-holding compartments to alternately inflate and deflate said compartments includes repeating a sequence of differential pressure regulation.

5. The system of any one of claims 1 to 4, wherein said quantity of gas includes at least one of ozone, oxygen, and an essential oil.

6. The system of any one of claims 1 to 5, wherein in the first mode, the causing of said flow of said quantity of gas is preceded by evacuating said first vessel through the first opening.

7. The system of any one of claims 1 to 6, wherein a volume of said pliable bag is within a range of 0.3 to 10 liters.

8. The system of any one of claims 1 to 7, wherein said lengthwise strip is formed integrally with said pliable bag.

9. The system of any one of claims 1 to 7, wherein said lengthwise strip is affixed to said second bag section.

10. The system of any one of claims 1 to 9, wherein in the second mode when the second vessel at least partly surrounds said enveloped lengthwise part of said limb, said lengthwise strip is aligned longitudinally with said multiple fluid-holding compartments.

11. The system of any one of claims 1 to 10, wherein said lengthwise strip has a length of at least 10 cm.

12. The system of any one of claims 1 to 11, wherein said lengthwise strip has a thickness of no more than 3.5 mm.

13. The system of any one of claims 1 to 12, wherein the first gas-transfer section comprises an ozone generator for delivering an ozone-containing gas to said first vessel.

14. The system of any one of claims 1 to 13, wherein the first gas-transfer section comprises a container for storage of a therapeutic gas.

15. The system of any one of claims 1 to 14, wherein when one or more bag-sections of said pliable bag are collapsed by inflation of one or more of said multiple fluid-holding compartments, said lengthwise strip maintains a viable conduit for conveyance of a gas at least for the extent of said first vessel that is surrounded by said fluid-holding compartments of said second vessel.

16. A system for administering a multibaric treatment protocol to a limb of a human subject, the system comprising:
a. a first vessel comprising (i) a pliable bag having an opening in a proximal portion thereof and comprising first and second opposing bag sections, and (ii) a connection arrangement mounted to the first bag section;
b. a second vessel having a proximal opening and comprising multiple fluid-holding compartments arranged consecutively along a lengthwise portion of said second vessel;
c. a first gas-transfer section comprising a first opening for gas transfer therethrough, the first section configured to cause a flow of a gas through said first opening;
d. a second gas-transfer section comprising multiple openings for gas transfer therethrough, the second portion configured to cause respective flows of gas through said multiple openings; and
e. electronic circuitry arranged to control said first and second gas-transfer sections and programmed to operate in each one of the following modes in sequence:
i. a first mode in which, when said first vessel envelops a lengthwise part of said limb, said first gas-transfer section causes a quantity of gas to flow through said first opening and into said first vessel, and
ii. a second mode in which, when the second vessel at least partly surrounds said enveloped lengthwise part of said limb, said second gas-transfer section causes a lengthwise circulation of said quantity of gas at least throughout a lengthwise portion of said pliable bag that is surrounded by said multiple fluid-holding compartments, wherein causing the circulation includes regulating, through said multiple corresponding openings, respective gas pressures in the fluid-holding compartments to alternately inflate and deflate said compartments, each inflating being effective to apply a compressive pressure through a wall of said pliable bag to a corresponding portion of said limb, wherein the alternately inflating and deflating includes alternately inflating and deflating consecutive fluid-holding compartments.

17. A system for administering a multibaric treatment protocol to a limb of a human subject, the system comprising:
a. a vessel comprising (i) a pliable bag having an opening in a proximal portion thereof and comprising first and second opposing bag sections, (ii) a connection arrangement mounted to the first bag section, and a (iii) lengthwise strip arranged on an interior surface of said pliable bag such that (A) a distal portion of said lengthwise strip is disposed in a distal portion of said pliable bag and in fluid communication with said connection arrangement and (B) a proximal end of the lengthwise strip is disposed in a proximal portion of said pliable bag, said lengthwise strip comprising an at-most-partially compressible layer open to an interior space of said pliable bag along the length of said lengthwise strip;
b. a gas-transfer apparatus comprising an opening for gas transfer therethrough, the apparatus configured to cause a flow of a gas through said first opening;
c. an elastically-compressible element biased to expand to a design height in at least one dimension; and
d. electronic circuitry arranged to control said gas-transfer apparatus and programmed to perform each of the following steps in sequence:
i. evacuating said vessel, through said first opening of said gas-transfer system, to reduce a pressure in said vessel to a below-ambient pressure and to at least partially compress said elastically-compressible element, and
ii. causing a quantity of gas to flow through said first opening of said gas-transfer system and into said evacuated vessel to increase said pressure in said vessel, the flow of gas traversing said lengthwise strip to expand the at least partially compressed elastically-compressible element.

18. The system of claim 17, wherein said elastically-compressible element comprises an open-celled foam.

19. The system of any either one of claim 17 or 18, wherein said below-ambient pressure is between 10 and 100 mm Hg below ambient pressure.

20. The system of any one of claims 17 to 19, wherein the flow of said quantity of therapeutic gas to said elastically-compressible element is at least partly through said lengthwise strip.

21. The system of any one of claims 17 to 20, wherein the flow of said quantity of gas to said elastically-compressible element is substantially all through said lengthwise strip.

22. The system of any one of claims 17 to 21, wherein a footprint of said lengthwise strip has an area less than 10 percent of an area of said pliable bag when lain flat without wrinkles or folds.

23. The system of any one of claims 17 to 22, wherein said lengthwise strip has a length equal to at least 70% of a length of said pliable bag.

24. The system of any of claims 17 to 23, wherein when said pressure in said pliable bag is reduced to said below-ambient pressure, said lengthwise strip retains at least 90% of an uncompressed thickness thereof.

25. The system of any of claims 17 to 24, wherein when said pressure in said pliable bag is reduced to said below-ambient pressure, said elastically-compressible element retains less than 80% of an uncompressed thickness thereof.
